(19) United States
(12) Patent Application Publication
(10) Pub. No.: US 2026/0326143 A1
(43) Pub. Date: Oct. 22, 2026

(54) Apparatus for Applying Flowable Substance from Container to Surface

(71) Applicant: Conrad Wayne Bewsky, Pitt Meadows (CA)

(72) Inventor: Conrad Wayne Bewsky, Pitt Meadows (CA)

(21) Appl. No.: 19/109,744

(22) PCT Filed: Sep. 8, 2023
(86) PCT No.: PCT/CA2023/051190

§ 371 Date: Mar. 7, 2025

Related U.S. Application Data
(60) Provisional application No. 63/405,079, filed on Sep. 9, 2022.
(60) Provisional application No. 63/493,558, filed on Mar. 31, 2023.

(51) Int. Cl. B05C 17/005

(52) U.S. Cl. CPC B05C 17/00506; B05C 17/0052

(57) ABSTRACT

Apparatus for applying a flowable substance from a dispensing container to a surface comprises a tubular adaptor having a first end portion configured for mounting to a dispensing tip of the container and an interior surface extending from a first end defined by the first end portion and to a second end for guiding the flowable substance through the adaptor. The apparatus further includes interchangeable attachment tips configured to be received on the adaptor in respective working positions. Each attachment tip forms a respective interior passageway for guiding the flowable substance from a mounting end of the attachment tip, with an opening therein, and to a free end arranged at or adjacent the surface and having a release opening from which the flowable substance is applied to the surface. The attachment tips have different exterior shapes for forming different beads when the flowable substance is applied to the surface.

### FIELD OF THE INVENTION

The present invention relates to an apparatus for applying a flowable substance from a dispensing container to a surface. The dispensing container has a body forming a receptacle configured to receive the flowable substance, and the body is deformable for mechanically urging the flowable substance out of the receptacle. The dispensing container further includes a dispensing tip supported on the body in fluidic communication with the receptacle and forming a passageway to convey the flowable substance. The dispensing tip is closed and configured for locating a dispensing opening through which the flowable substance is released from the container.

### BACKGROUND

Presently, filling gaps, cracks, holes and voids efficiently is time consuming and arduous when trying to maintain an even bead, a clean edge and work surface. Over filling is common when applying paste like mixtures such as caulk, spackle and fillers. Cleaning involves multiple passes, and there is a great deal of waste.

Presently, applying and spreading minimal amounts of low viscosity liquids such as paint, sealer and other finishes is time consuming, cumbersome and involves a lot of cleaning. Over applying is common, as much more is applied than necessary.

Presently, applying and spreading liquid and paste like adhesives efficiently is also time consuming and arduous when trying to maintain its consistency, effectiveness and an even spread. Over applying is common when applying a liquid such as white glue. Cleaning involves multiple passes and there is a great deal of waste.

Presently the nozzle of a pre-filled tube of caulk is cleanly cut at an angle at a predetermined size to fill a specific size of gap. When poorly cut, the result is an uneven messy bead and a messy work surface.

Presently paste-like mixtures are supplied in a variety of tube forms and are dispensed by squeezing the tube or by using mechanical means such as a caulk gun.

The open nozzle of a tube also becomes a tool for finishing in most to all cases. Other means such as a finger, a blade, a rag or flexible tools are necessary as a secondary tool to improve the finish.

A common problem with the present application, is the nozzle of commercially pre-filled caulk, spackle and adhesive dispensing tubes typically comprises a very rigid slippery thick walled plastic usually having a substantial taper to accommodate different bead sizes or openings when cut, making it very difficult to attach any kind of applicator tool tip.

Presently, attempts have been made to provide flexible caulk tips which slip onto a tapered tube nozzle but have a tendency to slide off especially in use when drag is applied caused by friction between the tip and work surface and they can only be used with certain nozzle profiles. This problem is exacerbated when in use due to the material being dispensed getting between the mating surface of the caulk tip and tube nozzle caused by pressing the caulk tip to the work surface distorting the seal and allowing the dispensed material to pass. In addition these caulk tips are typically too large to finish small gaps and hairline cracks.

Presently applying caulk directly to a gap, through the nozzle provided on a commercially pre-filled tube is dependent on the speed at which the caulk is applied and the amount of caulk dispensed. They are in sync in order to achieve a somewhat decent bead, any deviation and a void is left or the gap is over filled and caulk spills over the edge of the tube nozzle end and is removed.

Another problem with the present application, the blunt profile and or thick wall of a commercially pre-filled tube nozzle cut open at a minimum, is likely to be too large and rigid of a dispensing and tooling tip when filling or caulking hairline cracks and small gaps. Over applying caulk is a result and much is removed and discarded resulting in a lot of wasted caulk and time spent.

Another problem presently, is existing tube nozzle ends are non-existent of a flexible wiping edge and do not provide guidance for gaps on flat planes or obtuse angles.

Another problem with the present application is, gun style and squeezable tubes are quite large and cumbersome and involve more effort and space to maneuver.

Another problem with the present application, is when secondary tools are used to remove excess caulk, the delay is typically long enough for a skin to form on the applied caulk requiring moistening of the caulk and multiple passes to achieve a clean uniform finish. In many instances not enough caulk has been initially applied and in other instances is reapplied. The disadvantage is a lot of caulk is discarded, a skin forms quickly on the bead before tooling and the bead is ultimately messed up.

Another problem with the present application is, finishing hair line cracks and small gaps referred to as black lines on finished light colored work surfaces which are unsightly. They are typically over filled with a high percentage of waste due to the profile, wall thickness and rigidity of commercially pre-filled tube nozzles which are difficult if not impossible to cut to a fine tool piece.

Another problem is, when a tapered tube nozzle is trimmed to increase dispensing or bead size for filling large gaps and voids the tube is no longer of use for smaller gaps and cracks or less dispensing.

Another problem is some specifically pre-filled tubes have fitted tool tips which are discarded once the tube is emptied. Some of these tips provide poor tooling, are difficult to clean and have the disadvantage of only using the type of material supplied.

Presently, applying different bead sizes comprises using different tubes of caulk, one for each size of bead, and accordingly, much more caulking is applied than necessary and the application involves secondary tooling.

Applying non-sanded and sanded caulks and non-sanded grout to wall and floor tile installations is an arduous and extensive multi-step process in application and finishing.

A common problem with the present application is filling small gaps on a large tile profile installation when it is necessary to use non-sanded grout. Presently, a float is used to apply the non-sanded grout usually covering the entire tiled surface with grout, in cleaning numerous times the entire tiled surface is inevitably affected by the grout installation adding much extra work and time to the project.

Another problem with the present application is, the smaller the gap the greater the chance the gap is inadequately filled or missed.

Presently, when filling small holes and voids on finished surfaces such as walls or installed pre-finished surfaces such as moldings and trim, paste like mixtures such as fillers or spackles are used together with a tool such as a finger or a putty knife, requiring two hands. Filler may be scooped out of a container with a tool and applied or dispensed from a pre-filled supply tube onto a tool such as a knife or finger and applied by pressing the mixture into the void being filled and the excess is somewhat wiped off or left and sanded off.

A common problem with the present application is, after only a few voids are filled the filler on the tool that hasn't been used becomes degraded and too dry to use and is discarded or placed in a container to be re-mixed. Dried filler on the tool is cleaned periodically. The disadvantages include use of two hands, wasted material, extra steps and time and a large patch to finish.

Another problem is when a tool tip is fixed to or a part of a commercially pre-filled tube it is discarded once the tube is emptied. These tips typically provide inadequate tooling, are difficult to clean and have the disadvantage of only using the type of material supplied.

Another problem is, some fillers come in a tube with an applicator tip which can over apply the filler, providing poor tooling, and ending up with a large patch to finish. They are difficult to clean and are discarded when the tube is empty. When the tip is used as intended to wipe off excess filler it has a tendency to remove too much. This has the disadvantage of only using the material supplied.

Presently, other commercially available spackles and fillers come in a container, are scooped out and applied using a putty knife. The common problem is these fillers are exposed to air for a prolonged period of time and over time lose their consistency, degrade and become thicker and more difficult to spread thus going on thicker, resulting in more material to remove, wasted material, extra work and a large patch to finish.

Presently, the common problem when applying adhesives such as PVA (liquid white glue) is the adhesive being dispensed through the nozzle provided is uneven, quickly begins to pool, it is difficult to judge amount of the adhesive to be applied and the adhesive runs off the work surface. Tools such as a finger, blade, trowel or brush are used to spread the adhesive after it has been applied. This adds extra time to the project, usually more adhesive is applied than necessary and the amount of time the adhesive is exposed to air is increased, ultimately increasing the risk of a compromised joint. This action can be messy and arduous, especially when applying the adhesive to a non-horizontal surface. The disadvantages include extra steps, extra time and more material is applied than necessary.

Presently, when applying a paste like mixture adhesive such as Liquid Nails® and NoNails® from a commercially pre-filled tube, the adhesive is dispensed through the nozzle provided as a bead or a blob and is spread with a tool such as a finger, stick or notched blade tool. The disadvantages include provision of a second step, extra time, cleaning the tool and especially, with these types of adhesive, the extra exposure time to air substantially increases the risk of a compromised glue joint or bond.

Another problem when a paste adhesive is applied as a blob or a heavy bead is the difficulty in compressing the mating surfaces together as the adhesive is being spread at the same time.

Presently, applying low and very low viscosity liquids such as paint, stain, sealer and other finishes, preferably for touch-ups in which a very small amount is used, is a two handed, cumbersome, repetitive task of, open, mix, use, close and clean, with a great deal of time spent and the touch-up is typically larger and more visible than necessary on many surface finishes.

Another common problem with the present application is, having the container opened many times, especially for prolonged periods of time where is the contents are exposed to air, lose consistency and dry out. Tools become encrusted, shortening the life of the tool.

Pre-filled tubes of touch-up paint, stain and other finishes are commercially available but have the disadvantage of being sealed, are not refillable, many have no means of mixing, contents are specific, are difficult to clean, and have limited tooling features.

Some available applicators can only be filled once, are used and discarded and have no mixing apparatus built in.

The present invention eliminates the problems described herein and greatly reduces overall costs.

Presently, paste like mixtures contained in soft flexible tubes are dispensed by squeezing the tube proportionately to the amount of material for application to the surface.

A common problem, is when enough of the material has been dispensed from the tube, the tube is somewhat flattened and less squeezable. In many instances the tube is discarded with a fair amount of material being wasted. In other instances the tube is rolled up to re-collect the contents and re-expand the tube to regain squeezability.

Another problem is the rolled portion may be held in the hand while squeezing, unrolling when set down, having to be re-rolled or other means such as tape or binder clips may be used to contain the roll. Binder clips pop off when squeezing and tape can be difficult to apply and remove.

Presently, spackle filled patched holes on finished surfaces such as walls, trim or moldings, are smoothed from any protruding excess filler or dried particles in the finish by means of such devices as sanding paper, putty knifes or scrapers.

A common problem is, sanding papers cut the filler as well as the work surface damaging the finish and have a tendency to hollow out a patch. Putty knifes and scrapers tear the filler off, sometimes gouging much of the filler out of the filled void and can also damage and scratch the finished work surface.

Presently, a device such as a funnel, a suction tube or gun, or a type of syringe are used when transferring liquids from vessel to vessel.

A common problem with these devices is, the contents being transferred may be exposed to air and they only work with relatively low to very low viscosity liquids.

When transferring paste like mixtures such as spackle, a tool such as a putty knife or finger is used.

A common problem with this method is, the mixture is exposed to air, losing consistency, drying out and air entrapment is inevitable.

When transferring high viscosity liquids such as glues or adhesives the pour and squeeze method is used.

A common problem is, a high chance of spillage especially from a large bottle to a small bottle and the exposure to air.

Presently, many commercially pre-filled tubes and bottles simply provide a device to contain the contents and dispense from with very limited to no tooling and finishing features.

Another problem is, they have no form of venting or air intake, no separation between the contents and squeezable compartment and their physical shape does not remain the same.

Another problem is, pre-filled containers simply contain the contents and the means of dispensing is scooping out the contents with a tool or using a brush to absorb the contents.

A problem when dispensing paste like mixtures such as spackle from a resilient squeezable container is, when the squeeze is relaxed the container remains in the squeezed form or air is drawn in displacing the contents dispensed. The problem when dispensing liquids such as paint or white glue is, when the squeeze is relaxed the tube or bottle is typically turned upright to draw in air and regain squeezability or depending on the viscosity, air may draw in through the paint or glue in the nozzle.

Another problem is, when paint or glue is dispensed in a steady stream for a long period of time, the squeezability of the tube is depleted and the tube is lifted from the surface, up-righted and relaxed to draw in air regaining squeezability and placed back onto the surface to continue.

Presently, when liquid such as paint is dispensed from a tube or bottle by squeezing, and the squeeze is relaxed, air is typically drawn in to displace the dispensed paint through the passage of which the paint was dispensed, the only opening.

A common problem is, when the tube or bottle is left laying down the paint remains in or fills the passage and with thermal expansion pressure builds in the single compartment container and causes the paint to ooze out.

Presently, caulks are dispensed from tubes such as a caulk gun or squeezable form of which both can be cumbersome and awkward when working on trim and moldings with multiple profiles which are substantially maneuverable.

A common problem when using a caulk gun tube is, the physical size, mainly its length and awkwardness and the size of the plunger proportional to a very small nozzle opening along with the mass of caulk which is pressurized by the movement of the plunger, which inevitably causes oozing of the contents and in use involves two hands.

A common problem when using a physically smaller dispensing tube such as a squeezable form, is the softness and somewhat resilience of the tube. When not in use and with a sometimes loose-fitting cap provided, the tube relaxes drawing back the caulk from the tip of the nozzle, slightly drying out the remaining film of caulk left in the nozzle each time, eventually reducing the size of the passage requiring cleaning.

### SUMMARY OF THE INVENTION

It is an aspect of the invention to provide an apparatus that eliminates the afore-described problems and greatly reduces overall costs including time spent and waste of flowable substance. Furthermore, it is an aspect of the invention to provide an apparatus to apply and spread an even layer of adhesive in one pass. Moreover, it is an aspect of the invention to provide an apparatus with the convenience of a multi-use tool.

According to an aspect of the invention there is provided an apparatus for applying a flowable substance from a dispensing container to a surface, wherein the dispensing container has a body forming a receptacle configured to receive the flowable substance, wherein the body is deformable for mechanically urging the flowable substance out of the receptacle, wherein the dispensing container further includes a dispensing tip supported on the body in fluidic communication with the receptacle and forming a passageway to convey the flowable substance, wherein the dispensing tip is closed and configured for locating a dispensing opening through which the flowable substance is released from the container, the apparatus comprising:
an adaptor in the form of a tube and extending from a first end to a second end, wherein the first and second ends are open, wherein the adaptor comprises a container mounting portion defining the first end and configured to be received on the dispensing tip of the container and an attachment mounting portion defining the second end, wherein each of the container mounting portion and the attachment mounting portion have interior surfaces, wherein the interior surface of the container mounting portion is arranged to face the dispensing tip of the container and the interior surface of the attachment mounting portion is configured to guide the flowable substance from the dispensing tip of the container and to the second end of the adaptor; and
a plurality of interchangeable attachment tips configured to be received on the adaptor in respective working positions, wherein each of the attachment tips forms a respective interior passageway for guiding the flowable substance from a mounting end of the attachment tip, located at or adjacent the second end of the adaptor in the respective working position and having an opening therein, and to a free end of the attachment tip arranged at or adjacent the surface and having a release opening in the free end from which the flowable substance is applied to the surface, wherein the interchangeable attachment tips have different exterior shapes for forming different beads when the flowable substance is applied to the surface.

This provides an arrangement for using a common dispensing container storing a flowable substance to apply beads of different shapes of that substance.

Typically, the dispensing tip is supported at an end of the body of the dispensing container.

Typically, the dispensing tip of the container is rigid.

Typically, in a closed condition, as before forming an opening in the dispensing tip, the dispensing tip is in the form of a receptacle to contain the flowable substance.

Typically, the dispensing tip of the container is supported in fixed relation to the body of the container.

Typically, the dispensing tip of the container forms a nozzle, which is closed.

Typically, the dispensing opening is locatable in the dispensing tip by removing an end portion of the dispensing tip defining a free end thereof, typically by cutting action. When the dispensing tip is considered to extend in a longitudinal direction from the body and to the free end thereof, the cutting action is typically directed transversely thereto.

Typically, the interchangeable attachment tips have different combinations of exterior shape and shape of passageway. The shape of the passageway includes a tip opening, including size and shape thereof, and a path along which the passageway extends relative to an axis of the adaptor.

In one arrangement, when the adaptor extends along an axis from the first end to the second end, the container mounting portion of the adaptor comprises a plurality of projecting members carried on the interior surface thereof and projecting inwardly therefrom towards the axis, wherein the projecting members are configured for imbedding in the dispensing tip of the container to resist relative movement between the adaptor and the dispensing tip in an axial direction of the adaptor.

In particular, the projecting members resist against movement of the adaptor along the axis and in a direction away from the container, which would act to detach or otherwise remove the adaptor from the dispensing tip.

In this manner, the adaptor acts to securely grip the dispensing tip of the container.

Preferably, the interior surface of the container mounting portion of the adaptor is smooth besides the projecting members carried thereon.

In one arrangement, the projecting members extend helically around the axis.

In one arrangement, the projecting members are angularly spaced from each other around the axis of the adaptor.

In such arrangements, the projecting members may be arranged at a common distance from the first end of the adaptor.

As such, when the projecting members extend helically around the axis and are located at a common distance from the first end of the adaptor, the projecting members follow distinct helical paths around the axis. This may act to maximize gripping of the adaptor on the dispensing tip, as each projecting member cuts a unique helical path in the dispensing tip.

In such arrangements, the projecting members may comprise ridges oriented transversely to the axis and a plurality of teeth supported on each of the ridges, such that each of the projecting members carries a plurality of penetrating pointed terminuses which are axially spaced apart.

Preferably, the pointed terminus of each trailing one of the teeth protrudes further outwardly from an apex or tip of the ridge on which the tooth is carried, such that each tooth cuts a distinct path in the dispensing tip upon mounting of the adaptor thereon.

In one arrangement, an interior cross-section of the container mounting portion defined by the interior surface thereof is non-uniformly tapered in size from the first end and towards the attachment mounting portion, wherein a rate of tapering is higher adjacent a junction between the container mounting portion and the attachment mounting portion than adjacent the first end.

Typically, an interior cross-section of the attachment mounting portion defined by the interior surface thereof is tapered in size from the junction towards the second end; however, the tapering is substantially uniform, that is a rate of the tapering is constant.

In one arrangement, the apparatus further includes a cutting gauge configured to delimit a length of an end portion of the dispensing tip to be cut for locating the dispensing opening in the dispensing tip, wherein the cutting gauge is in the form of a tube configured to receive the dispensing tip and extends along a respective axis, wherein the cutting gauge is supported on the adaptor with the axes of the adaptor and the cutting gauge in parallel relation to one another.

Preferably, the axes of the adaptor and the cutting gauge are coplanar.

In one arrangement, when the cutting gauge extends axially from a first open end proximal to the first end of the adaptor and to a second open end of the cutting gauge distal to the first end of the adaptor, the cutting gauge comprises a leading cylindrical portion defining the first open end and a trailing frustoconical portion defining the second open end, wherein the trailing frustoconical portion is tapered in cross-sectional size from a junction between the leading cylindrical and trailing frustoconical portions towards the second open end, and wherein the leading cylindrical portion is longer in the axial direction than the trailing tapered portion.

Such configuration of the cutting gauge acts to reduce likelihood that the dispensing tip contacts an interior surface of the cutting gauge at an intermediate location between the first and second open ends. As such, either the first open end or the second open end act as a stop for delimiting the end portion of the dispensing tip to be cut.

In the illustrated arrangement, the cylindrical portion is two to three times longer in the axial direction than the frustoconical portion.

It will be appreciated that an opening at/in the first open end of the cutting gauge is larger than an opening at/in the second open end of the cutting gauge.

In one arrangement, the apparatus further includes a cap configured to cover the second end of the adaptor and a storage post configured to receive the cap, wherein the storage post is supported in fixed relation to the adaptor and is oriented transversely to the axis of the adaptor. In one arrangement, when the apparatus further includes a second tubular passageway supported on the adaptor in fixed parallel relation thereto, the storage post is carried on the tubular passageway.

In one arrangement, the storage post is in the form of a pair of parallel planar prongs. In one arrangement, each of the interchangeable attachment tips and the adaptor are interconnectable by a plurality of pairs of mating members to form a fluidic seal between the second end of the adaptor and the mounting end of the attachment tip arranged in the respective working position, wherein the mating members of the adaptor include (i) a plurality of recesses in an outer surface of the attachment mounting portion, wherein the recesses are arranged in angularly and axially spaced relation about the outer surface, and (ii) an annular receptacle at the second end of the adaptor, wherein the annular receptacle extends axially of the adaptor and encompasses the interior cross-section of the attachment mounting portion; and wherein the mating members of the attachment tip include (i) a plurality of projecting bodies supported on an interior of the attachment tip and configured to mate with the recesses in the outer surface of the attachment mounting portion, and (ii) an annular lip supported at an end of the attachment tip and configured to mate with the annular receptacle.

Typically, the projecting bodies are configured to mate with the recesses by being sized and shaped to fit therein.

In the illustrated arrangement, a first set of the recesses and the projecting bodies is larger in a circumferential direction than a second set of the recesses and the projecting bodies.

In the illustrated arrangement, the first set of the recesses and the projecting bodies is located closer to the mounting end of the attachment tip and the second end of the adaptor, which are registered with one another in the respective working position of the attachment tip, than the second set of the recesses and the projecting bodies relative to the registered attachment tip mounting end and adaptor second end.

Typically, the annular receptacle acts to apply substantially uniform pressure around the full circumference of the interface between the second end of the adaptor and the mounting end of the attachment tip.

Distinct mating members spaced in the circumferential/angular direction act to resist relative rotation between the attachment tip and the adaptor.

In one arrangement, a caulking one of the interchangeable attachment tips configured to apply a bead of a caulking type of the flowable substance comprises a nose protruding in the axial direction beyond the release opening which opens transversely to the axis, wherein the exterior shape of the caulking attachment tip comprises a central bottom ridge extending from the release opening and away from the axis and in a rearward direction towards the mounting end of the caulking attachment tip, wherein the exterior shape of the caulking attachment tip includes on either side of the ridge concavely shaped surfaces forming an inverted V shaped edge from one side of the caulking attachment tip and across the nose to an opposite side of the caulking attachment tip.

In other words, the caulking type of the flowable substance is viscous and/or paste-like.

Typically, the nose is curved from side-to-side.

It will be appreciated that the inverted V shaped edge is disposed on one side of the release opening, typically that which is closer to the axis of the attachment tip.

The inverted V shaped edge is suited for use to remove the applied flowable substance immediately after application to the surface, when the applied flowable substance is pliable or wet, so as to form a smooth or clean bead of the caulking type of the applied flowable substance. Preferably, end portions of the inverted V shaped edge, distal to the nose, are convexly curved.

In one arrangement, the exterior shape of the caulking attachment tip has a substantially planar forwardly facing surface locating the release opening and between the nose and the bottom ridge.

In one arrangement, when the body of the dispensing container is rollably deformable, the apparatus further includes a retention clip configured to be supported on a deformed end portion of the body of the dispensing container, wherein the retention clip is generally clam-shaped to have an upper portion and a lower portion in generally parallel and spaced-apart relation and defining therebetween a receptacle configured to receive the deformed end portion of said body, wherein sides of the retention clip at the upper and lower portions are flared away from each other to act as guide surfaces for locating the retention clip onto the deformed end portion of said body in a transverse direction to a longitudinal direction of the body of the dispensing container directed from the deformed end portion to the dispensing tip.

Typically, rollable deformation is in a longitudinal direction of the body from the free end towards the dispensing tip.

Typically, the deformed end portion defines the free end of the body of the dispensing container.

In one arrangement, one of the upper portion and the lower portion of the retention clip is shorter than another one thereof and wherein an end portion of the shorter one of the upper portion and the lower portion is hooked towards a longer one of the upper and lower portion to substantially close the clam-shaped receptacle for securably pinching the body of the dispensing container.

In one arrangement, the retention clip comprises a plurality of parallel ribs exterior to the receptacle and spanning between free ends of the upper and lower portions.

In one arrangement, the apparatus further includes a smoothing tool attachment configured to cuttingly remove hardened excess of the applied flowable substance and configured to be supported on the adaptor distinctly of the interchangeable attachment tips, wherein the smoothing tool attachment comprises a mounting portion in the form of a planar body locating an opening configured to be received on the adaptor and a plurality of parallel blades arranged in a transversely extending row relative to the axis of the adaptor.

Typically, the mounting portion is configured to be supported in a plane substantially orthogonal to the axis of the adaptor.

Generally speaking, the smoothing tool is used to leave a finished surface of the hardened applied flowable substance. As such, the smoothing tool is configured to remove, by cutting action, excess amounts or portions of the hardened applied flowable substance.

Typically, the blades have cutting edges extending substantially parallel to the axis of the adaptor. Thus, the smoothing tool is configured to be moved in parallel directions to the axis of the adaptor to slicably or cuttingly remove the excess applied flowable substance.

Conveniently, outer edges of outer ones of the blades in the row are usable as wiping edges to spread the applied flowable substance on the surface while the applied flowable substance is wet or pliable.

In one arrangement, when bottom surfaces of the blades define a common plane, the common plane is inclined to be transverse to the axis of the adaptor.

The bottom surfaces of the blades are suited for forming a planar type of the finished surface of the hardened applied flowable substance.

In one arrangement, when the smoothing tool comprises opposite ends which are axially spaced apart relative to the axis of the adaptor and opposite sides of the smoothing tool which are spaced apart in a transverse direction to the axis of the adaptor, a first one of the opposite ends is formed by substantially pointed ends of the blades and a second one of the opposite ends is formed by rounded ends of the blades, wherein the second end of the smoothing tool is convexly shaped in the transverse direction between the opposite sides.

The substantially pointed ends of the blades form respective tips of the blades, distinct from the cutting edges. That is, upper edges of the blades, opposite to the bottom edges, converge with the bottom edges to form the substantially pointed ends or tips at the first end of the smoothing tool.

The rounded second end of the smoothing tool is suited for forming a concavely shaped type of the finished surface of the hardened applied flowable substance.

In one arrangement, the second end of the smoothing tool is additionally convexly shaped in a depth direction which is transverse to the axis of the adaptor and the transverse direction. In one arrangement, a filling one of the interchangeable attachment tips configured to apply a filling type of the flowable substance comprises a triangular peripheral edge protruding axially beyond the release opening which is coaxial with the axis of the adaptor, wherein an intermediate surface of the exterior shape between the release opening and the triangular peripheral edge is planar and inclined.

In one arrangement, the release opening is triangular shaped.

In one arrangement, the filling attachment tip includes along one side of the triangular peripheral edge a plurality of axially-extending grooves configured for spreading the applied filling type of the flowable substance.

In one arrangement, a painting one of the interchangeable attachment tips configured to apply a painting type of the flowable substance comprises a plurality of axially-extending parallel pins supported on a planar face oriented orthogonally to the axis of the adaptor and in which the release opening is located.

As such, free ends of the pins are spaced axially from the release opening.

In one arrangement, free ends of the pins are pointed.

In one arrangement, the passageway of the painting attachment tip includes a valve intermediate the mounting and free ends and upstream from the release opening relative to the flow of the flowable substance, wherein the valve is configured to resist flow in an upstream direction from the cavity of the receptacle.

In one arrangement, an absorbent applicator one of the interchangeable attachment tips configured to apply an absorbent type of the flowable substance comprises a generally cylindrical receptacle configured to receive an absorbent pad, wherein a base of the receptacle locates the release opening in a planar surface, wherein the receptacle includes a plurality of spacers supported at spaced positions on the planar surface and defining support surfaces spaced from the planar surface to carry the absorbent pad in spaced relation to the release opening.

Typically, the planar surface at the base of the receptacle is oriented orthogonally to the axis of the adaptor.

Typically, the spacers form therebetween a cavity delimited by the planar surface for the absorbent type of flowable substance to flow outwardly from the axis.

In one arrangement, the passageway of the absorbent applicator attachment tip includes a valve intermediate the mounting and free ends and upstream from the release opening relative to the flow of the flowable substance, wherein the valve is configured to resist flow in an upstream direction from the cavity of the receptacle.

In one arrangement, an adhesive applicator one of the interchangeable attachment tips configured to apply an adhesive type of the flowable substance comprises the release opening in the form of a transversely elongated slit and a plurality of notches in a transversely extending row and arranged to at least one side of the slot for spreading the adhesive type of the flowable substance.

In one arrangement, the adhesive applicator attachment tip further includes a pair of planar guide tabs at opposite ends of the slit and oriented normally to the slot and configured to receive therebetween a workpiece defining the surface to which the flowable substance is to be applied.

In one arrangement, the body of the dispensing container comprises an internal tubular diaphragm adjacent the dispensing tip and having a plurality of sections along a longitudinally-oriented axis of the diaphragm, wherein the diaphragm is generally frustoconical in shape and the sections are collapsible independently of the other for urging the flowable substance to the dispensing tip.

In the illustrated arrangement, the diaphragm is in the form of a ribbed tubular wall which tapers or converges from a first larger end to a second smaller end arranged closer to the dispensing tip than the first end.

In one arrangement, an end of the body opposite to the dispensing tip includes an opening selectively closed by a vent plug, wherein the vent plug forms a passageway extending between an open end exterior to the receptacle formed by the body of the dispensing container and a flap at an opposite end interior to the receptacle and forming a selectively closable opening, wherein the flap is closable responsive to lowering of pressure in the receptacle relative to an ambient environment of the body of the dispensing container so as to conduce movement of the flowable substance out through the dispensing tip.

The opening formed by the flap is normally open. This acts to fill a portion of the interior of the container body between the flowable substance and the vent plug with gas from the ambient environment, which effectively acts to replace a dispensed portion of the flowable substance from inside the body of the dispensing container with air. Thus, after squeezable deformation, the interior of the container body is re-pressurized to an atmospheric pressure of the ambient environment, that is a pressure inside the container is equalized to that of the ambient environment. As the flap is normally open, it permits exchange of gas between the interior of the container body and the ambient environment, including when the pressure inside the container body rises to be higher than that of the ambient environment, for example due to thermal expansion, in which scenario the gas is transferred out of the container body to normalize the pressure inside the container body relative to the ambient environment.

In one arrangement, the end of the body opposite to the dispensing tip includes at least one substantially cylindrical annular body encompassing the vent plug and configured to respectively receive a cap for closing one of the release opening in a respective one of the interchangeable attachment tips and the dispensing opening in the dispensing tip of the dispensing container.

Generally speaking, the annular body is substantially cylindrical so as to support the cap received for storage thereon. Preferably, the annular body includes circumferentially spaced protrusions on its outer surface projecting outwardly from an axis of the annular body to form passageways between the outer surface of the annular body and the cap received in a storage position thereon. In this manner, exchange of gas between the interior of the container body and the ambient environment remains permissible when the cap is stored on the annular body.

In one arrangement, said at least one substantially cylindrical annular body comprises a pair of concentric substantially-cylindrical annular bodies respectively configured to receive different caps respectively configured for closing the release opening and the dispensing opening. In one arrangement, a transfer one of the interchangeable attachment tips configured to transfer the flowable substance to a different dispensing container for applying the flowable substance therefrom and to the surface comprises an adaptor mounting portion defining the mounting end of the transfer attachment tip and an insertion portion defining the free end and locating the release opening, wherein the insertion portion is substantially cylindrical and has reduced outer diameter relative to the adaptor mounting portion so as to be configured to be passed through a release opening of the different dispensing container and into an interior volume thereof for receiving the flowable substance, and wherein the respective interior passageway of the transfer attachment tip extends coaxially of the adaptor axis from the mounting end to the free end.

The insertion portion is substantially cylindrical so as to have uniform outer cross-sectional size and shape across its length in the axial direction for fitting into the release opening of the different dispensing container. Preferably, an outer surface of the insertion portion includes flattened axially-extending portions thereof, which are at angularly spaced locations around the axis of the adaptor/transfer attachment tip. The flattened portions of the outer surface act to provide passageways between the outer surface of the insertion portion and an interior surface of the different dispensing container defining the release opening thereof, to permit exchange of gas between the interior of the container body of the different dispensing container and the ambient environment when the transfer attachment tip is received inside the different dispensing container. Thus, gas inside the different dispensing container is displaceable out therefrom through the passageways between the transfer attachment tip and the release opening of the different dispensing container when the flowable substance is transferred into the different dispensing container via the transfer attachment tip.

In one arrangement, the different dispensing container comprises a rigid body defining the interior volume thereof and an actuator configured to mechanically urge the flowable substance out from the different dispensing container, wherein the different dispensing container further includes a tip defining the release opening of the different dispensing container and configured to respectively receive the interchangeable attachment tips.

For example, the different dispensing container is in the form of a syringe such that the actuator is in the form of a plunger configured to push the flowable substance out of the interior thereof.

### BRIEF DESCRIPTION OF THE DRAWINGS

The invention will now be described in conjunction with the accompanying drawings in which:

FIG. 1 is an isometric view of an assembly of four components of the present invention in use with a commercially pre-filled squeezable caulk tube.

FIG. 1a is an exploded isometric view of the four components of the present invention shown in FIG. 1.

FIG. 2 is a side view of an assembly in use similar to the assembly shown in FIG. 1 with a variation of the adapter component of the present invention shown in FIG. 1.

FIG. 2a is a top view of the assembly in use shown in FIG. 2 taken along line 2-2 of FIG. 2 with a variation of the adapter component of the assembly of the present invention shown in FIG. 1.

FIG. 2b is a sectional view of the assembly in use taken along line 3-3 of FIG. 2a with a variation of the adapter component of the present invention shown in FIG. 1.

FIG. 2c is an enlarged sectional view of view 2c a portion of the assembly shown in FIG. 2b.

FIG. 3 is an isometric view of the adapter component of the present invention.

FIG. 3a is an enlarged view of view 3a of the adapter component a portion of FIG. 3.

FIG. 3b is a perspective front view of the adapter component of the present invention in a different orientation as shown in FIG. 3.

FIG. 3c is a back view of the adapter component of the present invention shown in FIG. 3.

FIG. 3d is a top view of the adapter component of the present invention shown in FIG. 3b.

FIG. 3e is an enlarged sectional view of the adapter component nozzle taken along line 5-5 of FIG. 3d.

FIG. 3f is a sectional view of the adapter component taken along line 4-4 of FIG. 3d.

FIG. 3g is an enlarged sectional view of view 3g of the adapter component a portion of sectional view in FIG. 3f.

FIG. 3h is an enlarged sectional view of view 3h of the adapter component a portion of the sectional view in FIG. 3f.

FIG. 4 is a perspective view of the caulk tool tip component of the present invention.

FIG. 4a is a perspective back view of the caulk tool tip component shown in FIG. 4.

FIG. 4b is a top view of the caulk tool tip component shown in FIG. 4.

FIG. 4c is an enlarged view of view 4c of the caulk tool tip component a portion of FIG. 4b.

FIG. 4d is a sectional view of the caulk tool tip component taken along line 6-6 of FIG. 4b.

FIG. 4e is a side view of the caulk tool tip component of the present invention shown in FIG. 4.

FIG. 4f is a sectional view of the caulk tool tip component taken along line 7-7 of FIG. 4e.

FIG. 4g is a side view of the caulk tool tip component similar to FIG. 4e.

FIG. 4h is a sectional view of the caulk tool tip component taken along line 8-8 of FIG. 4g.

FIG. 5 is a perspective view of the tube clip component of the present invention.

FIG. 5a is a back view of the tube clip component shown in FIG. 5.

FIG. 5b is a sectional view of the tube clip component taken along line 9-9 of FIG. 5a.

FIG. 5c is a bottom view of the tube clip component shown in FIG. 5.

FIG. 5d is a sectional view of the tube clip component taken along line 10-10 of FIG. 5c.

FIG. 6a is a portion of the sectional view shown in FIG. 2b in use with the caulk tube nozzle tip.

FIG. 6b is a portion of a sectional view similar to the portion of the sectional view shown in FIG. 6a of a variation of the caulk tube nozzle tip.

FIG. 6c is a portion of a sectional view similar to the portion of the sectional view shown in FIG. 6b of another variation of the caulk tube nozzle tip.

FIG. 7a is a portion of a sectional view of the adapter cut off gauge of the adapter component of the present invention in use with a variation of the caulk tube nozzle shown in FIG. 6a inserted therein.

FIG. 7b is a portion of a sectional view of the adapter cut off gauge of the present invention in use with another variation of a caulk tube nozzle inserted therein.

FIG. 7c is a portion of a sectional view of the adapter cut off gauge of the present invention in use with another variation of a caulk tube nozzle inserted therein.

FIG. 8 is an exploded perspective view of an assembly of three components of the present invention.

FIG. 8a is a top view of the fill tool tip component shown in FIG. 8.

FIG. 8b is a sectional view of the fill tool tip component taken along line 11-11 of FIG. 8a.

FIG. 8c is a perspective back view of the fill tool tip component shown in FIG. 8.

FIG. 8d is a perspective front view of a variation of the fill tool tip component of the present invention shown in FIG. 8.

FIG. 8e is a perspective front view of the notched tool tip component of the present invention.

FIG. 9 is an exploded perspective view of variation of an assembly of three components of the present invention.

FIG. 9a is a perspective front view of the brush tool tip component of the present invention shown in FIG. 9.

FIG. 9b is a top view of the brush tool tip component shown in FIG. 9.

FIG. 9c is a sectional view of the brush tool tip component taken along line 12-12 of FIG. 9b.

FIG. 9d is an enlarged sectional view of view 9d of the brush tool tip component a portion of FIG. 9c.

FIG. 10 is an exploded perspective view of an assembly of four components of the present invention.

FIG. 10a is a perspective front view of the pad tool tip component of the present invention shown in FIG. 10.

FIG. 10b is an unexploded top view of the assembly of four components shown in FIG. 10.

FIG. 10c is a sectional view of the assembly of four components taken along line 13-13 of FIG. 10b.

FIG. 10d is an enlarged sectional view of view 10d a portion of the assembly of four components shown in FIG. 10c.

FIG. 11 is a perspective view of the notched tool tip component of the present invention.

FIG. 11a is a top view of the notched tool tip component shown in FIG. 11.

FIG. 11b is a sectional view of the notched tool tip component taken along line 15-15 of FIG. 11a.

FIG. 11c is a sectional view of the notched tool tip component taken along line 14-14 of FIG. 11a.

FIG. 11d is an enlarged sectional view of view 11d of the notched tool tip component a portion of FIG. 11b.

FIG. 12 is a perspective view of a brush tool tip a variation of the notched tool tip component shown in FIG. 11.

FIG. 13 is a perspective view of the smoothing tool component of the present invention.

FIG. 13a is a perspective view of the smoothing tool component shown in FIG. 13.

FIG. 13b is a back view of the smoothing tool component shown in FIG. 13.

FIG. 13c is a back view of the smoothing tool component similar to the view shown in FIG. 13b tilted back slightly.

FIG. 13d is a back view of the smoothing tool component similar to the view shown in FIG. 13c tilted back slightly.

FIG. 13e is a back view of the smoothing tool component similar to the view shown in FIG. 13d tilted back slightly.

FIG. 13f is a side view of the smoothing tool component taken along line 16-16 of FIG. 13b.

FIG. 13g is a bottom view of the smoothing tool component taken along line 17-17 of FIG. 13f.

FIG. 13h is an enlarged view of view 13h of the smoothing tool component a portion of FIG. 13g.

FIG. 13i is a sectional view of the smoothing tool component taken along line 18-18 of FIG. 13g.

FIG. 14 is a perspective view of a variation of the smoothing tool component of the present invention shown in FIG. 13.

FIGS. 15a and 15b are perspective views of an assembly of five components of the present invention in use similar to the assembly shown in FIG. 1.

FIGS. 16a and 16b are perspective views of a variation of an assembly of five components of the present invention in use similar to the assemblies in FIGS. 15a and 15b

FIG. 17 is an exploded perspective view of an assembly of two components of the present invention in use with a commercially pre-filled bottle of glue.

FIG. 17a is an unexploded top view of the assembly in use shown in FIG. 17.

FIG. 17b is a sectional view of the assembly in use taken along line 19-19 of FIG. 17a.

FIG. 17c is an enlarged sectional view of the assembly taken along line 20-20 of FIG. 17a.

FIG. 17d is an enlarged sectional view of view 17d of the assembly in use a portion of FIG. 17b.

FIG. 17e is an enlarged sectional view of view 17e a portion of the assembly shown in FIG. 17b.

FIG. 18 is an exploded view of an assembly of six components of the present invention.

FIG. 18a is an enlarged exploded view of two components of the assembly a portion of FIG. 18.

FIG. 18b is an unexploded side view of the assembly shown in FIG. 18.

FIG. 18c is a top view of the assembly shown in FIG. 18b.

FIG. 18d is a sectional view of the assembly taken along line 21-21 of FIG. 18c.

FIG. 18e is an enlarged sectional view of view 18e a portion of the assembly shown in FIG. 18d.

FIG. 18f is an enlarged sectional view of view 18f a portion of the assembly shown in FIG. 18d.

FIG. 19 is a perspective view of the reversible pocket diaphragm component of the present invention.

FIG. 19a is a perspective back view of the reversible pocket diaphragm component of FIG. 19.

FIG. 19b is a top view of the reversible pocket diaphragm component shown in FIG. 19.

FIG. 19c is a sectional view of the reversible pocket diaphragm component taken along line 22-22 of FIG. 19b.

FIG. 20a is a side view of the reversible pressure suppressor diaphragm component of the present invention.

FIG. 20b is a perspective front view of the reversible pressure suppressor diaphragm component shown in FIG. 20a.

FIG. 20c is a perspective back view of the reversible pressure suppressor diaphragm component shown in FIG. 20a.

FIG. 21 is a sectional view similar to the sectional view of the assembly of FIG. 18d. FIG. 21a is an enlarged sectional view of view 21a a portion of the assembly shown in FIG. 21.

FIG. 22 is a perspective view of the vent plug component of the present invention.

FIG. 22a is a top view of the vent plug component shown in FIG. 22.

FIG. 22b is a sectional view of the vent plug component taken along line 23-23 of FIG. 22a.

FIG. 22c is an enlarged sectional view of view 22c of the vent plug component shown in FIG. 22b.

FIG. 23 is an exploded perspective view of an assembly of three components of the present invention in use with a commercially pre-filled caulk tube.

FIG. 23a is an unexploded perspective view of the assembly in use a portion of FIG. 23.

FIG. 23b is an enlarged view of view 23b of the assembly in use shown in FIG. 23a. FIG. 24 is a perspective front view of the transfer tube tool tip component of the present invention.

FIG. 24a is a perspective back view of the transfer tube tool tip component shown in FIG. 24.

FIG. 25 is a side view of the assembly in use shown in FIG. 23a.

FIG. 25a is a sectional view of a portion of the assembly taken along line 26-26 of FIG. 25.

FIG. 25b is a sectional view of the assembly in use taken along line 25-25 of FIG. 25.

FIG. 25c is an enlarged sectional view of view 25c of the assembly in use shown in FIG. 25b.

FIG. 25d is an enlarged sectional view of view 25d a portion of the assembly shown in FIG. 25a.

FIG. 26 is perspective view of an assembly of two components of the present invention.

FIG. 26a is a top view of the assembly shown in FIG. 26.

FIG. 26b is a sectional view of the assembly taken along line 24-24 of FIG. 26a.

FIG. 27 is a sectional view of an assembly of seven components of the present invention in use similar to the sectional view shown in FIG. 21.

FIG. 27a is an enlarged sectional view of view 27a a portion of the assembly in use shown in FIG. 27.

FIG. 28 is an enlarged sectional view a portion of an assembly similar to the portion of an assembly shown in FIG. 18f with a variation of two components of the present invention.

FIG. 29 is an enlarged sectional view a portion of an assembly similar to the portion shown in FIG. 28 with a variation of one component of the present invention and a mixer ball inserted therein.

FIG. 30 is an exploded perspective view of an assembly of seven components of the present invention.

FIG. 31 is a side view of the back portion of a component of the assembly shown in FIG. 30.

FIG. 31a is a sectional view of the back portion of the component taken along line 27-27 of FIG. 31.

FIG. 31b is a top view of the back portion of the component shown in FIG. 31.

FIG. 31c is a sectional view of the back portion of the component taken along line 28-28 in FIG. 31b.

FIG. 32 is a top view of the front portion of a component of the assembly shown in FIG. 30.

FIG. 32a is a sectional view of the front portion of the component taken along line 29-29 in FIG. 32.

FIG. 33 is a top view of a component of the assembly shown in FIG. 30.

FIG. 33a is a sectional view of the component taken along line 30-30 in FIG. 33.

FIG. 34 is a perspective view of a tube clip component of the present invention.

FIG. 34a is a bottom view of the tube clip component shown in FIG. 34.

FIG. 35 is a side view of a variation of the tool tip adapter component of the present invention shown in FIG. 3.

FIG. 35a is a sectional view of the adapter component taken along line 31-31 in FIG. 35.

FIG. 35b is a back view of the adapter component shown in FIG. 35.

FIG. 35c is an enlarged view of view 35c of the adapter component a portion of FIG. 35b.

In the drawings like characters of reference indicate corresponding parts in the different figures.

### DETAILED DESCRIPTION

The accompanying figures show an applicator tool set, comprising multiple independent components used individually or as part of a system, adaptable to a wide variety of commercially available pre-filled dispensing tubes and bottles having many different nozzle profiles, used to dispense, apply, tool and finish various paste like mixtures and various liquids, on smooth, rough or irregular surfaces, has structure to secure itself to a tube nozzle providing an air tight seal, has structure which provides self-guidance, provides a seal to a work surface, can apply and finish most applications in a single pass, has structure to smooth work surface and patch work, can transfer paste like mixtures and liquids to and from various dispensing tubes and bottles, has a cut off gauge for commercially pre-filled tube nozzles, a post to store a cap and tool tip, has structure to contain the emptied rolled portion of a collapsible tube, has a cap when not in use, is tough, durable, easy to use and is easily cleaned.

In other words, there is shown in the accompanying figures an apparatus for applying a flowable substance from a dispensing container to a surface.

Generally speaking, the dispensing container has a body forming a receptacle configured to receive the flowable substance, and the body is deformable for mechanically urging the flowable substance out of the receptacle. The dispensing container further includes a dispensing tip supported on the body in fluidic communication with the receptacle and forming a passageway to convey the flowable substance. The dispensing tip is closed and configured for locating a dispensing opening through which the flowable substance is released from the container.

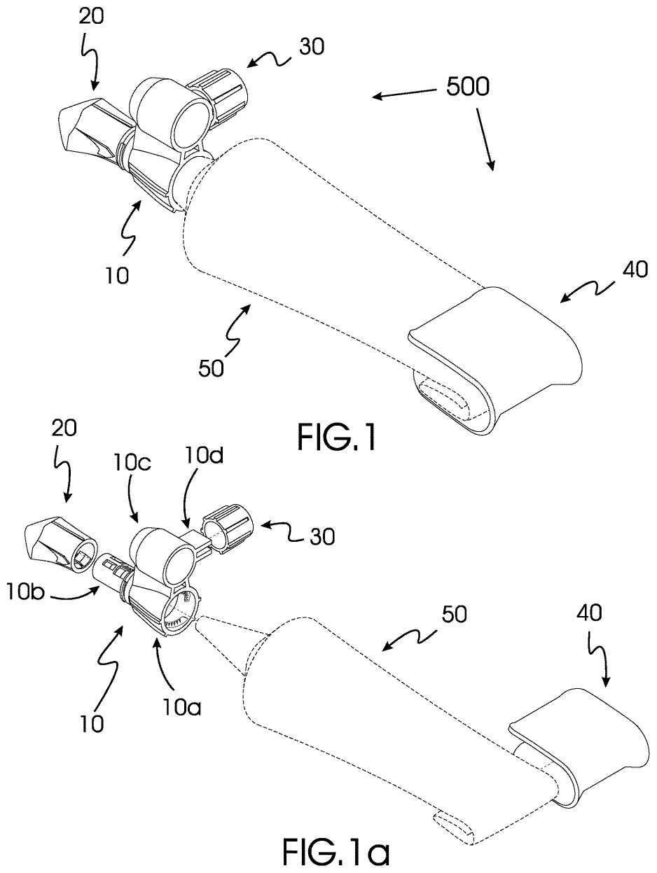

Referring to FIGS. 1 and 1a of the drawings, four components of the present invention described and illustrated herein as an example, an assembly indicated generally at 500 an applicator tool set comprising components a tool tip adapter 10, a caulk tool tip 20, a cap 30, and a tube clip 40, in use with a commercially pre-filled squeezable tube of caulk 50, is shown.

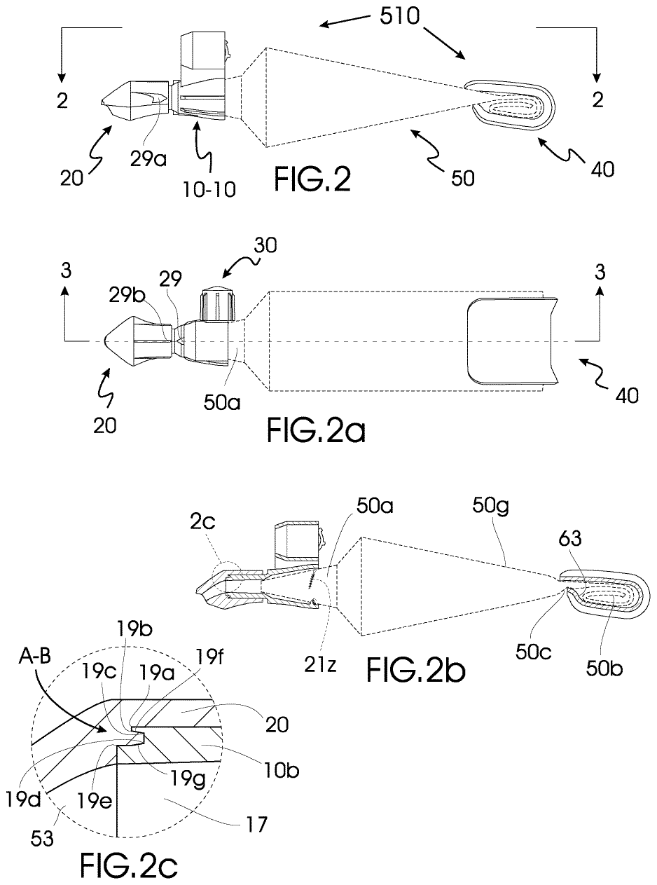

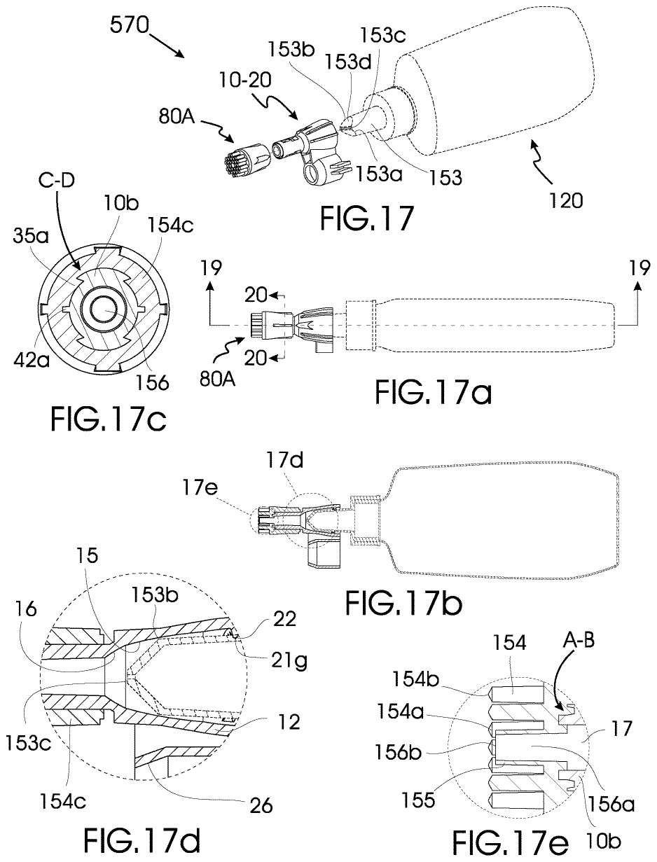

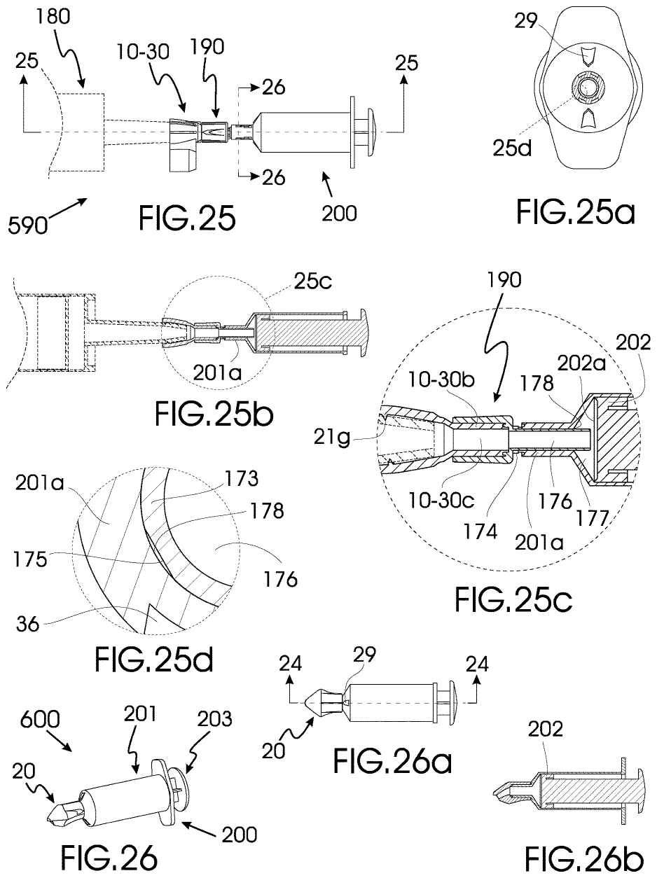

Referring to FIGS. 2, 2a and 2b, a variation of the assembly 500 generally at 510 illustrates a variation of the tool tip adapter component 10 at 10-10, as a simple form having no provisions for attaching the smoothing tool component 70. FIG. 2b also shows a sectional of the caulk tube nozzle 50a of the caulk tube 50 inserted into the adapter 10-10 with the impression 21z of a helical segment 21 and its crest 21g and teeth serrations 22 cutting and pressing into the outside surface of the caulk tube nozzle 50a similar to what's shown in FIGS. 17d and 25c and a sectional of the rolled portion 50b of the caulk tube contained in the tube clip component 40 and the depression of the caulk tube portion 50c gripped and held by the hooked portion 63 of the tube clip component 40.

FIG. 2c is an enlarged sectional view illustrating the common five-point seal zone A-B common to all tool tip to adapter and custom container attachments as described in the caulk tool tip component 20 description.

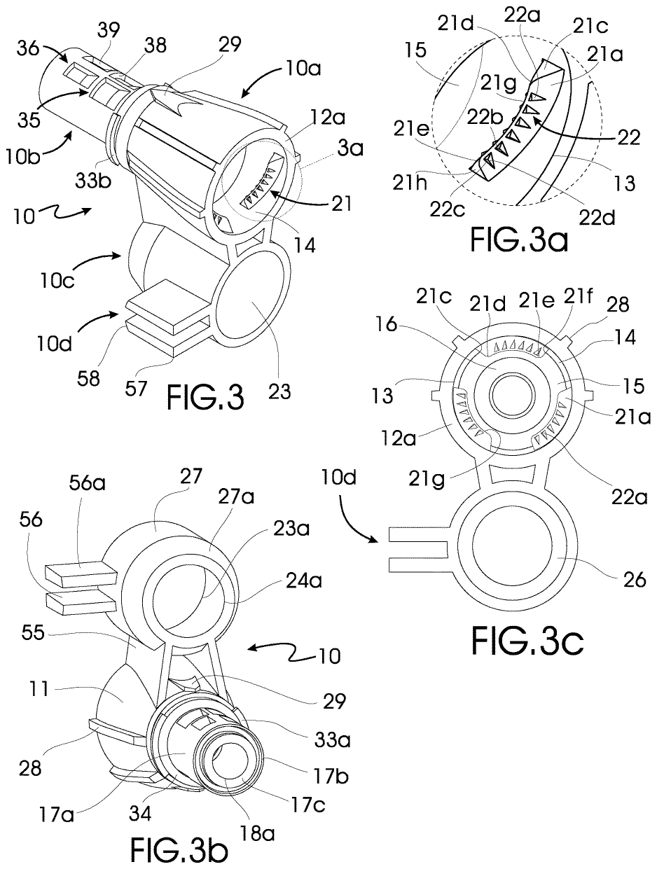

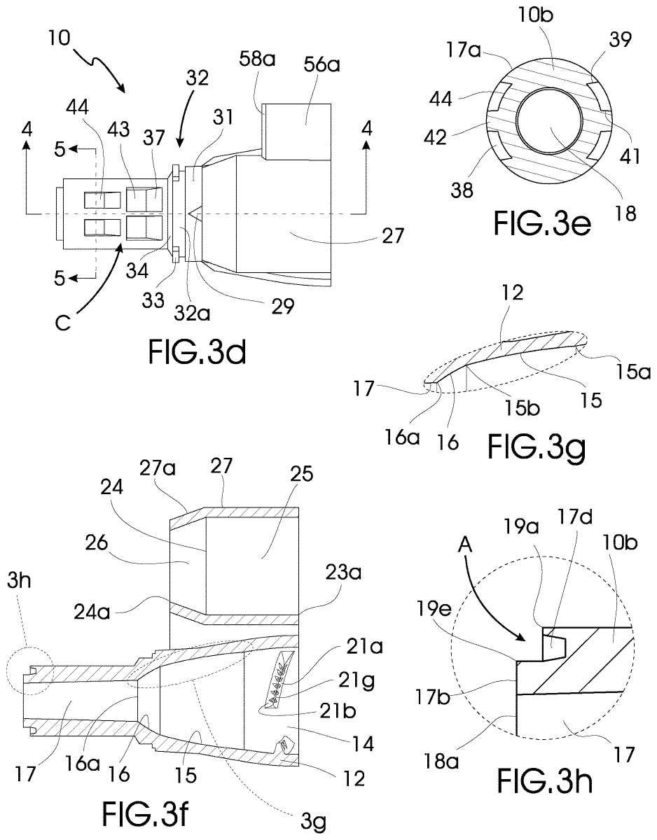

Referring to FIGS. 3, 3b, 3g and 3f of the drawings, the tool tip adapter component of the present invention described and illustrated herein as an example, indicated generally at 10 is shown, comprising three adjoining structures, the body 10a, the nozzle 10b, and the cut off gauge 10c. The body 10a comprises preferably three adjoining frustoconical forms joined at transition points 15a and 15b. The hollow of each form, comprises the back form having a substantially large opening 13 at its base coming off a vertical plane, decreasing in diameter slightly to the start of the mid form 15a, for example one third of the way in, with the mid form decreasing in diameter substantially to the start of the front form 15b, for example four fifths of the way in and the front form, much shorter, decreasing in diameter rapidly, to a much smaller opening 16a than the opening 13 at the base of the back form. The surface of each hollow of each frustoconical form has a circular curvature bowing outward. The inside circular curvature 14 of the back form houses the helical thread segments and the inside circular curvature 15 of the mid form and the inside circular curvature 16 of the front form are beneficial in that the outer edge of a tube nozzle opening is the primary point of contact pressing against the least amount of surface providing a tighter seal, at the best possible pressure point.

The outside surface 11 of the wall 12 of the body 10a would preferably be of a similar form as the inside surface. Alternatively, it would have a single convex curvature surface or may have a flattened conical surface. Finger grips 28 protruding slightly from the outside surface 11 of the body 10a are situated in key locations, preferably two sets of two, opposite each other and together with the cut off gauge 10c and adjoining wall like structures 55 form a comfortable grip when screwing the adapter 10 onto a tube nozzle. Alternatively, the finger grips 28 may comprise multiple partial rings adequately spaced apart, protruding sufficiently from the outer surface 11 of the body 10a extending from the outer surface of one wall 55, wrapping around the outer surface 11 of the body terminating at the outer face of the opposite wall 55. Alternatively, staggered ring segments may be used.

To release a taper to taper mating surface, only a slight reverse movement is used for separation unlike that of a jar and lid where a great deal of force and movement is used as the mated surfaces are compressed, distorted and stretched and the contact structure is altered.

Sufficiently securing the adapter to a sharply tapered nozzle uses friction and many points of compressive resistance. In order to increase the force for backing off the adapter turned onto a tube nozzle, preferably thread segments and serrations are used rather than a full thread rotation. When the adapter is screwed onto a tube nozzle, the nozzle surface is compressed and cut into by the crest of the thread and the sides of the cut are spread apart by the tapered flanks of the thread, the deeper the cut the more this action is increased. When the adapter is left in its secure position the portion of a nozzle surface between the ends of two segments relaxes and being of a somewhat resilient material slightly expands forming a compressive resistant friction point at the back end of each segment. In reverse, extra force is used, to recompress the relaxed portions of a nozzle.

More resistance is used with a sharply tapered tube nozzle. In addition to the thread segments, serrations are added to the face of each flank of each segment which perform similar to the “V” shape of the thread segment further spreading apart the sides of the cut and once the adapter is secure the nozzle surface between each serration expands forming many more compressive resistant friction points at the back of each gripping edge of each serration. Alternatively, fewer serrations are used placed farther apart or more serrations are used placed closer together. The serrations may be of different shapes and sizes, protruding more or less from the face of the flank. In reverse each thread segment and each serration slightly recompresses and reconfigures the nozzle material prior to rotating freely.

These elements are necessary as the objective is to affix and to retain the adapters position on a variety of tapered tube nozzle profiles during use, especially with such a small seat for the nozzle end to seal against.

Alternatively, the inside surface of an adapter would mirror the profile of a specific nozzle adding to the length of the compressive seal between the inside surface of the adapter to the outer surface of the nozzle but would use an adapter for each nozzle profile.

FIGS. 3, 3a and 3c illustrate a preferred means of attaching the tool tip adapter 10 to a commercially pre-filled tube or bottle nozzle. A set preferably of at least three internal male helical thread segments 21 of substantial circumferential length equally spaced circumferentially protruding inward from the inside surface 14 of the adapter body wall 12 with the leading end 21c of each segment 21 starting slightly in from the back face 12a of the body 10a.

Each helical segment 21 comprises preferably a sharp “V” symmetrical flank thread with a substantially large pitch. The leading end face 21c of each segment 21 at its crest 21g angles back into the segment substantially, with the opposite end face 21h angling back much less, at each end of the crest 21g of each segment 21 each point is cut at a curve 21d and 21e gradual to the curvature of the crest 21g through both flanks 21a and 21b providing a gentle introduction of the thread to the outer surface of a tube nozzle when the adapter is rotated, allowing the thread to cut into the nozzle rather than tear or force into it.

Each flank 21a and 21b of each segment 21 on its face is lined with an array or a series of external grip like teeth serrations 22 protruding from the face of the flank following the curvature of the crest 21g but not along the crest, mainly situated in the mid section of the flank providing a clean cutting edge of the crest 21g with the serrations 22 gripping a tube nozzle surface substantially decreasing the risk of the adapter 10 from backing off and breaking the seal when in use, but allowing the adapter 10 to be removed from a tube nozzle with minimal damage to the surface of and the threads which have been cut into the nozzle so when reattaching the adapter 10 to the tube nozzle the gripping characteristics are maintained similar to the previous attachment increasing the number of times an adapter can go on and off the same nozzle.

Each serration 22 comprises three faces at various angles to each other with the longest of the three, the leading face 22a angling back from the leading end 21c of the segment 22 coming away from a flank 21a at an obtuse angle to the face of the flank so that the serration may glide over the nozzle surface when attaching the adapter to the nozzle. The back face 22c is angled almost but not perpendicular to the leading face 22a, back into the face of the flank forming a sufficient gripping edge 22d that is preferably perpendicular to a line tangent to the curvature of the crest at that point where both faces join at the gripping edge 22d. The bottom face 22b is formed by a cut following the same curvature as the curvature of the crest 21g along the face of a flank 21a but not into the flank of the segment 21 at a slight obtuse angle from the face of the flank through both faces of the serration 22 forming a shorter second gripping edge, leaving a slight unobstructed clean cutting edge, the crest 21g of each segment 21. This action increases the gripping of the adapter 10 to the nozzle by adding to the compressive friction of the thread segments 21 to the tube nozzle without tearing away at the tube nozzle during removal of the adapter.

Alternatively, the leading face 22a of the serration 22 may have a concave surface running along the gripping edge 22d for a smoother glide over the tube nozzle surface and the back face 22c may also have a concave surface running along the gripping edge 22d forming a more aggressive sharper grip edge. Alternatively, one or both of these two faces may have a concave surface running perpendicular to the gripping edge 22d converting the edge to a grip point at the juncture of the three faces.

The inside diameter at the crest 21g of the helical segments 21, and the distance from the serrated helical segments 21, to the inside opening of the nozzle passage 16a at the base of the nozzle 10b and the size of the opening 16a, together with the use of the cut off gauge 10c, a high pressure point of seal is achieved, even though supply tube nozzles have such a range of size and shape as shown in FIGS. 7a, 7b, 7c and 17.

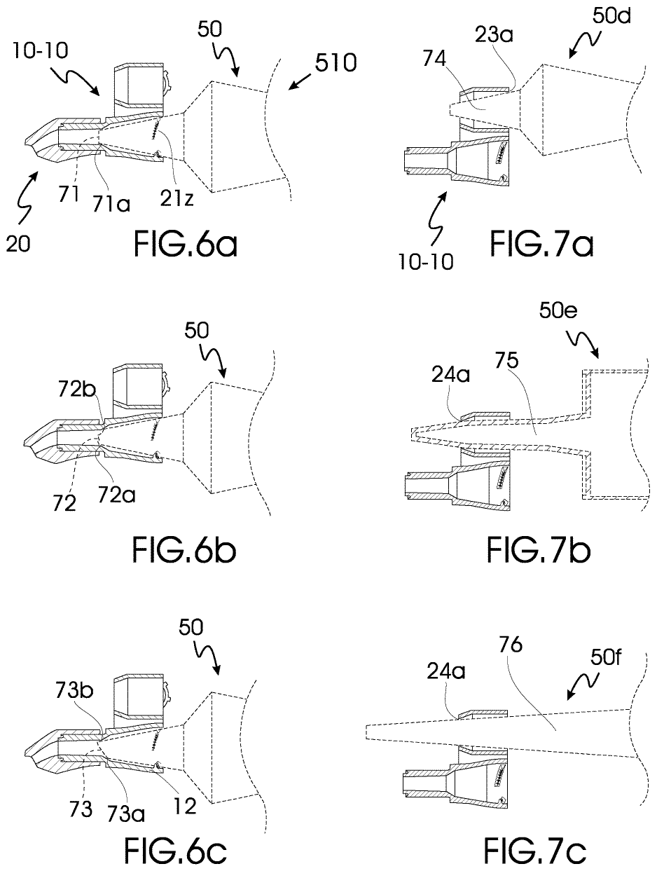

The inside surface curvature of the frustroconical forms of the adapter body 10a are necessary to provide smooth insertion of a tube nozzle and a gentle surface to seal along. Even when a supply tube nozzle is of an irregular shape as shown in FIG. 17d or when its tip has been cut jagged or at an angle as shown in FIGS. 6b and 6c the cut of the nozzle seats sufficiently forming a seal.

In addition to the helical segments 21 and serrations 22, described herein is another embodiment comprising three linear grip ribs (not shown) protruding from the inside surface of the adapter body equal in length, equally spaced circumferentially around the inside surface of the adapter body following its contours, originating at the back edge 15a of the mid frustoconical form, extending into the body 10a up to, but not into the nozzle opening 16a. The rib comprises preferably two concave curved faces opposite each other, facing away from each other, with the leading face having a longer shallower curve than the trailing face, generally both faces are tangent to the curvature of the inside surface of the body, protruding slightly, coming together forming a crest. This form of resistance is added to aid in non-loosening and to maintaining an adapters position on a tube nozzle when in use. Alternatively, the rib could have a slight curve of its entire length clockwise, viewed from the back.

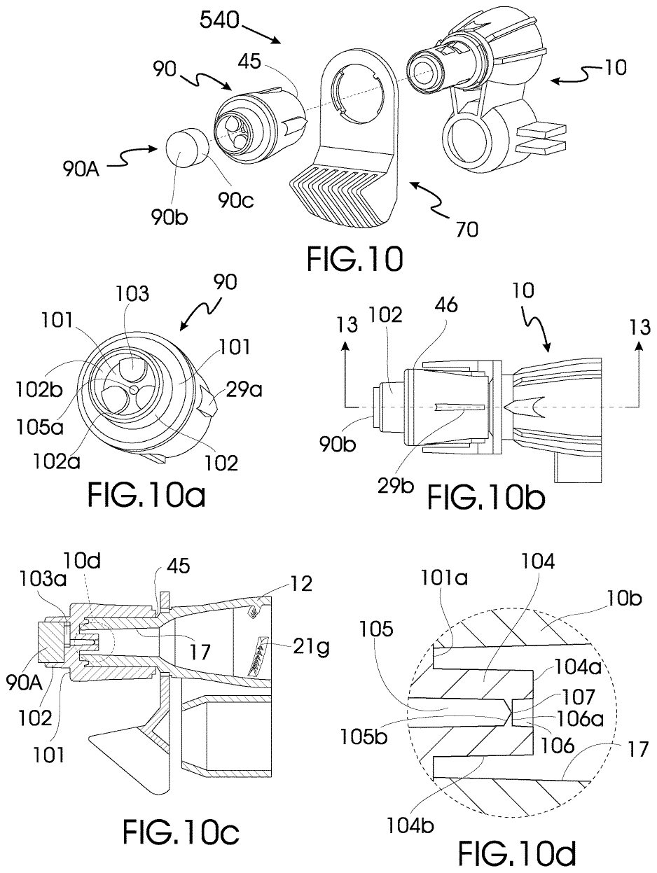

FIGS. 3, 3b and 3d illustrate a means of attachment of the smoothing tool 70 to the adapter body 10a, comprising a cylindrical collar 31 larger in diameter than the outer diameter of the adapter nozzle 10b extending sufficiently from the tapered outer surface 11 of the adapter body 10a toward the nozzle with a second slightly smaller in diameter cylindrical collar 32a extending off the face of the first collar 31 sufficiently enough to accept the thickness of the tab form 144 of the smoothing tool component 70 as shown in FIGS. 10b and 10c a sectional view. The larger back collar 31 of the two collars forms a stop face for the back of the smoothing tool tab 144 to rest against. Preferably, the smaller front collar has two partial rings 33 protruding from its outer surface, slightly larger in diameter than the diameter of the collar 32a. The rings 33 are opposite each other, equal in circumferential length, and each are slightly less than one quarter of its total circumference, extending back from the face of the front collar 32a preferably half the distance of the length of the collar 32a. The sloped front face 34 of the front collar 32a rapidly tapers down to the outer surface 17a of the nozzle 10b. In use the slope helps to guide the smoothing tool onto the collar.

Two alignment arrows 29 protrude from the outer surface of the adapter body 10a and adjoining cylindrical collar 31 generally at the front of the adapter body 10a, opposite each other in the same proximity, in line with each set of grooves.

FIGS. 3, 3b, 3d, 3f and 3h illustrate a tubular like nozzle 10b of substantial length, having a slightly tapered passage 17, through its entirety, protruding linearly from the adjoining end 16a of the front frustoconical form of the adapter body 10a gradually decreasing in diameter terminating at the tip of the nozzle 17b. The outer surface 17a of the nozzle is preferably of a cylindrical form. Preferably, passage 17 is of a cylindrical form similar to its outside surface 17a, similar to passage 10-30c of nozzle 10-30b of adapter 10-30 clearly illustrated in FIG. 25c. The nozzle end comprises two circular end faces, an outer face 17b and an inner face 17c. The nozzle extends from the surface of the outer face 17b slightly adding to the length of the nozzle forming the inner face 17c, its apex. Both faces are divided by a circular cavity 17d. The cavity 17d has tapered side walls 19f and 19g angled slightly inward to each other and is slightly recessed into the outer face 17b. The distance across the opening of the circular cavity and each circular face is preferably similar with the distance across the outer face being the lesser of the three. Advantageously, the outer edge 19a and inner edge 19b of the outer face 17b, the inside outer edge 19c and inside inner edge 19d of the cavity 17d and the outer edge 19e of the inner face are points of the five-point seal zone A as shown in FIGS. 3h and 2c.

As a means of attaching a tool tip to a nozzle and detaching, optimally grips and grooves are preferred. Alternatively, a locking thread and ease release method may be used.

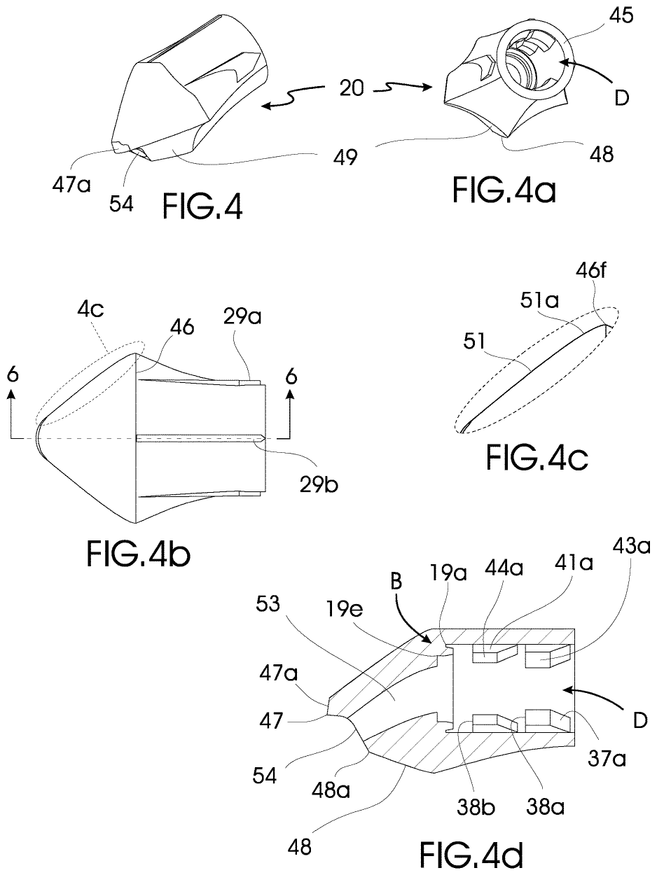

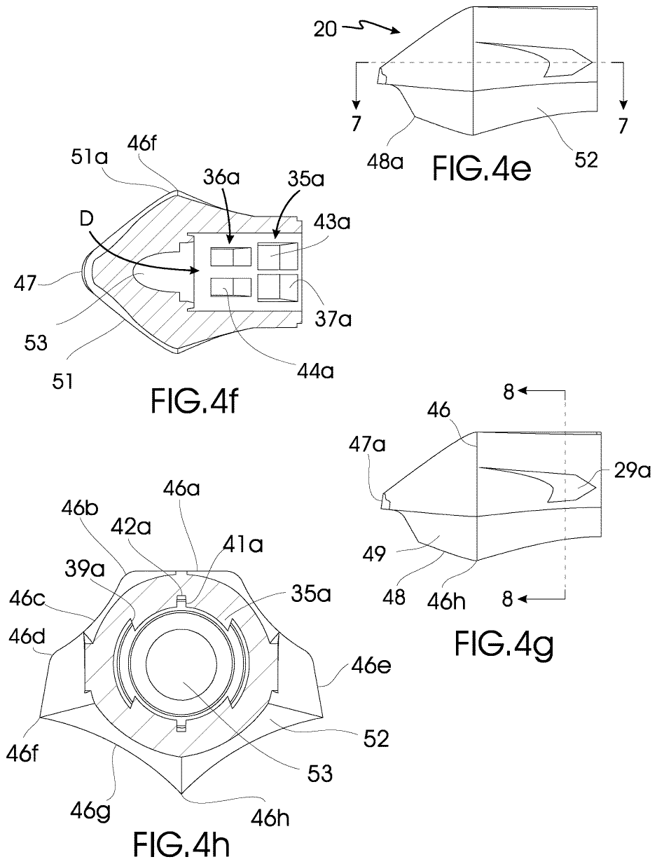

Shown in FIGS. 3, 3d and 3e the outer surface of the nozzle 17a, preferably has two sets of four groove segments Zone C opposite each other recessed into the nozzle around its circumference. Each set has two initial partial grooves 35 and 36 placed linearly along its shaft recessed circumferentially into the outer surface of the nozzle 17a and are of two circumferential widths. Both grooves are preferably of equal depth with the partial back groove 35 closest to the adapter body 10a being substantially wider circumferentially than the partial front groove 36 closest to the nozzle tip, both partial grooves comprise two side faces 39, a front face 38, and a sloped back face 37. Each partial groove is split equally circumferentially with a center rib with rib 42 of the front partial groove 36 being substantially wider circumferentially than the rib 42a shown in FIGS. 4h and 17c of the back partial groove 35, forming two equal segments of each partial groove, with each segment comprising the sloped back face 37 angling back gradually toward the adapter body from the base of the groove 43 and 44 up to the outer surface 17a of the nozzle 10b and a front face 38 rising from the base of the groove 43 and 44 to the outer surface 17a of the nozzle preferably at a right angle and two side faces with the inner side face 41 angling slightly inward at the base of the groove 43 and 44 and the outer side face 39 angling substantially outward at the base of the groove 43 and 44. The form of the back segments is the same as the form of the front segments, the difference being the circumferential width of the ribs and groove segments. The outward angle of each segment side wall 39 forms an aggressive resistance wall for the mating surface of a tool tip grip. Additional resistance walls are added by adding the dividing ribs, substantially increasing resistance to rotational forces caused by surface-to-surface friction and applied pressures of a tool tip in use such as a caulk tool tip.

FIGS. 3, 3b and 3f illustrate the cut off gauge described as being attached to the outer surface of the adapter body 10a with the adapter 10 in the orientation as having the grip form zone and arrow facing upward from a horizontal plane as shown in FIGS. 3b and 3f. Preferably, the means of attachment comprises two wall like structures 55 protruding upward sufficiently from the adapter body 10a, at a slight angle to each other, farther apart at the juncture of the adapter body, centered over and running along the length of the adapter body terminating at the outside surface of the cut off gauge 10c, maintaining vertical alignment of all three structures. In addition the wall like structures provide a means of structural support between the gauge and adapter body forming a finger or thumb location as a superior grip when attaching and detaching the adaptor 10 to a tube nozzle. Alternatively, the two walls may be turned at a right angle running across the adapter body 10a from the center of the adapter body to the left and to the right at least one third of the width of the cut off gauge 10c in each direction, maintaining the alignment. Another alternative, one wall like structure may be used.

The nozzle cut-off gauge 10c comprises a hollow tubular like structure with a cylindrical form as the majority at the back of the gauge and a substantially shorter frustoconical form, at the front of gauge with the back face of the gauge and the back face of the adapter body 10a preferably in line on the same plane. The back opening 23a, the insertion end of the gauge is of a larger diameter than the front opening 24a, the exiting end of the gauge. Described in detail, the back, say preferably four fifths of the gauge is of a cylindrical form and has a much shorter frustroconical form conjoining at its front face. The inside of the gauge is described as a tubular receptacle, a cylindrical hollow 25 rapidly decreasing in diameter to a much smaller exiting end. With the inside diameter of the insertion end being larger than the inside diameter of the much shorter tapered exiting end, together with the total length of the gauge, ensures that a nozzle is cut to the appropriate length. Advantageously, the inside surface 26 of the much shorter front frustoconical form is used to confirm if a previously cut tube nozzle with a profile similar to or as shown in FIGS. 7b and 7c having a rather large opening, is useable with the adapter. When inserted into the gauge 10c, the tube nozzle comes in contact with the inside surface without protruding at the exiting end and is not contacting the back opening, this ensures proper attachment of the adapter, forming a seal. This also applies to an uncut irregular end of a tube nozzle such as a glue bottle 120 tube nozzle 153 shown in FIG. 17.

For convenience, the adapter body 10a and cut-off gauge 10c configuration has a preferable top and bottom dependent on its use, for example when used for caulking, the cut-off gauge would be to the top of the adapter body and when used for filling holes, the cut-off gauge would be to the bottom of the adapter body.

In use, the profile of the glue bottle 120 nozzle 153 shown in FIGS. 17 and 17d was inserted into the cut off gauge 10c and the outer edges 153c of the slotted nozzle tip 153 came in contact with the inside slope 26 at the exiting end and was not cut. Alternatively, the slot may be removed forming a rounder opening of the nozzle. In this instance, screwing on the adapter 10-20 the outer edges 153c of the slotted tip nozzle 153 of the glue bottle 120 came in contact with the inside curvature at the juncture of the mid 15 and front 16 frustoconical forms of the adapter body 10a. Screwing on the adapter 10-20 further, the slotted tip edges 153c and edges 153b and 153a of the tapered flatten sides 153d of the nozzle 153 are gently deformed conforming to the inside curvature of the front form 16 and mid form 15 of the adapter body 10a forming a tight seal. This is an example illustrating that the inside surface of the two adjoining forms are more than adequate to provide sufficient seating for nozzles of many different profiles.

In general use of the cut off gauge 10c, a supply tube nozzle is inserted at the back opening 23 of the gauge and the outer surface of the nozzle comes in contact any where along the inside surface of the gauge, typically at the inside edge of either opening 23a or 24a and the exiting portion of the tube nozzle is cut off.

A storage post 10d comprising two linear wall like structures 56 and 56a sufficiently spaced apart at a distance, preferably, similar to the inside radius of the adapter nozzle cap 30, protruding from the outer surface 27 of the cut off gauge 10c in line with the cylindrical form of the gauge, preferably to the left or to the right of the gauge with the gauge in line with the adapter body 10b vertically off of a horizontal plane as shown in FIG. 3c. The post form protrudes at least far enough to securely retain the adapter nozzle cap 30 when in use or a tool tip when not in use. The back end of each wall has a flat face, while the front, opposite end of each wall has an outward curved face. The outside corner 57 of each back flat face and the curvature 58 of each front curved face are of a slightly larger circumference than the inside diameter of the adapter nozzle cap 30. When stored on the post, the cap would be of a slightly oblong shape, rather than being stretched or forced onto the post maintaining its true circumference when off the post. Alternatively, the post may be turned at a right angle running across the gauge with the outside face of the wall closest to the back of the gauge, being slightly in from the back face. In addition all four ends of the post may have an outward curved face having a radius slightly more than the radius of the inside of the cap.

The preferred embodiment described, wherein the tool tip adapter component of the present invention comprises multiple frustroconical forms, a dual curvature inner surface in relation to the seating of a tube nozzle, has self-threading non-loosening helical thread segments with teeth serrations on both faces, has a five-point seal zone, and a dual position dual split locking groove zone.

The inner form of the adapter body in conjunction with the length from the serrations to the base of the nozzle passage, the five point seal zone, the dual split locking grooves and the use of the tube nozzle cut off gauge achieves the ultimate tool in adaptation providing a means of attaching various tool tips easily and quickly to a wide variety of nozzle profiles having many shapes and sizes such as tapered, sharply tapered and non-tapered nozzles of commercially pre-filled dispensing tubes and bottles. The cut-off gauge ensures adaptability, it is reusable and interchangeable from nozzle-to-nozzle multiple times, maintaining a secure attachment of a tool tip to the adapter sufficiently to achieve and maintain an air tight seal during use and yet is easily removed.

The present invention has at least a five-point seal on all tool tip to tool tip adapter and custom container nozzle connections beneficial in the dispensing of very low viscosity liquids and in eliminating any distortion caused by forces that may be applied to a tool tip in use. The tool tip to adapter five-point seal in conjunction with the split grips on the inside of the tool tip and split grooves on the outside of a nozzle provides an air tight seal and locks the tool tip in place onto a nozzle. This also prevents the tool tip from rotating on the nozzle when in use. Rotation of the tool tip aligns an arrow on the tool tip with an arrow on the adapter or a custom container and the grips of the tool tip come out of the grooves of the nozzle and the tool tip is easily removed with the grips sliding on the smooth section of the nozzle.

Advantageously, tool tips would be manufactured of a singular flexible material, while the adapter would be manufactured of a very rigid material so it can sufficiently attach to a tube nozzle and accept any suitable force that may be applied during use.

Another advantage, even though a tube nozzle is cut jagged or on an angle the inside form of the tool tip adapter body guides the open end of a tube nozzle, seating it sufficiently, forming an airtight seal.

Another advantage, the adapter has a means for the attachment of a smoothing tool.

Another advantage, a user can apply and finish the contents direct from the pre-filled tube or bottle of their choice reducing steps and working time and has the benefit of working with fresh material.

Another advantage, the tool tip adapter attaches to a wide variety of tube nozzle profiles.

The dual curvature inner surface of the adapter body is the optimal surface to guide a tube nozzle to a fixed position, to conform to and to seal against.

The tool tip adapter 10 is preferably fabricated of a generally tough, durable, rigid material of sufficient mass and physical properties. This would prevent the adapter from excessive distortion caused by such conditions as heat or the forces applied therein or thereon. Suitable fabricating materials of the adapter may include metal or preferably thermoplastic resins such as Acetal or Polycarbonate. Optimally the adapter would be fabricated of Acetal. The adapter can be processed in a variety of shapes and sizes and the preferred manufacturing process is injection molding making it economical to produce.

FIGS. 1 and 1a of the drawings, the nozzle cap component of the present invention described and illustrated herein as an example indicated generally at 30 is shown, comprising tubular receptacle closed at one end having an inside diameter similar to the outside diameter of the adapter nozzle 10b and is of sufficient length so when placed on the adapter nozzle the open end of the cap is at least slightly past the front grooves 36. The outside of the cap 30 has an array of linear grips similar to grips 28 of the adapter body 10a shown in FIG. 3b protruding from the outer surface, evenly spaced, from the open end of the cap for much of its length. With the adaptor 10 in use the cap 30 is stored on the post 10d.

The adapter nozzle cap 30 is preferably fabricated of a generally tough, durable, rigid or flexible material of sufficient mass and physical properties. This would prevent the cap from distortion caused by such conditions as heat or the forces applied therein. Suitable fabricating materials of the cap may include metal, thermoplastic resins or preferably silicone rubber or a TPU such as Santoprene. Optimally the cap would be fabricated of silicone rubber. The preferred manufacturing process is injection molding or compression molding making it economical to produce.

Referring to FIGS. 4, 8, 8d, 8e, 9a, 10a, 11, 12, 17 and 24 of the drawings, tool tip components of the present invention described and illustrated herein as an example, have a common tubular receptacle, a trunk, with an extended form which protrudes from the adjoining end face of the trunk and a passage through its entirety for passing paste like mixtures and liquids indicated generally at 20, 60, 60A, 60B, 80, 90, 100, 110, 80A and 190 are shown. Four commonalities are apparent in the preferred means of attachment, detachment and of an airtight seal of the trunk of a tool tip component to the nozzle of an adapter component or a custom container component. Commonalities of the trunk, referring to FIGS. 2c, 4a and 4d comprise a common inside five-point seal form zoneB and a common inside grip form zone D a common inside form of the trunk and a common insertion end 45 of the trunk, common to all tool tip components of the present invention. The outside form of the adjoining face 46 of the trunk is, of various shapes and contours particular to each tool tip, such as circular, rectangular, or irregular. The inside form of the trunk from the insertion end plane to the adjoining end plane, mates to the outer form of the nozzle of components 10, 10-10, 10-20, 131, 10-30, 201 and 131-A from the base of the nozzle to the tip of the nozzle which includes the five point seal form zone A as shown in FIGS. 3h and 2c and the groove form zone C as shown in FIG. 3d. The five-point seal form zone B of a trunk is the female mate to the five point seal form zone A of a nozzle and the grip form zone D of a trunk is the male mate to the groove form zone C of a nozzle. The common five-point seal zone A-B comprises points 19a, 19b, 19c, 19d and 19e of FIG. 2c. The common groove and grip zone C-D a partial shown in FIG. 17c comprises two sets of back grooves 35 and two sets of back grips 35a, two sets of front grooves 36 and two sets of front grips 36a as shown in FIGS. 3 and 4f.

Referring to FIGS. 3, 3d, 3e, 4d, 4f and 4h, surfaces 37, 38, 39, 41, 43 and 44 of a nozzle are mating surfaces to surfaces 37a, 38a, 38b, 39a, 41a, 43a and 44a of a trunk. Generally, the form of the back set of grooves 35 and mating grips 35a is the same as the form of the front set of grooves 36 and mating grips 36a, with the difference being the circumferential width of the groove and mating grip segment such as, the front face 38a and 38b of the grips shown in FIG. 4d and of the divider rib and mating space such as rib 42 of FIG. 3e and rib 42a of FIGS. 4h and 17c. The grips protruding from the inner surface of the trunk and the grooves recessed into the outer surface of a nozzle are mates located specific to each other.

Each zone of the five-point seal form is similar in size, with the male mates of each zone being slightly wider than its female mate. In use, the compressed fit of the five-point seal zone forms an air tight seal and eliminates distortion of the tool tip at the nozzle tip, preventing leakage. This form of attachment of the present invention is superior in that a common tubular receptacle, a trunk, of a tool tip component a preferred embodiment of the present invention fits over the nozzle of a tool tip adapter component or custom container component preferred embodiments of the present invention, securely attaching to the nozzle in at least one secure position.

Another commonality of a tubular receptacle, a trunk, of a tool tip component, is two alignment marks and two alignment arrows protruding from the outer surface of the trunk preferably closer to the insertion end. The marks 29b and arrows 29a on all trunks may vary in shape, length, width and distance that they protrude from the outer surface, due to the outer form of each trunk. Generally, the two alignment marks 29b are centralized to the grip zone D on the inside, circumferentially opposite each other and the two alignment arrows 29a are circumferentially opposite each other at a right angle to the alignment marks 29b.

Advantageously, the back grips 35a are close to the insertion end 45 and wider than the front grips 36a. This is beneficial in that the opening at the insertion end is weaker in its physical properties and more susceptible to stretching. Wider grips thicken the wall at the opening, reducing the circumferential length of a thin wall therefore the opening is less susceptible to stretching. With the back grips wider and in line centrally with the front grips the wider grips pass over the cavity of the narrow front grip during ejection in the molding process.

Partial grips and grooves are used rather than a continuous grip and groove providing a means of easy removal of a tool tip from a nozzle by way of rotation. Advantageously, the grip zone D of a tool tip is of a lesser distance than it's mating surface of a nozzle in relation to the distance from the groove zone C of the nozzle to its apex. This comprises pressing the tool tip on to a nozzle forming a compressed five-point seal at zone A-B. The same would apply to the tapered cavity form 17d of the five-point seal zone A with the male mate of the trunk being slightly wider, and being compressed when the tip is pressed on.

In use, when an adapter or custom container nozzle 10b is inserted into the insertion end 45 of a tool tip, the end 17b of the nozzle comes in contact with the tapered back face 37a of the back grips 35a of both sets, with further insertion the outer surface 17a of the nozzle slides along the inside surface of grips 35a and 36a and eventually the five point seal form zone A of the nozzle comes in contact with the five point seal form zone B of the trunk and with a slight amount of force the five point seal zone B of the trunk is compressed and with an alignment mark 29b of the trunk in line with an alignment arrow 29 of an adapter or custom container, the grips drop into the grooves locking the tool tip in place, ready for use.

To remove, the tool tip is rotated generally one quarter of a turn on the nozzle pulling the grips on the inside of the tool tip trunk up and out of the grooves of the nozzle onto the outer surface of the nozzle, this action aligns an arrow 29a on the tool tip with an arrow 29 on the adapter body or custom container distorting the contact between the inner surface of the tool tip trunk and outer surface of the nozzle substantially reducing overall drag allowing the tool tip to be easily pulled off. In a typical tight fitting cylindrical tube form of attachment, the more the pull the tighter the grip.

When in use as an example, a caulk tool tip 20 is pressed against both surfaces of a gap specifically a right angle inside corner and depending on the surface texture, more surface-to-surface friction is applied to one wiping edge than the other. The dual split locking grips and grooves provide a superior attachment, substantially increasing the resistance to rotational forces caused by a difference in friction, preventing a tool tip from rotating or pulling off of a nozzle during use, eliminating leakage. The grooves of a nozzle have a sloped back face 37 to match the mate surface 37a of the tool tips, where the tool tips have that slope for easy insertion of a nozzle.

To indicate a secure attachment and positioning for easy removal, the adapter and custom container components have alignment arrows and tool tip components have alignment marks and arrows.

The grooves and grips are of sufficient depth and protrusion based on the flexibility of the rubber like material the tool tips are manufactured of, to provide adequate holding power.

Multiple groove and grip segments substantially increase the overall grip necessary to adequately retain a caulk tool tip which is subject to substantial drag and rotational forces caused by surface-to-surface friction and applied pressures. Substantial force is necessary to adequately engage a caulk tool tip to the work surface in keeping a clean edge.

An align mark on the tool tip aligned with an arrow on the adaptor or custom container ensures proper positioning for use.

An arrow on the tool tip aligned with an arrow on the adaptor or custom container allows for easy removal.

Referring to FIGS. 4 and 4a of the drawings, the caulk tool tip component of the present invention described and illustrated herein as an example, indicated generally at 20 is shown, a common tubular receptacle, the trunk, with an extended form that is somewhat of a pyramidal shape and a passage through its entirety for passing paste like mixtures such as caulk.

Referring to FIGS. 2c, 4a and 4d the caulk tool tip 20 comprises a common inside five point seal zone B, a common inside grip zone D, a common inside form of the trunk and a common insertion end 45 of the trunk, common to all tool tip components of the present invention. The outside form at the adjoining face 46 of the trunk is, of an irregular shape particular to the caulk tool tip 20 tapering back to the insertion end 45. The insertion end is on a vertical plane with the adjoining face 46 on a plane parallel to the vertical plane. The irregular shape at the adjoining face 46 of the trunk comprises an upper form and a lower form. The upper form is of a centered flat top 46a of sufficient width with each end rolling down 46b into a slight valley 46c and back out rolling down 46d and outward at a slight angle forming a point 46f where the upper form meets the lower form. The lower form rolls inward from the point 46f curving downward with both curvatures 46g meeting at the center coming to a point 46h ending with a form similar to a “V” with concave faces. The point 46h is of a greater distance from the center axis than is the flat top 46a of the upper form, FIG. 4h helping define the shape.

Referring to FIGS. 4, 4b, 4c, 4e, 4f and 4g the combined upper and lower forms extend substantially from the adjoining face 46, for example two thirds the length of the trunk perpendicular vertically and at a slight angle downward from the horizontal, tapering substantially with the upper form terminating at a point. The lower form terminates firstly at the crest 48 of the “V” for example at two thirds of the distance of the upper form, with the top of the form extending further at an angle and finally at a slight curve tangent to the underside of the top form, terminating short of the upper point forming its apex and somewhat of a flat face, a mouth like form. In general, the “V” shaped underside of the trunk has two concave faces 52 tapering back to the insertion end and the underside of the lower form comprises two concave faces 49 joined at the center, forming a crest 48 extending from its lowest point 46h at the adjoining face 46 and angling up slightly, terminating at a face point 48a at its flat face. The wiping edge 51, 51a formed along the juncture of the upper and lower form, from the apex of the upper form to the adjoining face 46, is slightly bowed outward, for much of its length, at a slight angle outward from a straight line connecting the upper form apex to the juncture point 46f of the upper and lower form at the adjoining face 46, rounding in rapidly to the point 46f forming a dual curvature 51, 51a wiping edge.

This form of wiping edge increases the wiping pressure at the back end and adds to the wiping ability of the tool tip on an irregular work surface while maintaining a substantial length to the wiping edge. The face of each wiping edge along the curved juncture of the upper and lower form, rise up from the edge, at a slight angle inward forming a relief side wall defined as 46e forming a blunt blade like durable wiping edge. The upper form apex 47 of the extension is formed by a radius, preferably specific to the bead size of a particular tool tip, tangent to the long curvature 51 of both edges, cut at a slight angle up from its edge at the underside of the upper form, forming a relief angle face 47a similar to the angle of each wiping edge face. The downward angle from the horizontal of the combined upper and lower extension and the angle of each wiping edge 51, 51a to each other are dependent on the radius of the upper apex 47 or bead size of a particular tool tip and the desired angle of the tool tip to the work surface when in use. The distance of extension of the combined upper and lower form, is dependent on the angle of each wiping edge 51, 51a to each other and the desired angle of the tool tip to the work surface when in use. The distance from the upper form apex 47 to the face point 48a of the lower form crest 48 of the extension is dependent on the form of the upper apex 47 being a point or radius and the angle at which the tool tip is at to the work surface with each wiping edge 51, 51a substantially engaged to the work surface, when in use. The radius of the upper apex 47 determines the bead size. The face point 48a of the crest 48 of the lower form is at a sufficient distance from the work surface to suit the bead size of each particular tool tip with the tool tip at its in use position. For example, a pointed upper form apex and the angle of each wiping edge 51, 51a to each other is a right angle and the preferred use is for finishing small gaps and hairline cracks on trims and moldings, the distance from the face point 48a of the crest 48 to the upper form apex 47 would be substantially less. A circular passage 53 extends from the trunk at the adjoining face 46 curving down gradually at a taper, terminating at the opening 54 of the flat face. The size of the opening 54 and the size, taper and curvature of the passage 53 is suited for the bead size of that particular tool tip. Alternatively, the opening may be of another shape such as triangular or an irregular shape similar to the form of the mouth.

In use, the underside of the tool tip, the concave faces 49, collect any over flow of caulk at over dispensing and deposit some of the collection at under dispensing. When caulking a gap at the junction of two surfaces at a right angle to each other or a slight acute angle, the outer form at the flat face of the tool tip, the mouth, provides a partial seal to the work surface and directs the caulk into the gap. When caulking a gap or crack at the junction of two surfaces at an obtuse angle to each other or on a common flat plane, the outer form of the mouth of an appropriate bead size provides a tight seal to the work surface, directing the caulk into the gap or crack. The bottom “V” form, the crest 48, engages into the gap or crack guiding the tool tip preventing wandering of the tool tip on the work surface.

Optimally, the caulk tool tip 20 has a self guiding “V” like bottom form, dual curvature wiping edge, provides a partial to a full seal to the work surface directing caulk into a gap or crack, various bead sizes that are easily interchangeable and has an easy to clean streamline form. The embodiments described herein typically have the common alignment marks 29b and arrows 29a.

The caulk tool tip 20 is generally fabricated of a tough, durable, pliable, resilient material of sufficient mass and physical properties preventing unnecessary distortion or deformation caused by such conditions as necessary pressure applied for sufficient engagement of the wiping edge to the work surface. Suitable fabricating materials of the caulk tool tip may include silicone, TPU, Dynaflex®, neoprene, PVC, or Santoprene®. Optimally the caulk tool tip would be fabricated of silicone rubber for paste like mixtures other than silicone and TPU thermal plastic urethane for paste like mixtures other than polyurethane, such as various caulks, sealants and non-sanded grouts. The caulk tool tip can be processed in a variety of shapes and sizes. The preferred manufacturing process is injection molding or compression molding making it economical to produce.

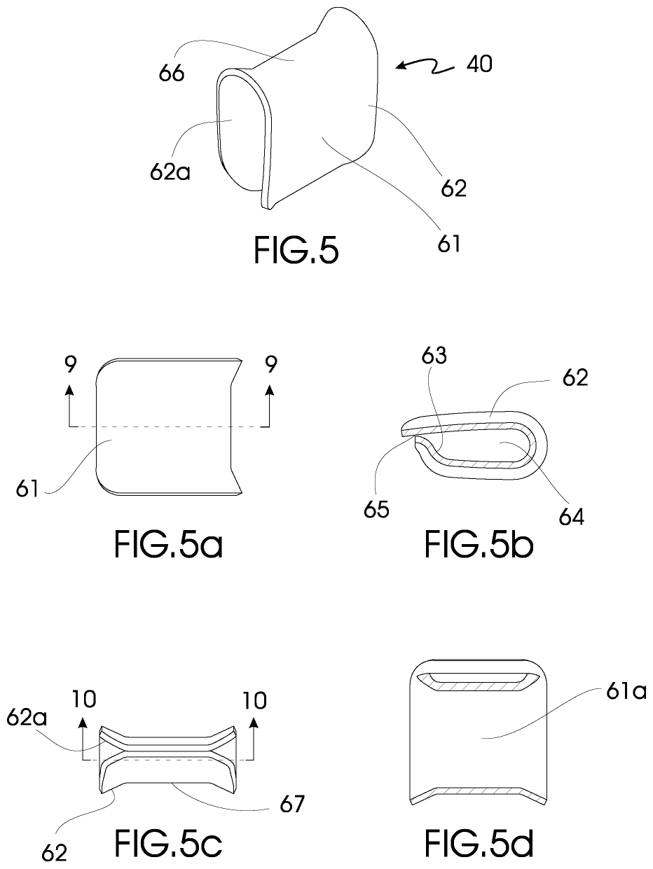

Referring to FIG. 5 of the drawings, the tube clip component of the present invention described and illustrated herein as an example, indicated generally at 40 is shown, is somewhat of a “U” shaped tubular receptacle open at both ends with a slit along the bottom, used for retaining the rolled portion of a squeezable tube.

Referring to FIGS. 5a, 5b, 5c and 5d the tube clip 40 comprises a preferably longer back side 61 slightly bowed out, a “U” shaped top 66 and a front side 67 angling inward slightly along much of its length, rapidly curving in and back out at the bottom, forming a slight hook 63 with its inside face 65 almost touching and almost parallel to the opposite face 61a. A substantial portion of each open end 62 of the clip 40 flare out substantially providing a much wider opening 62a for easy insertion of a rolled tube and a structure to maintain its somewhat closed shape when in use, preventing the clip from opening and popping off.

When in use the rolled portion of a squeezable tube is inserted from either end 62a with the back inside 61a of the clip 40 against the flatter face 50g of the supply tube 50 and the rolled portion 50b comes to rest against the inside of the hook 63 of the tube clip 40. When the tube is squeezed it has a tendency to re-expand applying force where the clip is closed onto the tube 50c as shown in FIG. 2b. Sectional views FIGS. 5b and 5d help define its shape. The tube clip 40 allows the user to quickly and easily maintain an expanded supply tube giving the user better control over the dispensing and tooling of the material being dispensed, securely containing the rolled up portion 50b of the squeezable, collapsible tube 50.

Tube clip 40 is preferably fabricated of a generally tough, durable, rigid material of sufficient mass and physical properties. This would prevent the tube clip from excessive distortion caused by such conditions as heat or the forces applied therein or thereon, for use with squeezable tubes containing paste like mixtures such as caulk, spackle, fillers and adhesive, such as Liquid Nails® or No Nails®. Suitable fabricating materials of the tube clip may include metal, fiberglass or preferably thermoplastic resins such as Acetal or Polycarbonate. Optimally the tube clip would be fabricated of Polycarbonate. The tube clip can be processed in a variety of shapes and sizes. The preferred manufacturing process is injection molding making it economical to produce.

FIGS. 6a, 6b and 6c illustrate sectional views of a portion of, or similar to a portion of the sectional view shown in FIG. 2b of the cut nozzle end of commercially pre-filled squeezable tubes 50 in use with adapter 10-10 a variation of adapter 10, having no curvature to the inside surface of the body and no provision for attaching a smoothing tool 70. Nozzle end 71 has a clean cut and the point of seal is the edge of the adapter nozzle opening 71a. Nozzle end 72 has a jagged cut with the seal from 72a to 72b. Nozzle end 73 is an angled cut with the seal from 73a to 73b.

FIGS. 7a, 7b and 7c illustrate various nozzle profiles in use with the cut off gauge 10c. Nozzle 74 comes in contact with inside edge of the back opening 23a, nozzle 75 comes in contact with the inside edge of the front opening 24a and nozzle 76 also comes in contact with the inside edge of the front opening 24a. The nozzle portion protruding from the exiting end of each gage is cut off.

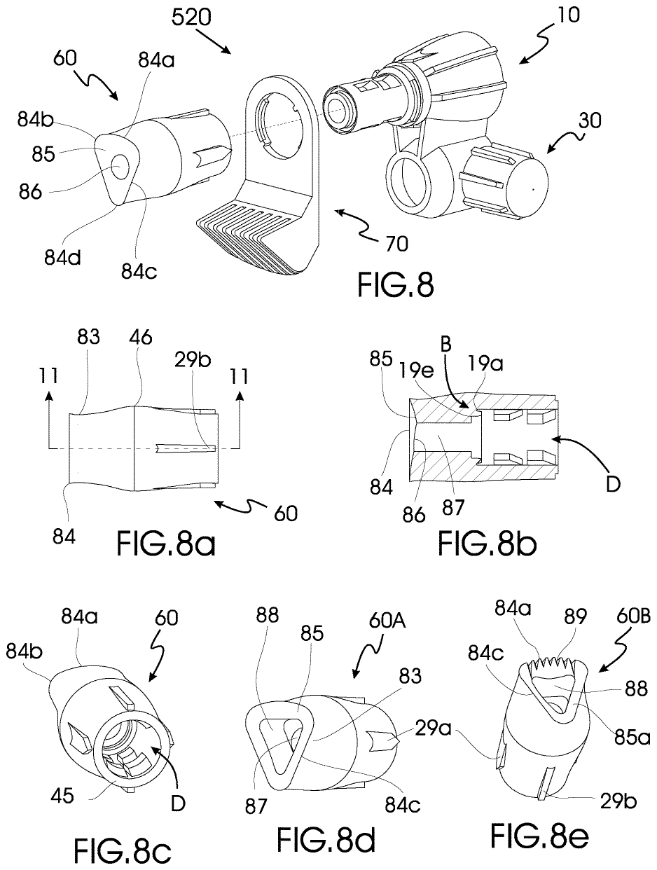

Referring to FIGS. 8, 8a, 8b and 8c of the drawings, the fill tool tip component of the present invention described and illustrated herein as an example indicated generally at 60 is shown, a common tubular receptacle with the trunk, having an extended circular form with a triangular face, and a passage through its entirety for passing paste like mixtures such as spackle.

Referring to FIGS. 8b and 8c the fill tool tip 60 comprises a common inside five point seal zone B, a common inside grip zone D, a common inside form of the trunk and a common insertion end 45 of the trunk, common to all tool tip components of the present invention. The outside form at the adjoining face 46 of the trunk is, of a circular shape particular to the fill tool tip 60 tapering back to the insertion end 45. The insertion end is on a vertical plane with the adjoining face 46 on a plane parallel to the vertical plane. The circular shape at the adjoining face 46 of the trunk extends from the adjoining face 46 substantially narrowing down gradually, for example two thirds of the way, to a neck like form 83 and widening gradually to a flat front face 85, the face being of a somewhat triangular shape with rounded corners 84b and 84d, with two angles 84c being equal in length and longer than the third, and the third angle having a curvature 84a to the outside, tangent to the curvature of the two corners 84b. The two corners 84b having a common radius and the third corner 84d a smaller radius tangent to the two sides 84c. The innermost surface of the neck form 83 is slightly less of a distance from the center axis than the radius of the outside diameter of the adjoining face 46. The outermost edge of each corner 84b and 84d is of a substantially greater distance from the center axis than the radius of the outside diameter of the adjoining face 46 and the outermost edge of each side 84c and 84a is of a similar distance. From the outer edge of the face 85 inward, the face 85 is slightly concave. The concave face 85 is beneficial. When in use, the face 85 is pressed onto a work surface and a seal is easily formed around the edge of the face directing the dispensed material where intended. Another advantage is, the passage 87 size is increased to the point of contact, decreasing the accuracy used to cover the void being filled. With a concave face 85 and the edge of the face narrowing to a neck form 83, a slightly flexible smoothing wiping blade is formed. Alternatively, a more rigid blade is formed with the outer edge of the face having a slight chamfer angling outward down toward the neck 83, or the edge may be cut off slightly forming a thickened edge (both variations not shown). A circular passage 87 similar in size as the passage of an adapter or custom container nozzle extends from the tubular receptacle at the adjoining face 46 through to the opening 86 at its face 85. FIG. 8d illustrates another embodiment 60A similar to embodiment 60 with the passage 87 having an enlarged opening 88 at the dispensing end to aid in filling larger cavities. FIG. 8e illustrates another embodiment 60B similar to embodiment 60A having a substantially deeper concave face 85a and a series of notches 89 cut through the curved edge 84a in its entirety at a depth suitable for applying and spreading paste like adhesives. The embodiments described herein typically have the common alignment marks 29b and arrows 29a.

The fill tool tip 60 and 60A is best suited for paste like mixtures such as spackle and filler. The preferred use is to fill holes from a brad nail, finishing nail, small screws on installed pre-finished and unfinished trim, moldings and holes on finished surfaces such as walls. The notched tool tip 60B is used to apply and spread caulk adhesives such as silicone, urethane and sticky adhesive mixtures such as Liquid Nails® or No Nails®, all available in commercially pre-filled tubes.

Optimally, the fill tool tip 60 and 60A seals to the work surface directing applied mixture into a void, the patch is wiped smooth in one stroke. It eliminates over fill, conforms to uneven surfaces and many surface profiles. Grooves and small gaps and cracks are easily filled.

Optimally, the notched tool tip 60B seals to the work surface and evenly applies paste adhesive in one stroke at the notched end, conforms to uneven surfaces and many surface profiles.

Tool tips 60, 60A and 60B are generally fabricated of a tough, durable, pliable, resilient material of sufficient mass and physical properties preventing unnecessary distortion or deformation caused by such conditions as the necessary pressure applied for sufficient engagement of the tool tip to the work surface. Suitable fabricating materials of a fill tool tip may include silicone, TPU, Dynaflex®, neoprene, PVC, or Santoprene®. Optimally the tool tips would be fabricated of silicone rubber for paste like mixtures other than silicone and TPU thermal plastic urethane for paste like mixtures other than polyurethane. The tool tips can be processed in a variety of shapes and sizes. The preferred manufacturing process is compression molding or injection molding making it economical to produce.

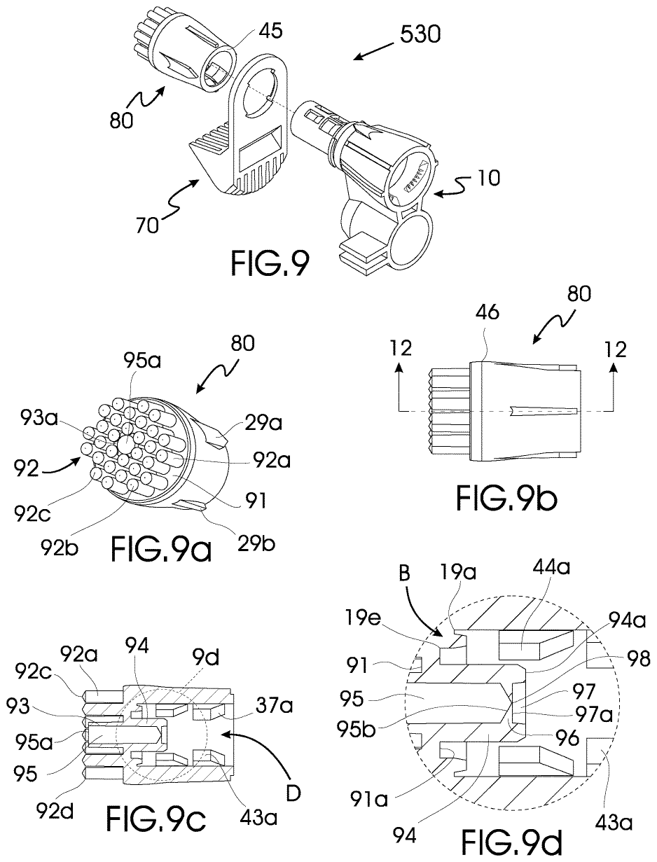

Referring to FIGS. 9, 9a, 9b, 9c and 9d of the drawings, the brush tool tip component of the present invention described and illustrated herein as an example indicated generally at 80 is shown, a common tubular receptacle, the trunk, with an extended solid circular form with a circular passage through its entirety for passing low viscosity liquids such as latex paint.

Referring to FIGS. 9c and 9d the brush tool tip 80 comprises a common inside five point seal zone B, a common inside grip zone D, a common inside form of the trunk and a common insertion end 45 of the trunk, common to all tool tip components of the present invention. The outside form at the adjoining face 46 of the trunk is, of a circular shape particular to the brush tool tip 80 tapering back to the insertion end 45. The insertion end is on a vertical plane with the adjoining face 46 on a plane parallel to the vertical plane. The circular shape at the adjoining face 46 of the trunk extends from the adjoining face 46 slightly, forming a preferably circular base, having a substantially flat front surface 91 and a substantially flat back surface 91a. Tool tip 80 has a multiplicity of pins 92 protruding horizontally from the front surface 91 of the base. The pins 92 comprise a generally circular form at the base 91 gradually decreasing in diameter for most of its length, with the end portion of a pin having a conical form 92b terminating at a drill point at its apex 92c. The circular edge 92d at the end of a pin is preferably rounded and alternatively the tapered circular form of the outer surface 92a of a pin could be cylindrical. Tool tip 80 has a set of circular tubular forms comprising a front tube 93 and a back tube 94. The front tube 93 protrudes from the front surface 91 of the base at the center of the base terminating at its apex 93a at a lesser distance than the pins. The outside diameter of the tube 93 is large enough to conjoin to the six surrounding pins forming a feed channel. With the opening 95a of the passage 95 being at a slight distance from the work surface, liquids are applied directly to the surface and easily spread by the pins. The back tube 94 is of a slightly larger diameter, but no more than the inside diameter of an adapter or custom container nozzle and protrudes horizontally from the back surface 91a of the base, substantially, and in line with the front tube 93. The passage 95 in the base extends through the front tube 93 in its entirety and through the back tube 94 sufficiently, terminating inside the back tube 94 for example four fifths of the way in, forming a closed passage having two sloped faces 95b opposite each other sloping at a slight angle further into the tube joining at the center. At the end of the back tube is a short slightly tapered circular passage 97, the supply opening to the entire passage, having a slightly larger diameter than the front passage at the end face 94a of the tube extending into the tube reducing in size to the same diameter as the front passage 95 terminating at the juncture at the center edge of the two sloped faces 95b at the closed end of the front passage forming a slit 98. The form remaining in the passage on each side of the slit is of a wedge shape 96. The slit 98 joins the front passage 95 to the back passage 97 forming a restriction for the passing of liquids. The slit 98 is formed at the outer end of a free standing structure, eliminating distortion of the slit from any forces that may be applied in the attachment of the tool tip to a nozzle such as the stretching of the base, maintaining the slit profile.

Optimally, the circular inside face 97a of the back passage 97 would terminate slightly before the juncture at the center edge of the two sloped faces 95b at the closed end of the front passage 95 and the slit would be cut in a post fabrication process forming a slit with two opposing faces having a normally closed position (not shown). The length of the opposing faces determines the force for opening the slit.

Optimally, the inside circular face 97a of the back passage 97 would be of a similar form as the sloped faces 95b at the closed end of the front passage 95, such that the circular face of the back passage would have two sloped faces similar to and in line with the two sloped faces 95b of the front passage 95, joined at the center sloping into the passage at less of an angle than the slope faces of the front passage (not shown). Optimally the slit is formed in a post fabrication process resulting in the slit having a normally closed position.

Advantageously, in both optimal forms the slit receives more pressure to pass liquids as the slit flaps are forced forward. In doing so the flaps press against each other until such point as they begin to come apart at the trailing edges and finally flip in the opposite direction toward the exiting end of the passage and as long as the flow of liquid continues the flaps remain in the forward orientation. When the flow stops the resilient properties of the tool tip would flip the flaps to their normally closed position. Alternatively a slight portion of each flap could be detached from the wall of each passage at each end.

The restrictive slit prevents the oozing of medium and low viscosity liquids when the dispenser is left in a horizontal position, even with slight thermal expansion. Alternatively the base of the tool tip may have an irregular top surface and may be of shapes such as oval or rectangular. Alternatively the front tubular form may be smaller in diameter and at the center of a triangular group of three pins in a group of for example three tubes in a triangular pattern to fit with the pattern of the pins 92. Each passage is supplied individually or by way of a manifold. Alternatively the single passage would be of a different shape such as a linear tube and slot similar to 124 and 125 of FIG. 12. Optimally, the pins 92 are arranged in a staggered or equilateral triangular grid pattern, and are substantially close together. Alternatively, the pins may be farther apart and larger in diameter or of a cylindrical form similar to pins 123a in FIG. 12 and may be hollow or tubular. The pins 92 may be arranged in various patterns such as groups of four or more pins, irregular or concentric circles. The embodiments described herein typically have the common alignment marks 29b and arrows 29a.

The brush tool tip 80 is preferably used with low viscosity liquids such as paint, generally fabricated of a tough, durable, pliable, resilient chemical resistant material of sufficient mass and physical properties preventing unnecessary distortion or deformation caused by such conditions as necessary pressure applied for sufficient engagement of the tool tip to the work surface. Suitable fabrication materials are silicone, TPU, Dynaflex®, neoprene, PVC, or Santoprene®. Optimally the brush tool tip would be fabricated of silicone rubber. The tool tip can be processed in a variety of shapes and sizes. The preferred manufacturing process is injection molding or compression molding making it economical to produce.

Referring to FIGS. 10, 10a, 10b, 10c and 10d of the drawings, the pad tool tip component of the present invention described and illustrated herein as an example indicated generally at 90 and an absorbent pad at 90A is shown, a common tubular receptacle, the trunk, with an extended solid circular form with a substantially small diameter passage through its entirety for passing very low viscosity-water thin liquids.

The pad tool tip 90 comprises a common inside five point seal zone B, a common inside grip zone D, a common inside form of the trunk and a common insertion end 45 of the trunk, common to all tool tip components of the present invention.

The outside form at the adjoining face 46 of the trunk is, of a circular shape particular to the pad tool tip 90 tapering back to the insertion end 45. The insertion end is on a vertical plane with the adjoining face 46 on a plane parallel to the vertical plane. The circular shape at the adjoining face 46 of the trunk extends from the adjoining face 46 slightly, forming a preferably circular base, having a substantially flat front surface 101 and a substantially flat back surface 101a. The pad tool tip 90 has a tubular nozzle 102 having an outside diameter of for example three quarters the outside diameter of the trunk protruding horizontally from the front surface 101 of the base at the center of the base terminating at its apex 102a at a length of say one third the length of the trunk forming a receptacle 102 to retain an absorbent pad 90A. The diameter of the inside 102b of the receptacle 102 is slightly less than the diameter of the outside forming a thin stretchy wall. On the inside of the receptacle 102 there are at least three pad like spacers 103 having a substantially flat face, comprising three sides with the fourth side abutting to the inside wall 102b of the receptacle, two sides opposite each other are straight sides at a sufficient distance apart and the side closest to the center opposite the abutting wall 102b is curved outward toward the center keeping slightly back from the edge of the passage opening 105a. The spacers 103 protrude slightly from the front face of the base 101, forming channels 103a between the spacers 103 and around the passage opening 105a. A much smaller diameter back tubular form 104 having an outside diameter 104b slightly larger than the diameter of the passage 105 protrudes horizontally from the back surface 101a of the base in line with the front receptacle 102 and at a similar length as the receptacle. The substantially small diameter passage 105 in the base extends through the back tube 104 sufficiently, terminating inside the back tube 104 for example four fifths of the way in, forming a closed passage 105 having two sloped faces 105b opposite each other sloping at a slight angle further into the tube joining at the center. At the end of the back tube is a short slightly tapered circular passage 106, the supply opening to the entire passage, having a slightly larger diameter than the closed passage 105 at the end face 104a of the tube 104 extending into the tube 104 reducing in size to the same diameter as the closed passage 105 terminating at the juncture at the center edge of the two sloped faces 105b of the front passage, forming a slit 107. The slit 107 joins the front passage 105 to the back passage 106 forming a restriction for the passing of liquids. The slit 107 is formed at the outer end of a free standing structure, eliminating distortion of the slit from any forces that may be applied in the attachment of the tool tip to a nozzle such as the stretching of the base, maintaining the slit profile.

Optimally, the circular inside face 106a of the back passage 106 would terminate slightly before the juncture at the center edge of the two sloped faces 105b at the closed end of the front passage 105 and the slit 107 would be cut in a post fabrication process forming a slit with two opposing faces having a normally closed position (not shown). The length of each opposing face affects the amount of force for opening the slit.

Optimally, the inside circular face 106a of the back passage 106 would be of a similar form as the sloped faces 105b at the closed end of the front passage 105, such that the circular face of the back passage would have two sloped faces at a lesser angle than and in line with the two sloped faces of the front passage, joined at the center sloping forward (not shown).

Optimally the slit is formed in a post fabrication process resulting in the slit having a normally closed position.

Advantageously, in both optimal forms the slit receives more pressure to pass liquids as the slit flaps are forced forward. In doing so the flaps press against each other until such point as they begin to come apart at the trailing edges and finally flip in the opposite direction toward the exiting end of the passage. As long as the flow of liquid continues the flaps remain in the forward orientation. When the flow stops the resilient properties of the tool tip would flip the flaps to their normally closed position. The restrictive slit prevents the oozing or leaking of very low viscosity liquids when the dispenser is left laying down, even with slight thermal expansion. The embodiments described herein typically have the common alignment marks 29b and arrows 29a.

An absorbent pad 90A comprising a cylindrical shape of substantial thickness, has a diameter slightly larger than the inside diameter of the receptacle 102 of the pad tool tip 90 the pad is inserted into the receptacle coming to rest against the face of each spacer 103. The resilient walls 102b of the receptacle are stretched by the larger diameter pad 90A and the inside wall 102b of the receptacle grip the outer surface 90c of the pad retaining the pad in place. The face 90b of the pad protrudes slightly farther than the apex 102a of the receptacle 102.

In use, liquid exiting the passage at the opening 105a flows through the channels 103a which act as a manifold and quickly saturate the pad 90A ready for use. Alternatively, the outer edge of the face 90b of the pad 90A would be rounded or the face 90b could be rounded in its entirety. The substantially small diameter passage 105 in conjunction with slit 107 are necessary to maintain the flow of water thin liquids. Optimally a normally closed slit similar to slit 107 would eliminate oozing and leaking and maintain the flow of water thin liquids. Without the use of spacers the passage opening 105a is easily blocked by the absorbent pad substantially restricting the flow. Alternatively the base of the tool tip may have an irregular top surface and may be of shapes such as oval or rectangular.

Alternatively, the back tubular form 104 could have a squished mid section with a much larger opening at the end face 104a and the slit would be cut in a post fabrication process forming a normally closed slit. In use, the pressure of dispensing would bulge out the squished portion of the tube opening the passage 105. When the flow stops the slit closes (not shown).

The pad tool tip 90 is preferably used with very low viscosity liquids such as alkyd paint and sealers, urethane, stain, shellac, primer and is generally fabricated of a tough, durable, pliable, resilient chemical resistant material of sufficient mass and physical properties preventing the tool tip from excessive distortion or deformation caused by such conditions as wear or the forces applied therein or thereon. Suitable fabricating materials such as silicone, TPU, Dynaflex®, neoprene, PVC, or Santoprene® are used. Optimally the tool tip would be fabricated of silicone rubber. The tool tip can be processed in a variety of shapes and sizes. The preferred manufacturing process is injection molding or compression molding making it economical to produce.

The pad 90A is preferably used with very low viscosity liquids such as alkyd paint, urethane, stain, shellac, primer and is generally fabricated of a durable material of sufficient mass and physical properties having chemical and wear resistance preventing deterioration. Suitable fabrication materials are natural or synthetic felt or foam rubber. Optimally the pad would be fabricated of felt. The preferred fabrication process is die cut making it economical to produce.

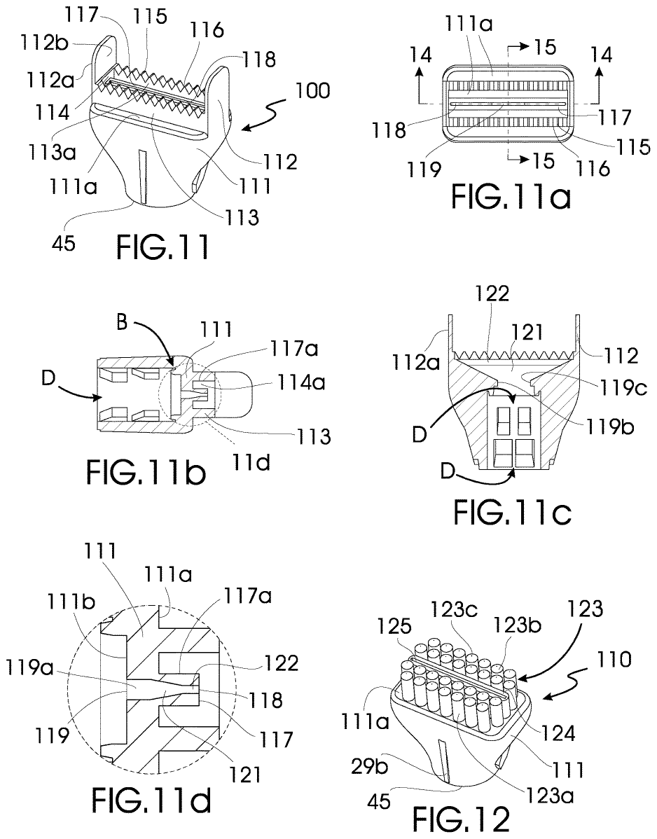

Referring to FIGS. 11, 11a, 11b, 11c and 11d of the drawings, the notched tool tip component of the present invention described and illustrated herein as an example indicated generally at 100 is shown, a common tubular receptacle, the trunk, with an extended solid rectangular form with a passage through its entirety for passing and applying medium viscosity liquids such as PVA glue to the edge of an object.

The notched tool tip 100 comprises a common inside five point seal zone B, a common inside grip zone D, a common inside form of the trunk and a common insertion end 45 of the trunk, common to all tool tip components of the present invention. The outside form at the adjoining face 46 of the trunk is, of a rectangular shape particular to the notched tool tip 100 tapering back to the insertion end 45. The insertion end is on a horizontal plane with the adjoining face 46 on a plane parallel to the horizontal plane. The rectangular shape at the adjoining face 46 of the trunk extends from the adjoining face 46 slightly, forming a preferably rectangular base 111, having a substantially flat top surface 111a and a substantially flat bottom surface 111b.

The physical dimensions of the rectangular base 111 are such that the long sides 113 of the base 111 are sufficiently longer than the thickness of an object such as a wooden board particular to that specific tool tip. Protruding sufficiently from the top surface 111a of the base 111 vertically is a rectangular tubular like form similar to the rectangular form of the base 111 with the outer face of each end wall of the tubular form flush to each end face of the base. The substantially longer side walls 113 run parallel to the sides of the base, set in slightly from each side face of the base equally. Each of the four walls are similar in thickness. A series of “V” shaped notches 116 of sufficient depth and width are preferably spaced equally in a linear pattern along the entire top 115 of each long side wall 113. Optionally one wall would have shallower, narrower notches for applying a thinner layer of adhesive. Alternatively one wall would maintain a flat un-notched top surface.

Protruding substantially from the top surface 115 of each end wall vertically, are two tab like structures 112 with rounded corners at half the thickness of the end wall with the outside face 112a of each tab flushed to the outside face of the end wall. The tabs serve as guides, when in use in applying liquid adhesive to the edge of a board. Preferably the edge of the inside face 112b of each tab is eased allowing for a smoother glide along the face or faces of a board. Alternatively one tab is removed or detachable or is able to rotate allowing the user to apply adhesive to the edge of a board at double the thickness, in two quick passes. Another rectangular tubular form 117 substantially narrower protrudes from the top surface 111a of the base 111 vertically centered on the inside of the outer tubular form between each inside face 113a, abutting to the inside face 114 of each end wall, with its top surface terminating at the bottom of the notches 116 forming a rectangular tube with a slot 118. Slot 118 comprises three sections having different widths across its opening, from the top of the slot gradually widening down to the underside of the base. A narrow section 122 at the top slightly down into the tube, a wider mid section 121 and a substantially wider bottom 119a at its opening 119 between two side walls 119b and 119c. Opposite to the width of the slot, each end 118 of the slot tapers substantially with the length of the slot decreasing rapidly from the top of the tube 117 down to the top of the bottom section joining to the side walls 119b and 119c which are parallel to each other as shown in sectional views FIGS. 11b, 11c and 11d.

In use, the narrow opening at the top of the passage restricts the flow forcing the liquid adhesive along the opening dispensing the adhesive evenly.

Each void 114a between each inside face 113a of the outer tubular form and each outside face 117a of the inner tubular form is a receptacle for overflow and provides an immediate supply to aid in applying a smooth uniform layer of adhesive. Alternatively each void may be wider and slightly tapered. Adhesive is applied and spread evenly on the edge of a board in one pass. Tool tip 100 can be fabricated of different widths suitable for different board thicknesses.

Brush tool tip 110 shown in FIG. 12 has the same form from the insertion end 45 to the top surface 111a of the base 111 as the notched tool tip 100 shown in FIG. 11. The brush tool tip 110 is a variation of the brush tool tip 80 of FIG. 9a having a multiplicity of pins 123 in a different configuration protruding vertically from the top surface 111a of the base similar to pins 92. The pins 123 a preferred embodiment are of a cylindrical shape 123a rather than tapered with the top portion of the pin 123b having a conical form terminating at a drill point 123c at the top of the pin. Tool tip 110 has a dispensing tube 124 and passage 125 similar to tool tip 100, having rounded ends. Both tool tip components 100 and 110 described herein typically have the common alignment marks 29b and arrows 29a.

Alternatively tool tip 110 would have a full array of pins protruding from its top surface having a similar delivery passage as tool tip 80 with at least three tubular forms each at the center of a triangular group of three pins having a restrictive slit circular passage with each passage supplied by a manifold. The preferred use is for low viscosity liquids such as latex paint. The rectangular arrangement with a staggered pattern of pins has the benefit of more coverage and faster spreading for large paint touch ups. Alternatively, the surface of the conical form 123b of each pin 123 at each end could be convex for applying less adhesive along the edges and the remaining pins, the conical form would gradually convert to a concave surface of the pins at the center for applying more adhesive. Alternatively, the pins would be more pointy in the center and gradually less pointy at the ends, but all pins would be at the same distance from the base to their apex, again applying less adhesive along the edges and more in the middle.

Notched tool tip 100 and brush tool tip 110 are preferably used with low and medium viscosity liquids and are generally fabricated of a tough, durable, pliable, resilient material of sufficient mass and physical properties preventing the tool tips from excessive distortion or deformation caused by such conditions as wear or the forces applied therein or thereon. Fabrication materials such as silicone, TPU, Dynaflex®, neoprene, PVC, or Santoprene® are used. Optimally the tool tips would be fabricated of silicone rubber and can be processed in a variety of shapes and sizes. The preferred manufacturing process is injection molding or compression molding making it economical to produce.

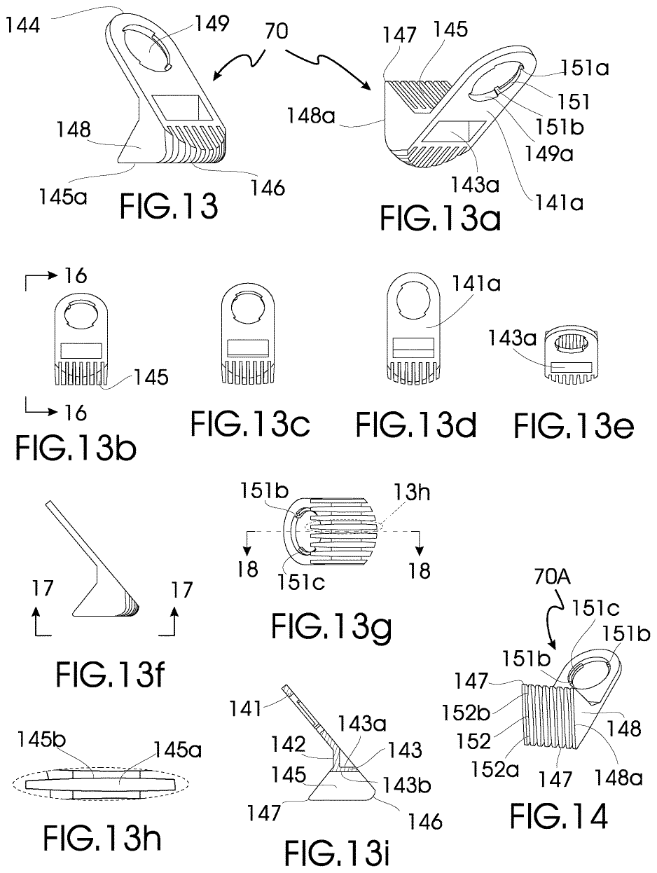

Referring to FIGS. 13, 13a, 13g, 13h and 13i of the drawings the smoothing tool component of the present invention described and illustrated herein as an example indicated generally at 70 is shown, a multi-blade smoothing tool plane like device with a wiping edge on each outer face. An apparatus having a plurality of blade like structures protruding down from the angled face of a tab like form and the tab having a hole like form through the top of the tab for mounting the tool onto a tool tip adapter or custom container.

The smoothing tool 70 comprises a shoe like form, a series of several blade like structures 145 having curved sides 145b and sloped end faces, a base 143 at the top 143b of the blades 145, a tab 141 coming off of the base 143 at an angle and a hole 149 through the tab 141 at its top end 144. Each blade has two long faces 145b opposite each other with each face bowed outward with the blade 145 being wider at its center and substantially narrower at the front end and slightly narrower at the back end as shown in FIGS. 13g and 13h. Optimally the blades would substantially narrower at both ends. Alternatively each face may be made up of multiple angles as shown in FIG. 14. Each blade is of sufficient length from end to end at its bottom surface 145a and protrudes upward vertically from a horizontal plane sufficiently, terminating to a substantially flat top surface 143b substantially shorter in length than the bottom surface 145a, and somewhat centered over it. Both ends slope inward at a similar angle forming a sloped front face and a sloped back face with the back sloped face at slightly more of an angle inward. The blades 145 are slightly spaced apart evenly in a linear pattern at a right angle to their long form, forming a rectangular flat top surface 143b of the blades. The outer surface 148 of the two outside blades are flat each forming a wiping blade at its bottom outside edge 148a. In use with a fill tool tip, a large void is filled and may be wiped or smoothed with either blade using a side motion. FIG. 13i illustrates a rectangular base 143 protruding slightly from the top surface of the blades 143b with the front face 142 and both side faces protruding vertically and the back face protruding at an angle following the angle of the back end face of the blades. The top of the base 143 terminates with its top face at an angle perpendicular to its sloped back face having the same distance across the short of its face as the thickness of the tab 141 and length of the collar 32a of adapter 10 in FIG. 3d. The base is hollowed 143a from the back face as shown, alternatively it may be hollowed from the front face. A tab like form 141 of sufficient thickness, equal to the length of the collar 32a in FIG. 3d is an extension of the angled top surface of the base, extending vertically from the top surface of the base substantially, maintaining the same slope as the back face of the base and blades.

The tab is substantially longer than its width having a hole through its entirety from the front face to the back face 141a at the top end 144 of the tab 141 having a diameter no less than the outside diameter of the ring segments 33 of attachment zone 32 of adapter 10 in FIG. 3d. Preferably the hole 149 has two ring segments 151, each equal in circumferential length, opposite each other and each are slightly less than one quarter of its total circumference, protruding from the inside surface 149a of the hole 149, inward to an inside diameter of no less than the outside diameter of the collar 32a of attachment zone 32 of adapter 10 shown in FIG. 3d. Both ring segments 151 protrude into the hole 149 from the back face 141a of the tab 141 to preferably half the distance of the thickness of the tab 141. The front face 151c of each segment is a mate to the back face 33b of ring segment 33. At the trailing end opposite end 151a of each ring segment 151 having the same inside diameter as each ring segment, a stop block 151b of minimal sufficient circumferential length protrudes from the back face 141a of the tab terminating at the front face. With the smoothing tool mounted on the adapter 10 the configuration of the ring segments 151 and stops 151b of the tab are of the same configuration as the ring segments 33 of zone 32 with each ring segment 151 of the tab 141 in line with and between each ring segment face 33b and the front face of the stop collar 31 of FIG. 3d. Each stop block 151b rests against the leading end face of each ring segment 33 of the adapter 10 fixing the tool in place.

The blades 145 are at least close enough to efficiently trim off a protrusion but not close enough to plug with debris. The front end 147 of each blade 145 is slightly eased, tangent to both the bottom and the sloped front surface allowing the tool to ride up onto a large protrusion gently trimming it down. The back end 146 of the blades 145 are of a curvature outward of a substantial radius cut from a horizontal plane through their entirety, forming a foot print of the tool on a horizontal having a straight front and a curved back with the outer blades being the shortest and the central blades being the longest. The bottom edge of each blade at the curved end is also eased, tangent to the horizontal bottom face and vertical end face of each blade as shown in FIGS. 13, 13f and 13g.

FIG. 13b is a back view of FIG. 13 with the bottom surface of the smoothing tool 70 sitting flat on a horizontal plane for use on a flat surface. FIG. 13c is a back view of the smoothing tool 70 similar to the view shown in FIG. 13b with the tool tilted back slightly showing a slightly curved bottom for use in a shallow concave profile of a molding. The radius of the curvature changes with the angle that the tool is held at. The more the tool is tipped back, the radius of the curvature decreases as shown in FIGS. 13d and 13e. The smoothing tool can be used on most any molding and trim profile such as in sharp grooves, inside and outside curvatures, flat faces and inside and outside corners.

The smoothing tool 70 easily attaches to an adapter or custom container for smoothing patches and surfaces when filling, priming and painting, is self dressing, maintaining each sharp cutting edge, cannot gouge out patches and outlasts sanding paper main times over.

To remove the smoothing tool from the adapter rotate the smoothing tool in the reverse direction till stop blocks come to rest against the opposite segment ends.

In use the smoothing tool is moved forward and back gently trimming off protruding excess fillers, and particles dried in the finish with no visible damage to the finished surface.

Alternatively, another embodiment would have the blades angling back slightly from the back face of the tool.

FIG. 14 illustrates smoothing tool 70A a variation of smoothing tool 70 with the cutting edge of each blade having a straight mid section 152 and a short angle 152b at the front of the blade and a slightly longer angle 152a at the back of the blade and both ends 147 of each blade slightly eased similar to the front end 147 of each blade of smoothing tool 70.

The smoothing tool 70 and 70A are preferably fabricated of a generally tough, durable, rigid material of sufficient mass and physical properties. This would prevent the smoothing tool from excessive distortion caused by such conditions as heat or the forces applied therein or thereon. Fabricating materials are thermoplastic resins such as Acetal or Polycarbonate. Optimally the smoothing tool would be fabricated of Acetal and can be processed in a variety of shapes and sizes. The preferred manufacturing process is injection molding making it economical to produce.

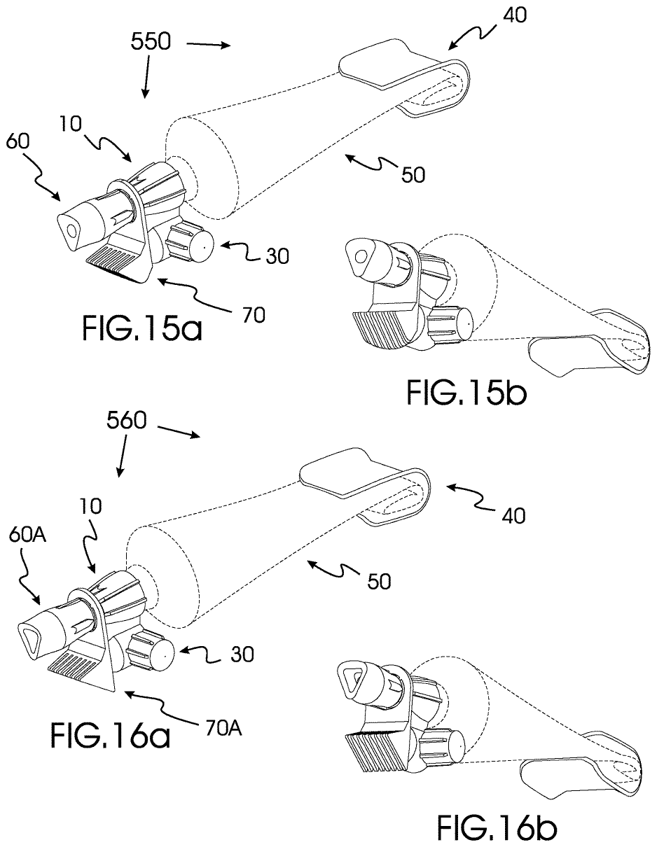

Referring to FIGS. 15a and 15b of the drawings, are perspective views of five components of the present invention as an example, an assembly indicated generally at 550 an applicator tool set comprising components an adapter 10, a smoothing tool 70, a fill tool tip 60, a cap 30, and a tube clip 40, in use with a commercially pre-filled squeezable tube of spackle 50, is shown, for filling small holes, gaps and cracks on pre-finished or non-finished surfaces such as installed trim and molding and finished walls.

Referring to FIGS. 16a and 16b of the drawings, are perspective views of five components of the present invention as an example, an assembly indicated generally at 560 an applicator tool set comprising components an adapter 10, a smoothing tool 70A a variation of smoothing tool 70, a fill tool tip 60A a variation of fill tool tip 60, a cap 30, and a tube clip 40, in use with a commercially pre-filled squeezable tube of spackle 50, is shown, for filling small and larger holes, gaps and cracks on pre-finished or non-finished surfaces such as installed trim and molding and finished walls.

Referring to FIGS. 17 and 17a of the drawings, illustrating two components of the present invention as an example, an assembly indicated generally at 570 an applicator tool set comprising components adapter 10-20 a slight variation of adapter 10 and brush tool tip 80A a slight variation of brush tool tip 80, in use with a commercially pre-filled squeezable bottle 120 of medium viscosity liquid adhesive such as PVA white glue, is shown, for applying and spreading glue when doing projects such as crafts or installing pre-finished or non-finished trim and molding, for applying adhesive to abutting ends and edges.

FIG. 17c illustrates the back portion of the attachment zone C-D with the common nozzle form 10b mating with the tubular form 154c specific to tool tip 80A and 80, and an open tubular passage 156 of tool tip 80A.

FIG. 17b is a sectional view of FIG. 17a outlining two views 17d and 17e.

FIG. 17d illustrates the uncut tube nozzle 153 of glue bottle 120 inserted into adapter 10-20 a slight variation of adapter 10 showing the crest 21g and serrations 22 of a thread segment slightly embedded into the tube nozzle 153 of the glue bottle 120 with the edges 153b and 153c of the glue bottle coming in contact with the inside surface 15 of the adapter body wall 12. Screwing on the adapter 10-20 further deforms the tube nozzle 153 end and fully seat the tube nozzle 153 against the inside surface 15 and 16 of the adapter body wall 12 forming an airtight seal.

FIG. 17e illustrates tool tip 80A a variation of tool tip 80 as being the same with the exception of the delivery passage. Tool tip 80A is described as having a tubular form 155 with a smooth inside surface 156a of a fully open passage 156, with the end 156b of the tubular form 155 terminating slightly before the tip 154b of each pin 154. The pins 154 are the same as pins 92 of tool tip 80. Alternatively, the surface of the conical form 154a of each pin could be convex for applying less adhesive and concave for applying more adhesive. Also shown is the common five point seal zone A-B.

Adapter 10-20 is a slight variation of adapter 10 as having the preferred dual curvature inside form of the adapter body, but is missing zone 32 in FIG. 3d the means of attaching a smoothing tool 70.

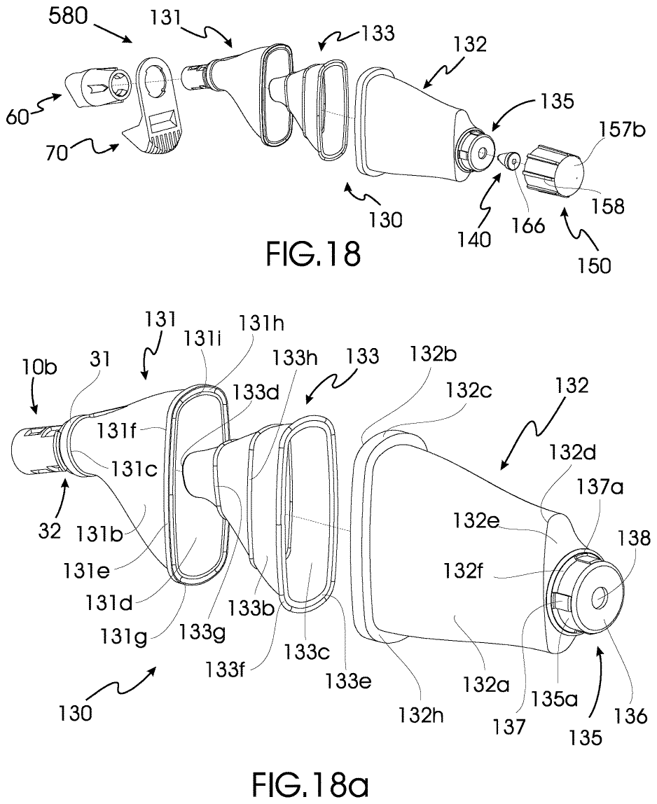

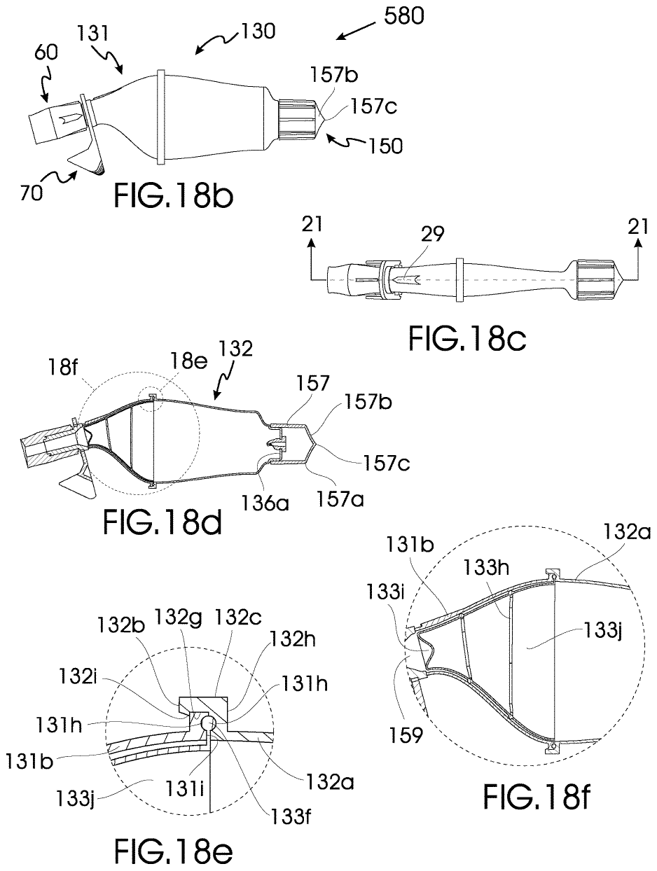

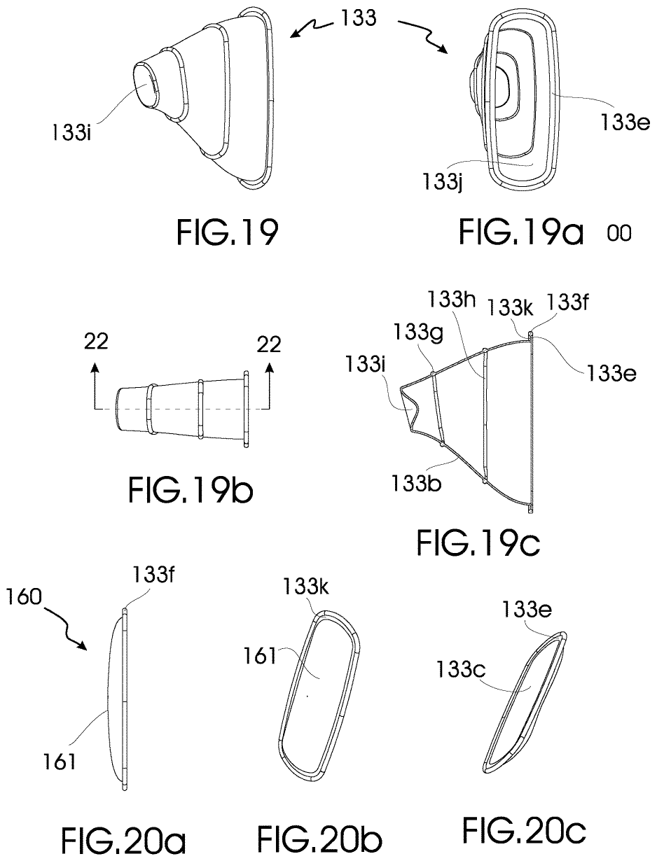

FIG. 18 of the drawings, illustrates six components of the present invention as an example, an assembly indicated generally at 580 an applicator tool set comprising a fill tool tip 60, a smoothing tool 70, a sub assembly 130 comprising a custom two piece container 131 and 132 and a reversible pocket diaphragm 133, a vent plug 140 and a cap 150, is shown.

FIGS. 18, 18b, 18c and 18d of the drawings illustrate the cap 150 described as a tubular receptacle having an array of finger grip ribs 158 evenly spaced around the outer surface of its side wall 157 and a pointy closed end. The inside diameter is of a sufficient size to snugly fit over the tool tips described herein when left on the custom container nozzle and not in use, with the exception of tool tip 20, 100, and 110. These tips are removed and the nozzle of the custom container is capped with the nozzle cap 30. Alternatively, a nozzle cap 30 storage post similar to post 10d of FIG. 3 may be added at the back of the container form 132. The cap 150 is further described as a circular side wall protruding substantially from its open end perpendicular to the face of the open end terminating at a length slightly longer than the length of a tool tip. The closed end is of a cone like shape having a concave surface 157b, extending from the outer edge 157a at the top of the side wall 157 terminating at a point 157c. Using kind of a rotating rolling motion, the pointy end 157c of the cap 150 is used for pressing in the protruding frayed edges of a hole in materials such as wood or paper faced surfaces. The concave form 157b gently rolls in the fray rather than bulging it out.

Alternatively, the cap could have a moistened pad inserted against the inside surface of the closed end keeping the contents moist over long periods of time.

The custom cap 150 is preferably fabricated of a generally tough, durable, rigid material of sufficient mass and physical properties. This would prevent the cap from excessive distortion caused by such conditions as the forces applied therein or thereon. Suitable fabricating materials of the cap may include metal or preferably thermoplastic resins such as Acetal or Polycarbonate. Optimally the cap would be fabricated of Polycarbonate. The preferred manufacturing process is injection molding making it economical to produce.

Referring to FIGS. 18 and 18a of the drawings, a sub assembly of the present invention described and illustrated herein as an example indicated generally at 130 is shown. The assembly comprises a squeezable, resilient custom two-piece container component having a front form 131 and a back form 132 with a reversible pocket diaphragm component 133 inserted therein.

The front form 131 comprises a tubular form with a substantially thin wall 131b coming off a vertical plane horizontally, having somewhat of a symmetrical oval opening 131d at the back of the tube, reducing in size substantially to a circular form 131c at the front of the tube. The circular form tilts down forward so the face is somewhat perpendicular to the top linear edge of the tube such that the top of the circular form is in line with the top of the tube. This makes it possible to get the tool tip right up against objects. Protruding off the face of the circular front of the tube is the common collar 31, the common smoothing tool mounting zone 32 and nozzle 10b of adapter 10 shown in FIG. 3d. The opening 131d at the back of the form 131 has a rim 131e of sufficient thickness protruding outward sufficiently from the outside surface of the wall 131b of the tube 131 completely around the opening, giving the tube structure and a face 131g of suitable width to accept a groove 131h and a slight recess to the inside face 131i of the rim 131e at the inside of the groove 131h. The groove 131h is of a half circle formed into the back face 131g of the rim 131e. To the inside of the groove 131h, the face 131i of the rim is slightly recessed to accept almost half the thickness of the rim of a diaphragm 133e. The back form 132 has the same recess and when assembled the bead 133f and rim 133e of a diaphragm 133 or 160 are compressed forming an airtight seal between the face 131i of the front tube rim 131e and the face 133k shown in FIG. 19c of a diaphragm rim 133e as shown in FIG. 18e.

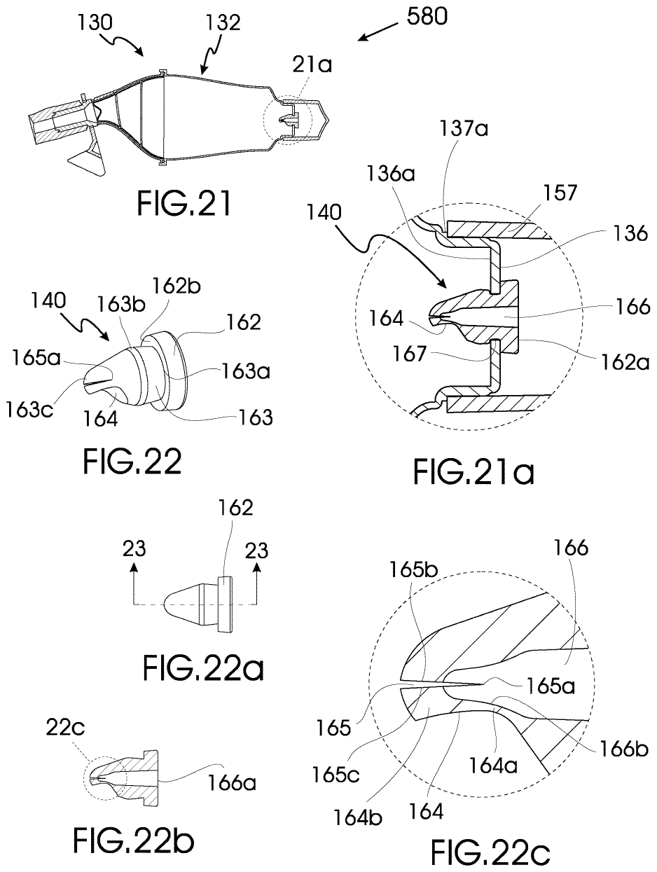

The back form 132 comprises a tubular form with a substantially thin wall 132a shown in FIG. 18e similar to the front form coming off the same vertical plane horizontally as the front form in the opposite direction toward the back. The back form 132 comprises the same opening form 131d, of the front form 131 as being a mate to the front form having the same rim 131e, face 131g, recess 131i and groove 131h as the front form 131. In addition, a thin band 132c of substantial width and thickness wraps around the outer surface of the rim, flush with the back face 132h of the rim extending sufficiently further than the front face of the rim. At the center of the top and of the bottom of the band at least one barb like grip 132i of sufficient length is located at the front inside edge 132g of the band from the front face 132b of the band 132c angling in toward the tube and back slightly, terminating at a point, and finally returning to the inside face 132g of the band on a line perpendicular to the inside face of the band 132c as shown in FIG. 18e. Preferably the grips 132i are located on each long side of the band 132c, such that when the rim 131e of the front form 131 is inserted into the inside opening of the band and the two forms are pressed together the grooved face 131g of each rim 131e meet and the grips slip over the outer edge 131f of the front form rim 131e. To open the tube assembly with the grip 132i on each long side of the band 132c the sides of the front form 131 are squeezed in sufficiently releasing the grips. Described further, the tubular form 132 extends back from the opening, substantially reducing in size to a form 132d similar to its opening but substantially smaller in all directions at which point it rapidly transitions 132e to a circular form at the base 132f of the storage post 135 having a diameter slightly smaller than the inside diameter of the cap 150. The circular form extends back slightly terminating with a closed end 136 forming a short cylindrical form, a storage post 135 for the cap 150. Four evenly spaced, circumferentially narrow cylindrical segments 137, having an outside diameter slightly larger than the inside diameter of the cap 150 protrude outward from the outer surface 135a of the post 135. Each cylindrical segment 137 has a small extension 137a extending outward from its face slightly, at its end at the base 132f of the post 135, forming a stop for the open end of the cap 150. A hole 138 through the closed end 136 of the post 135 located at the center of the post is of sufficient diameter to retain the vent plug 140 when inserted into the hole as shown in FIGS. 21 and 21a.

In use when the cap 150 is stored on the post 135, the cylindrical segments 137 retain the cap and the stops 137a keep the cap from sealing to the tube at the base 132f of the post 135. The channel between each segment 137 forms a passage for air passing through the vent plug 140.

Preferably, the container is a split body style with the front form 131 and back form 132 joining by at least one hinge of substantial length on a long side having at least one grip like latch or catch of sufficient length on the opposite side being a part of either form. In opening the container, the front form is squeezed to dislodge the grip. The front form component described herein typically has the common alignment arrows 29a as shown in FIG. 18c.

The custom two-piece container form 131 and 132 is preferably fabricated of a generally tough, durable, rigid pliable material of sufficient mass and physical properties. This would prevent the container from excessive distortion caused by such conditions as heat or the forces applied therein or thereon. Suitable fabricating materials of the container are preferably thermoplastic resins such as PETE (polyethylene terephthalate), PETG (polyethylene terephthalate glycol, PP (polypropylene), HDPE (high density polyethylene). Optimally the container would be fabricated of HDPE and can be processed in a variety of shapes and sizes. The preferred manufacturing process is injection molding making it economical to produce.

An example, dispensing spackle from a semi-rigid but resilient container is rather an ineffective means of dispensing, such that when the container is squeezed the spackle is agitated by the motion of the sides caving in and back, spreading the spackle throughout the inside of the container and much of it is never dispensed. To function even slightly the container is kept full and constantly tapped to maintain the contents at the nozzle. Even though the container is full, when the squeeze is relaxed the spackle is drawn back from the container opening. To resist this, air may be drawn in by way of an inlet valve.

The reversible pocket diaphragm 133, is described as a pocket like receptacle form inserting into the front form 131 of the resilient custom two piece squeezable container to contain and dispense paste like mixtures such as spackle, filler and caulk having a preferably resilient, flexible thin ribbed wall.

The pocket is of a tubular structure having a substantially large open end tapering to a much smaller closed end. The outer face at the closed end is preferably concave. Alternatively, the face may be flat.

Referring to FIGS. 18a, 18f and 19c, of the drawings the reversible pocket diaphragm component of the present invention described and illustrated herein as an example indicated generally at 133 is shown. The diaphragm 133 comprises a substantially thin-walled pocket like form with its outside form slightly smaller than the inside form of the front tube 131 of the two piece container, terminating at the nozzle opening 159. The front face 133d of the pocket 133 is of a concave form 133i. The opening 133c of the pocket 133 is slightly smaller than the opening 131d of the front form 131 and back form 132 of the container and has a continuous rim 133e having a thickened outer edge in the form of a bead 133f protruding from the outer surface 133b of the pocket to fit with the groove 131h of the front form 131. The rim 133e has a substantially thin wall similar to the thickness of the pocket body and the bead 133f is of an oblong form with a width similar to the width of the groove 131h but slightly thicker than the width of the groove 131h, which is compressed when assembled. To help maintain its shape, the pocket 133 as an example, has two annular continuous rib like forms 133g and 133h of sufficient size, with one at say one third of the length of the pocket and the other at two thirds of the length, with most of the rib exposed on the outside surface 133b and less on the inside surface 133j. In use when filling the container, the concave face 133i initiates the caving in of the pocket collapsing into itself and the ribs progressively assist in the pocket collapsing into itself. In dispensing, the concave face helps to dispense much of the contents left at the base of the nozzle 159. Alternatively the rib would be flush to the inside. Optimally an array of substantially small dome like protrusions, bumps (not shown) would be located on the outer surface of the pocket 133 in key locations to provide mini channels for the contents to pass from the back of the pocket to the nozzle opening.

FIG. 18e an enlarged sectional view, illustrates the connection of the front form to the back form with a diaphragm inserted therein. The bead and rim of the diaphragm are slightly compressed forming a seal.

FIG. 18f is a sectional view which illustrates the pocket diaphragm 133 inserted into the front tubular form 131 of the assembly 130.

FIG. 19 a front perspective view, 19a a back perspective view, 19b a top view and 19c a sectional view illustrate the pocket diaphragm 133 in some detail with attention given to the sectional view in FIG. 19c.

When the reversible pocket diaphragm is empty, it is fully inserted into the front form of the custom container of sub assembly 130 shown in FIG. 21. When filling the pocket, it gradually collapses into itself toward the back of the container reversing at its opening and re-expanding toward the back, holding twice its capacity. The ribs function to maintain its form as it gradually collapses. When fully filled it protrudes into the squeezable zone of the container doubling its capacity. The contents are dispensed even though they are agitated by the collapsing walls of the container.

An advantage, when filling the sub assembly 130 using the transfer tube tool tip is, the contents are delivered directly to the concave face of the diaphragm, and the air in the front compartment is vented out and displaced by contents.

The reversible pocket diaphragm contains the spackle when filling and acts as a pneumatic flexible plunger when the spackle is being dispensed.

When a semi-rigid but resilient container is used in dispensing low or very low viscosity liquids, the container is often left laying in a horizontal position.

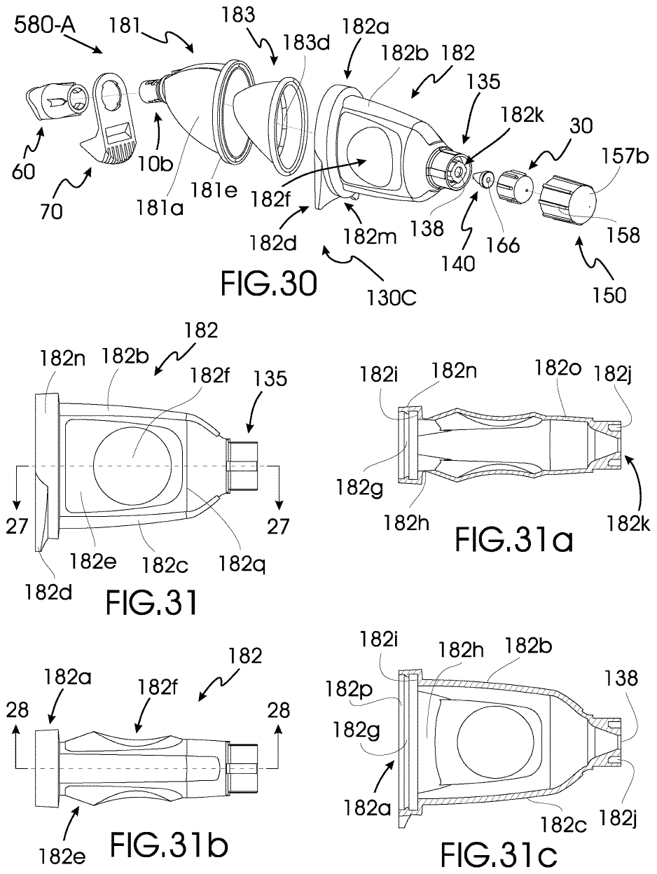

Referring to FIGS. 20a, 20b and 20c of the drawings the reversible pressure suppressor diaphragm component of the present invention described and illustrated herein as an example indicated generally at 160 is shown. The suppressor diaphragm 160 is similar to the reversible pocket diaphragm 133, comprising the same opening 133c, rim 133e and bead 133f as the pocket diaphragm 133 and a slightly bulged form 161 to the front shown in FIG. 20a in place of the pocket. The bulged front 161 is of a substantially thin wall similar to the wall thickness of the pocket diaphragm 133. The suppressor diaphragm 160 is interchangeable with the pocket diaphragm 133. When diaphragm 160 is inserted in sub assembly 130B shown in FIG. 29 the rim and bead are compressed, such that the front face 133k of the diaphragm rim 133e seals tightly against the face 131i of the rim 131e of front form 131A and the bead 133f of the diaphragm seals between each half of the groove 131h of the front form 131A. The preferred use is with low viscosity and very low viscosity water thin liquids such as paint, sealer and stain.

As part of the sub assembly 130B the pressure suppressor diaphragm 160 functions as a divider and a pressure suppressor used to contain and dispense a liquid such as paint. In use, the contents are isolated in the front compartment and when thermal pressure occurs, the diaphragm moves back to compensate, eliminating paint ooze.

The reversible pressure suppressor diaphragm 160 is preferably used with low and very low viscosity liquids such as latex paint and primer, alkyd paint and sealer, urethane, stain and shellac. Both are generally fabricated of a tough, durable, flexible, resilient material of sufficient mass and physical properties preventing excessive distortion or deformation caused by such conditions as a reaction to chemicals, heat or the forces applied therein or thereon. Suitable fabricating materials of each diaphragm may include materials such as natural and synthetic rubbers and silicone. Optimally each diaphragm would be fabricated of silicone rubber. Each diaphragm can be processed in a variety of shapes and sizes suited to fit a custom container. The preferred manufacturing process is injection molding or compression molding making it economical to produce.

Both diaphragms 133 and 160 are easily interchangeable and function as a divider and a pneumatic flexible plunger when used in the two-piece custom container, for dispensing paste like mixtures and liquids.

An example, when dispensing low or very low viscosity liquids from a semi-rigid but resilient container, the container is squeezed, contents are dispensed, the squeeze is released and air is drawn in from the nozzle end, through the contents, providing there is sufficient negative pressure in the container. If air is not drawn in, the bulged form of the container is eventually flattened and the container is up-righted and coaxed to expand. To overcome this, air may be drawn in at the back end of the container by way of an inlet valve which is typically installed from the inside. The vent is normally closed, covered by a flexible resilient flap located on the inside of a container which opens to draw in air and closes to pressurize.

Another example, when filling a semi-rigid but resilient container with a paste like mixture such as spackle a portion of the nozzle opening is kept clear allowing air being displaced by the spackle to escape. Dispensing spackle from a semi-rigid but resilient container is rather an ineffective means of dispensing, such that when the container is squeezed to dispense and released the spackle is drawn back from the container opening and the container is constantly tapped to move the contents to the opening. To address this, air may be drawn in by way of an inlet valve.

The design and physical properties of the vent plug 140 make it possible to insert it into a hole 138 shown in FIGS. 21 and 21a from the outside of the container making it easily serviceable. The vent plug 140 has four functions. Being normally open, it provides venting when thermal pressure occurs, allowing air to escape when the container is being filled. When the container is squeezed forcefully the flap closes and the container is pressurized. When the squeeze is relaxed the flap opens and air is drawn to displace the contents dispensed.

Referring to FIGS. 21a, 22, 22a, 22b and 22c the multi-function vent plug component of the present invention described and illustrated herein as an example indicated generally at 140 is shown. The vent plug 140 comprises a circular cap like end coming off of a vertical plane, sufficiently thick enough so it can be easily gripped for removal by a finger tip or a finger nail. Protruding perpendicular from the cap like end 162, the neck form 163a of the body 163 of the vent plug 140 comes off the inside face 162b of the end cap 162 at a substantially smaller diameter than the diameter of the end cap 162 gradually increasing in diameter to an enlarged mid section 163b, a bulb like shaped body 163 having a diameter slightly less than the diameter of the end cap 162 and narrowing down further terminating to a rounded end at its apex 163c. The length of the body is sufficient enough to prevent any distortion at the slit opening that may be caused by the body being compressed when inserted into a hole. At the rounded end 163c of the body 163 a “V” shaped slit 165 centered on and in line with its axis is cut through the tip horizontally in its entirety from one side to the other forming a mouth like passage 165. The open end of the “V” form, the mouth is substantially small located at the apex 163c of the body 163 extending back into the body sufficiently, terminating at a sharp knife edge 165a. Both upper 165b and lower 165c faces of the slit 165 are flat. The rounded blunt apex 163c forms a rigid opening to maintain the form of the opening at the apex 163c. The passage 166 extends through much of the body 163 at a slight taper from its opening 166a at the outer face 162a of the end cap 162 to just before the knife edge 165a of the slit 165 at which point it tapers more rapidly at a curvature to the inside terminating at almost the half way point of the slit with a rounded end. A large section of the body 163 between the mid section 163b and the apex 163c slightly below the passage wall, is cut away horizontally parallel to the knife edge 165a of the slit 165 forming a hinge point 164a. The cut 164 is of an irregular shape of curvatures with a substantially tight curvature at the point 164a closest to the passage wall 166b forming a lip like flap 164b.

When the vent plug 140 is pressed into the hole 138 of a custom dispensing container the bulged bulb like portion 163b expands against the edge of the hole at the back face 136a of the closed end 136. The neck section 163a is compressed against the inside surface 167 and outer edge of the hole. The back face 162b of the end cap 162 is compressed against the outer surface of the closed end 136. The vent plug is retained therein forming an air tight seal.

In use, when a container is forcefully squeezed and air rushes through the mouth 165 of the passage 166 it produces less pressure lifting the flap 164b, causing it to close, with its face 165c sealing against the upper face 165b.

The vent plug 140 is generally fabricated of a tough, durable, flexible, resilient material of sufficient mass and physical properties preventing the vent plug from excessive distortion or deformation caused by such conditions as the forces applied thereon. Suitable fabricating materials such as synthetic and natural rubbers and silicone rubber are used. Optimally the vent plug would be fabricated of silicone rubber and can be processed in a variety of shapes and sizes. The preferred manufacturing process is injection molding or compression molding making it economical to produce.

In a portion of an assembly shown in FIG. 28, similar to assembly 580 in FIG. 21 the reversible pocket diaphragm 133, together with the vent plug 140, is used to contain and dispense spackle. When filling the container using such means as a putty knife, or preferably using the transfer tube tool tip 190, the air in the back compartment is displaced by the diaphragm being filled and exits through the vent plug.

In use, the back compartment is squeezed forcefully causing the flap of the vent plug to close pressurizing the back compartment and applying pressure on the diaphragm dispensing the caulk. When the squeeze is relaxed, air is drawn in through the vent plug displacing the receding diaphragm.

Advantageously, when filling the container using the transfer tube tool tip, the air in the front compartment is vented out and displaced by contents.

In a portion of an assembly shown in FIG. 29, similar to assembly 580 in FIG. 21 the reversible pressure suppressor diaphragm 160 together with the vent plug 140 is used to contain and dispense a liquid such as paint when using brush tool tip 80 having a slit with a normally closed position or to contain and dispense water thin liquids such as stain, alkyd sealers and shellac when using pad tool tip 90 having a slit with a normally closed position.

In use, the contents are isolated in the front compartment and when thermal pressure occurs, the diaphragm moves back to compensate as air vents through the vent plug, eliminating seepage. When the back compartment is squeezed forcefully the flap of vent plug closes and the container is pressurized moving the diaphragm forward applying pressure to the holding compartment forcing the slit in the tool tip to open dispensing the paint. In dispensing a steady stream, the user can periodically relax the squeeze of the container without lifting it from the work surface and air is drawn in through the vent plug displacing the contents dispensed. Eventually the pressure in the front compartment becomes low enough and the slit in the tool tip opens and air is drawn in, as the diaphragm and slit conform to their environment. The diaphragm compensates substantially in either direction, with much more compensation favoring thermal pressure.

When mixing contents in a shaking forward and back motion the suppressor diaphragm 160 is moved forward and back while air passes through the vent plug 140 in and out of the back compartment compensating for the movement of the diaphragm. When the motion ceases the diaphragm conforms to its environment.

The normally open position of the vent plug and the normally closed slit of the particular tool tip such as tool tip 80 or tool tip 90, are necessary in eliminating premature dispensing of liquids.

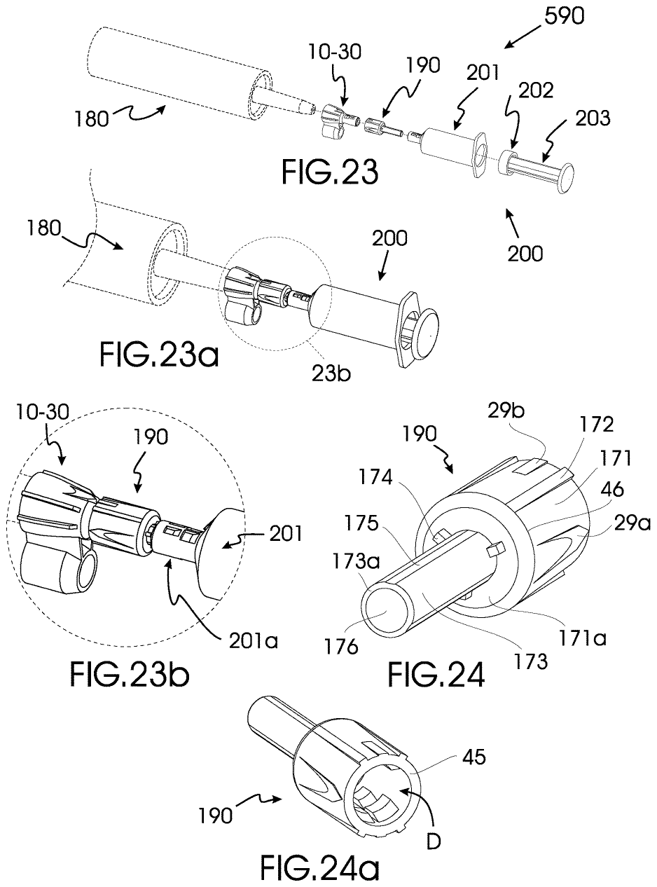

FIGS. 23, 23a and 23b of the drawings, illustrates three components of the present invention as an example, an assembly indicated generally at 590 an applicator tool set comprising an adapter 10-30 a variation of adapter 10, a transfer tube tool tip 190 and a custom plunger apparatus sub assembly 200 comprising a custom plunger body 201, a custom plunger seal 202 and a custom plunger 203, in use with a commercially pre-filled tube of caulk 180, is shown.

Referring to FIG. 24 of the drawings, the transfer tube tool tip component of the present invention described and illustrated herein as an example indicated generally at 190 is shown, a common tubular receptacle, the trunk, with an extended solid circular form with a passage through its entirety for passing paste like mixtures such as spackle and caulk and high viscosity liquid such as PVA white glue.

Referring to FIGS. 24 and 24a the transfer tube tool tip 190 comprises a common inside five point seal zone B (not shown), a common inside grip zone D, a common inside form of the trunk, a common insertion end 45 of the trunk and the common alignment marks 29b and arrows 29a, common to all tool tip components of the present invention. The outside form at the adjoining face 46 of the trunk is, of a circular shape particular to the transfer tube tool tip 190 tapering back to the insertion end 45. The insertion end is on a vertical plane with the adjoining face 46 on a plane parallel to the vertical plane. The circular shape at the adjoining face 46 of the trunk extends from the adjoining face 46 slightly, forming a preferably circular base, having a substantially flat front surface 91 and a substantially flat back surface 91a. Finger grips 172 protrude slightly from the outer surface 171 of the trunk preferably two sets of two, opposite each other, with each set centered on an alignment mark 29b, with one on each side. The transfer tube tool tip 190 has a tubular nozzle 173 of substantial length protruding horizontally from the front surface 171a of the circular base at the center of the base with an outside diameter slightly less than the inside diameter of an adapter or custom container, preferred cylindrical nozzle 10b. The transfer tube nozzle 173 has preferably three flat sections 175 equally spaced circumferentially around the outside surface. The flat section 175 is of sufficient depth into and running along the outer surface of the nozzle 173 from the base of the nozzle to its apex 173a, forming a vent strip. The diameter of the passage 176 is of a slightly smaller diameter than the outside diameter of the nozzle 173 forming a substantially thin wall maintaining a sufficient passage size to minimize flow restriction, especially with paste like mixtures. Protruding slightly from the front surface 171a of the circular base and extending outward slightly from the outer surface of the nozzle 173 are preferably three spacers 174 evenly arranged around the outer surface of the nozzle with each centered between two vent strips, forming stops.

FIG. 25 illustrates a side view of FIG. 23a outlining a sectional view in FIG. 25b and FIG. 25a. FIGS. 25a and 25b outline detailed views 25c and 25d illustrating in detail the three components of the present invention adapter 10-30, a transfer tube tool tip 190 and a custom plunger apparatus sub assembly 200 a portion of assembly 590 with attention given to the adapter component 10-30, nozzle passage 10-30c, of nozzle 10-30, as having a preferred cylindrical form.

The transfer tube tool tip 190 is used to transfer paste like mixtures and high viscosity liquids to and from various commercially available pre-filled tubes and dispensing containers and or special custom dispensing containers and has structure to vent displaced air when filling containers. As an example, when transferring caulk from a gun style caulk tube 180 to an emptied squeezable caulk tube or a custom container 201 the transfer tube tool tip 190 is mounted onto an adapter nozzle 10-30b which is screwed onto a gun style caulk tube 180 and the nozzle 173 of tool tip 190 is inserted into the nozzle of a second adapter screwed onto an emptied squeezable caulk tube or inserted into the nozzle 201a of custom container 201. The stops 174 at the base of the tool tip nozzle 173 come to rest against the apex 17c of the container nozzle 201a. The space between the inside surface of the container nozzle 201a and the face of the vent strip 175 of the tool tip nozzle 173 form a vent passage 178. When the custom plunger apparatus 200 is filled the caulk enters the plunger body 201 coming in contact with the face 202a of the plunger seal 202 forcing the plunger back and as the body fills the caulk backs up forcing the air in the cavity 177 out through each vent passage 178. The vent passage 178 is of sufficient size allowing air to pass but small enough to restrict the contents from passing, substantially minimizing air entrapment, and the exposure of the contents to air. Optionally the face of the plunger seal could be slightly concave.

The transfer tube tool tip 190 is generally fabricated of a chemical resistant, tough, durable, pliable, resilient or somewhat resilient material of sufficient mass and physical properties preventing the tool tip from excessive distortion or deformation caused by such conditions as the forces applied therein or thereon. Fabrication materials such as silicone rubber, TPU, Dynaflex®, neoprene, PVC, or Santoprene® may be used. Optimally the tool tip would be fabricated of silicone rubber for use with materials other than silicone and TPU for use with materials other than polyurethane and can be processed in a variety of shapes and sizes. The preferred manufacturing process is compression molding or injection molding making it economical to produce.

FIGS. 26, 26a and 26b of the drawings, illustrates two components of the present invention as an example, an assembly indicated generally at 600 is shown, for dispensing mixtures such as, caulk, sealant and non-sanded grout. A compact plunger style tube applicator comprising a custom plunger apparatus 200 and a caulk tool tip 20 preferably for use such as, caulking small gaps and cracks on installed molding and trim and caulking lines and gaps on installed wall and floor tile. It provides controlled dispensing, no oozing, a comfortable fit in the hand, is easy to fill, has interchangeable caulk tool tips, is easily cleaned and has more maneuverability throughout, such as in confined spaces.

The plunger body 201 and plunger 203 are preferably fabricated of a generally tough, durable, rigid material of sufficient mass and physical properties. This would prevent the components from excessive distortion caused by such conditions as heat or the forces applied therein or thereon. Suitable fabricating materials of the body and plunger are preferably thermoplastic resins such as Acetal (Delrin®), Polycarbonate, PP (polypropylene), HDPE (high density polyethylene). Optimally the components would be fabricated of Acetal and the preferred manufacturing process is injection molding making it economical to produce. The components can be processed in a variety of shapes and sizes such as a pistol grip or a palm grip having multiple annular grip ribs along the tube.

The plunger seal 202 is generally fabricated of a chemical resistant, tough, durable, pliable, resilient or somewhat resilient material of sufficient mass and physical properties preventing the seal from excessive distortion or deformation caused by such conditions as the forces applied therein or thereon. Fabrication materials such as silicone rubber, TPU, Dynaflex®, neoprene, PVC, or Santoprene® may be used. Optimally the seal would be fabricated of silicone rubber for use with materials other than silicone and TPU for use with materials other than polyurethane. Alternatively the seal may be fabricated of a thermoplastic resin such as HDPE (high density polyethylene) for use with all materials and can also be processed in a variety of shapes and sizes. The preferred manufacturing process is compression molding or injection molding making it economical to produce.

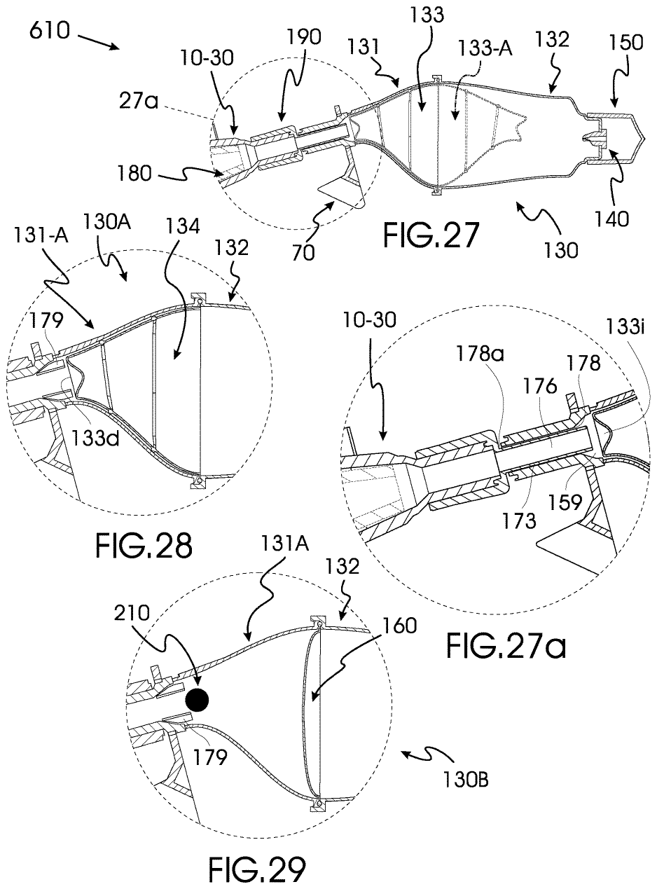

FIG. 27 of the drawings, illustrates seven components of the present invention as an example, an assembly indicated generally at 610 similar to assembly 580 in FIG. 21 is shown. An applicator tool set comprising an adapter 10-30 a variation of adapter 10, a transfer tube tool tip 190, a smoothing tool 70, a sub assembly 130 comprising a custom two piece container 131 and 132 and a reversible pocket diaphragm 133 inserted therein, a vent plug 140 and a cap 150 and an outline of view 27a. Shown, is an example of the reversible pocket diaphragm as 133A in a filled orientation.

FIG. 27a is an enlarged detailed view, a portion of the assembly 610. When being filled the caulk enters the container 131 coming in contact with dome 133i of the face 133d forcing the diaphragm 133 back and as the container fills, the caulk backs up forcing the air at the nozzle opening 159 out through each vent passage 178 exiting at the gap 178a between stops 174.

FIG. 28 illustrates two components of the present invention as an example, a partial assembly similar to assembly 580, showing a custom two piece container apparatus 130A, a preferred component comprising a front tube form 131A, a preferred component, a variation of 131 and back tube form 132 and a preferred reversible pocket diaphragm 134 a variation of diaphragm 133 inserted therein, is shown. The preferred front tube form 131A has at least three post like stops 179 of sufficient size and length protruding from the inside tapered surface of the nozzle opening 159 shown in FIG. 27a perpendicular to the face of the circular form 131c of the front tube 131A. The preferred reversible pocket diaphragm 134 is shortened at the front face end to compensate for the added stops 179.

FIG. 29 is similar to FIG. 28 illustrating the preferred pressure suppressor diaphragm 160 and a commercially available stainless steel mixing ball 210 of sufficient size inserted therein. The stops 179 are added at the nozzle area, substantially close to each other in an equilateral triangular pattern, forming a cage like form to prevent the mixing ball 210 from blocking the nozzle opening 159 when emptying the container or when in use and to prevent the paint from being forced into the nozzle passage in a pumping like action when mixing, being prematurely dispensed. The stops aid in emptying the container, stopping the ball allowing the paint to pass.

As an example, assembly 580, is a compact fully maneuverable, multi-use all-in-one tool set with a two piece squeezable tube, easy interchangeable tool tips and diaphragms, has a pointed cap for pressing in dimples on wood and on paper covered surfaces, has a detachable, replaceable two in one smoothing-wiping blade tool and a four function vent plug. The most efficient means of dispensing and finishing paste like mixtures such as spackle, fillers and caulk and medium, low and very low viscosity liquids such as white glue, paint, sealer, urethane, stains and shellac. For projects such as crafts and various installation and repair services such as, applying adhesive to abutting ends and edges when installing pre-finished or non-finished trim and molding, for filling nail holes and voids, for caulking gaps and cracks and for spot sealing and paint touch-ups, once installed.

FIG. 30 of the drawings, illustrates seven components of the present invention described and illustrated herein as an example, an assembly indicated generally at 580-A an applicator tool set similar to assembly 580 comprising fill tool tip 60, smoothing tool 70, a sub assembly 130C a variation of sub assembly 130, comprising a custom two piece container 181 and 182 and a reversible pocket diaphragm 183, vent plug 140, nozzle cap 30 and tool tip cap 150, is shown.

Referring to FIG. 30 of the drawings, a sub assembly of the present invention described and illustrated herein as an example indicated generally at 130C is shown being of a slightly different shape than sub assembly 130. The sub assembly 130C comprises a custom two piece container component having a rigid front form 181 and a much more squeezable, resilient back tubular form 182 with a reversible pocket diaphragm component 183 inserted therein.

FIGS. 30, 31, 31a, 31b and 31c of the drawings illustrate the back form indicated generally at 182 a variation of back form 132 of FIGS. 18a and 18d. Back form 182 comprises a similar slightly shorter tubular form having a slightly different shape, a longer tapered attachment zone 182a and thicker wall 1820 shown in FIGS. 30 and 31a a sectional view, and a substantially thicker top and bottom shown in FIG. 31c a sectional view. The thicker top, bottom and wall provide a suitable structure to minimize side flexing of the back form 182 when in use, mainly in use when filling holes, especially during the wiping motion to either side. Ribs 182b and 182c have been added to the top and bottom of the back form comprising a wide thickened band added to the outside surface of the tube, running along each surface from the back of the attachment zone 182a terminating just before the storage post 135. Alternatively the ribs may be added to the inside of the back form. The back form 182 comprises a similar attachment zone opening of back form 132 of FIG. 18e having a different shape and a continuous barb like grip rib 182g similar to barb like grip 132i. The barb like grip rib 182g is positioned slightly back into the opening of the attachment zone in from the edge of the opening forming a slight land 182p. The land is formed for the attachment zone 181e of the front form 181 to fit into, when pre-aligning both forms prior to being pressed together during assembly. Back form 182 has a smaller attachment zone 182a, smaller than its mate 181e, of the front form 181 shown in FIG. 30, having a tapered band 182n narrower at the opening of the attachment zone 182a so it may be stretched over the attachment zone 181e of the front form 181 when assembled. In addition each side wall section 182h at the back of the attachment zone 182a is substantially thinner at its center gradually thickening upwards and downwards for much of each side wall to the thickness of each side wall and rapidly thickening backward from the back of the attachment zone 182a to the thickness of the side wall slightly into the bulged portion 182e of each side wall. The slightly smaller, narrowing opening of the attachment zone 182a and the thinner section 182h of each side wall, provide a suitable attachment of the back form 182 to the front form 181 preventing disjoint of the two forms when in use that may be caused by full flexing of the back form when squeezed to dispense contents. The seat face 182i, of the attachment zone is typically flat minus the recess 131i and groove 131h of the front form 131 shown in FIG. 18e. The flat face is preferred allowing the face to slide into position on the bead of a diaphragm when shrinking down over the attachment zone 181e of the front form after being stretched over it during assembly. To open the tube assembly the attachment zone 182a of the back form is gradually peeled over and off of the front form attachment zone 181e by gradually stretching and pulling the back form with gentle but substantial force. Described further, the tubular back form 182 has a substantially bulged section 182e added to each side wall which extends backward from the back of the attachment zone for much of each side wall reducing in size to just before form 182q which is similar to form 132d of FIG. 18a and between but not up to the edge of the top rib 182b and bottom rib 182c. A concave dome like portion 182f is formed into each bulged section 182e in a suitable position forming a finger grip zone on one side wall and a thumb grip zone on the opposite side wall. A cradle like form 182m protrudes substantially from the bottom of the attachment zone 182a of the back form 182 for a finger to rest in, providing better control and comfort when in use. The cradle 182m comprises two foot like protrusions 182d positioned with one in line with each outer edge of the attachment zone joined by a concave curved land formed from the tip of each foot to its base, following the curvature of the attachment zone. The land extends from the front face of the attachment zone opening, back sufficiently such as, at least half the depth of the attachment zone 182a with the deepest point of the curved land finishing at the least, flush with or protruding out farther than the outer most curvature of the bottom of the attachment zone. Previously mentioned but not shown is a storage post for the nozzle cap 30. With the back tubular form 182 being of a much more flexible material the storage post 135 is extended farther from the back of the tube form 182 sufficiently to support the tool tip cap when the cap is stored on the post and used as a tool to press in the frayed edge of a hole. The back face 136 of the post 135 shown in FIG. 18a is recessed into the post and a second post, a miniaturized tool tip post 182k having the same profiles as post 135, protrudes from the recessed face terminating flush with the end of the tool tip post 135 and hole 138 is positioned in the center of the closed end. Nozzle cap 30 fits into the void 182j between both posts and is stored on post 182k and tool tip cap 150 fits over the nozzle cap and is stored on post 135. Venting of the vent plug 140 is maintained. Back form 182 specifically the bulged form 182e is a preferred embodiment for use with paste like substances such as spackles, fillers and caulks being beneficial in providing more squeeze-ability when filling larger holes gouges and more constant flow when used for filling small gaps and when drawing the tool away from the gap being filled. The concave finger and thumb grip zones 182f and the finger cradle 182m, provide comfort, ease of use and better control of the tool.

One component of the two-piece container, the back tubular form 182 is preferably fabricated of a generally tough, durable, flexible resilient material of sufficient mass and physical properties. This would prevent the container from excessive distortion caused by such conditions as heat or the forces applied therein or thereon. Suitable fabricating materials of the back tubular form may include silicone, TPU (Thermoplastic Polyurethane), Dynaflex®, neoprene, PVC (Polyvinyl Chloride), or Santoprene®. Optimally the back form would be fabricated of TPU and can be processed in a variety of shapes and sizes. The preferred manufacturing process is injection molding or compression molding making it economical to produce.

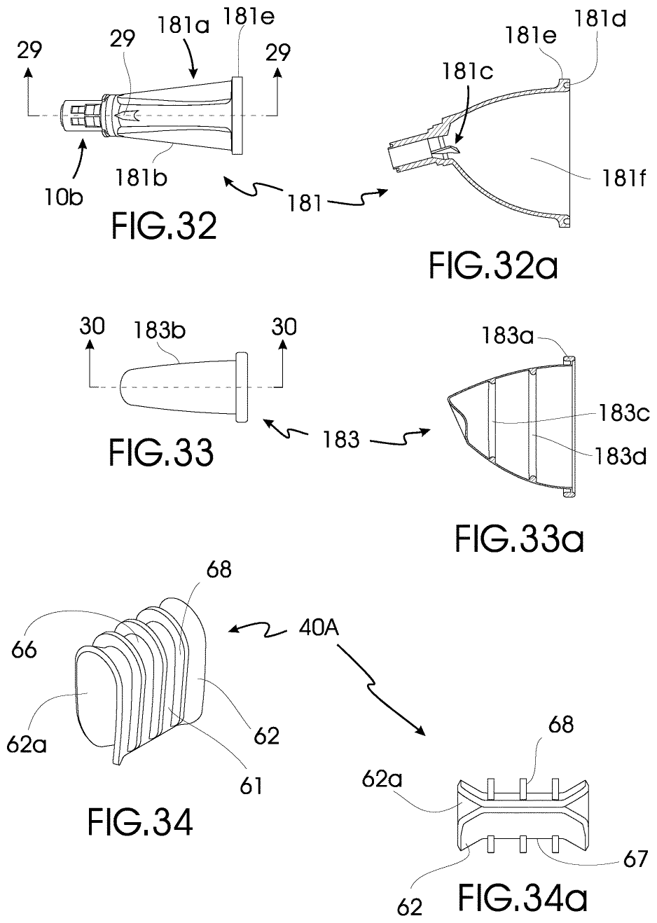

FIG. 32 and FIG. 32a a sectional view of the drawings illustrate the front form indicated generally at 181 a variation of front form 131 shown in FIG. 18a having a different shape, a similar substantially thin wall 131b, common collar 31, common smoothing tool mounting zone 32 and nozzle 10b, and a variation of front form 131A shown in FIGS. 28 and 29 depicting the post like mixing ball stops 179. Label zone 181a is added to the outside surface of each side wall of front form 181 comprising a conical wall like form protruding off of each face inevitably thickening much of each side wall mainly at the top and bottom providing a suitable surface 181b for the placement of a label (not shown). Post like mixing ball stop 181c is similar to post like stop 179. Attachment zone 181e has a much deeper groove 181d than groove 131h which is used to fully retain a diaphragm's position that would otherwise be at risk of being dislodged during the assembly of front form 181 and back form 182. The front form component described herein typically has the common alignment arrow 29 as shown in FIG. 18c.

One component of the two piece container, the front tubular form 181 is preferably fabricated of a generally tough, durable, rigid material of sufficient mass and physical properties. This would prevent the container from excessive distortion caused by such conditions as heat, a reaction to chemicals, or the forces applied therein or thereon. Suitable fabricating materials of the container are preferably thermoplastic resins such as PETE (polyethylene terephthalate), PETG (polyethylene terephthalate glycol, PP (polypropylene), HDPE (high density polyethylene). Optimally the container would be fabricated of HDPE and can be processed in a variety of shapes and sizes. The preferred manufacturing process is injection molding making it economical to produce.

FIG. 33 and FIG. 33a a sectional view of the drawings illustrate a reversible pocket diaphragm indicated generally at 183, a variation of diaphragms 133 and 134 shown in FIG. 19-19c and 28 . Pocket diaphragm 183 is described as having somewhat annular ribs 183c and 183d a variation of ribs 133g and 133h protruding from the inside surface of the diaphragm inward in similar positioning as pocket diaphragms 133 and 134. Alternatively the ribs may be removed. The bead 183a is much more of an elongated oval like form, elongated in one direction only, toward the insertion or closed end of the diaphragm sufficiently enough to fill the deepened groove 181d of the front form 181. When assembled, the pocket diaphragm 183 is inserted into the front form 181, and the bead 183a is pressed into the groove 181d of the front form 181 securing the diaphragm 183 in position. The attachment zone 181e of front form 181 is fitted into the pre-alignment form 182p of the attachment zone of the back form 182 and both forms of the tool are pressed together compressing the bead of the diaphragm against the seat face 182i of the attachment zone 182a of the back form providing an air tight seal. The outer surface 183b of the pocket diaphragm 183 has a similar form as the inside surface 181f of the front form 181.

Diaphragms are easily interchangeable and the reversible pressure suppressor diaphragm component of the present invention would have the same bead 183a configuration when used with the front form 181 and back form 182.

Both diaphragms are generally fabricated of a tough, durable, flexible, resilient material of sufficient mass and physical properties preventing excessive distortion or deformation caused by such conditions as a reaction to chemicals, heat or the forces applied therein or thereon. Suitable fabricating materials of each diaphragm may include materials such as natural and synthetic rubbers and silicone. Optimally each diaphragm would be fabricated of silicone rubber. Each diaphragm can be processed in a variety of shapes and sizes suited to fit a custom container. The preferred manufacturing process is injection molding or compression molding making it economical to produce.

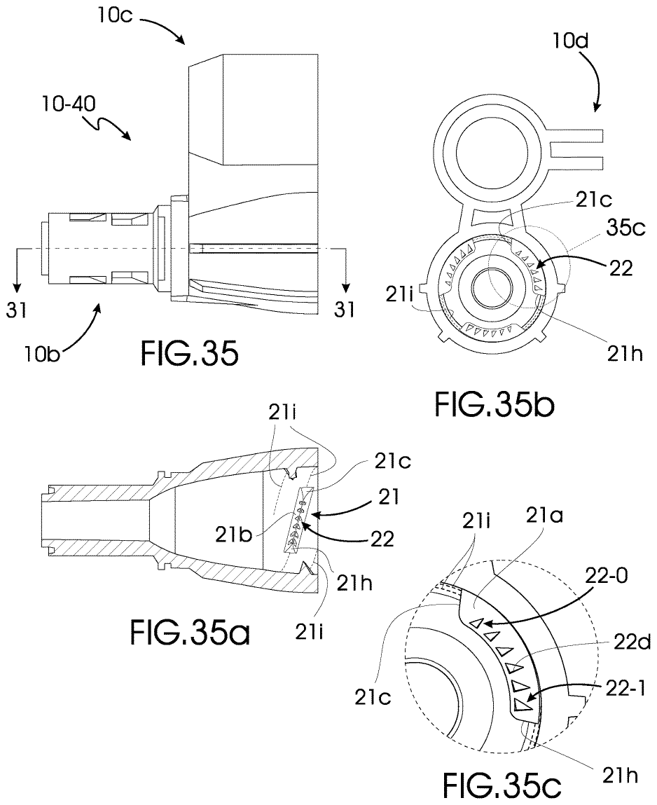

Referring to FIGS. 34 and 34a of the drawings, the tube clip component of the present invention described and illustrated herein as an example, indicated generally at 40A is shown. Tube clip 40A is a variation of tube clip 40 shown in FIGS. 5 and 5c having as an example three structural ribs 68 added to the outside surface of the clip spaced somewhat evenly across the clip between each open end 62 adding to the structural properties provided by the flared out portion of each open end 62. Preferably, the wide opening 62a would remain. The ribs 68 are of sufficient thickness and protrude from the outer surface sufficiently, wrapping around much of the outer surface including the back side 61, the “U” shaped top 66 and the front side 67.

Tube clip 40A is preferably fabricated of a generally tough, durable, rigid material of sufficient mass and physical properties. This would prevent the tube clip from excessive distortion caused by such conditions as heat or the forces applied therein or thereon. Suitable fabricating materials of the tube clip may include metal, fiberglass or preferably thermoplastic resins such as Acetal or Polycarbonate. Optimally the tube clip would be fabricated of Polycarbonate. The tube clip can be processed in a variety of shapes and sizes. The preferred manufacturing process is injection molding making it economical to produce.

Referring to FIGS. 35, 35a, 35b and 35c of the drawings, a variation of adapter 10 shown in FIG. 3-3h, is a tool tip adapter component of the present invention described and illustrated herein as an example, indicated generally at 10-40 is shown depicting a broken line 21i indicating an individual helical path for each thread segment 21. Previously mentioned, the serrations may be of different shapes and sizes, protruding more or less from the face of the flank.

The external grip like teeth serrations 22 protrude from each flank 21a and 21b of each segment 21 the least 22-0 at the leading end 21c with each serration 22 gradually protruding more than the previous one with the serration 22-1 at the opposite trailing end 21h of the segment 21 protruding the most. This would ensure that each grip edge 22d or grip point of each serration is engaged with the material of the dispensing tube nozzle when in use.

The tool tip adapter 10-40 is preferably fabricated of a generally tough, durable, rigid material of sufficient mass and physical properties. This would prevent the adapter from excessive distortion caused by such conditions as heat or the forces applied therein or thereon. Suitable fabricating materials of the adapter may include metal or preferably thermoplastic resins such as Acetal or Polycarbonate. Optimally the adapter would be fabricated of Acetal. The adapter can be processed in a variety of shapes and sizes and the preferred manufacturing process is injection molding making it economical to produce.

Of the pliable materials mentioned, many are resilient and extremely tough and durable and others are extremely resilient, tough and durable.

Custom containers and tubes can be fitted with the tool tip for each application and filled with the desired material such as caulk, spackle, adhesives and paint.

The preferred embodiment is described as a set, a system of tools and components for the installation and finishing of non-finished and pre-finished molding and trim and for the repairs and finishing of finished surfaces.

A preferred embodiment described as an adapter used to a fix tool tips to a wide variety of commercially pre-filled dispensing tubes and bottles having many various nozzle profiles. The tool tip adapter.

Another preferred embodiment is described as a receptacle to cover the adapter nozzle end. The cap.

Another preferred embodiment is described as various tips to dispense, fill and tool cracks and gaps with caulking. The caulk tool tip.

Another preferred embodiment is described as a clip to contain the rolled up end of a commercially pre-filled collapsible tube. The tube clip.

Another preferred embodiment is described as a tip to dispense, fill and wipe holes with fillers and spackle. The fill tool tip.

Another preferred embodiment is described as a tip to dispense and spread paint. The brush tool tip.

Another preferred embodiment is described as a tip to dispense and spread very low viscosity liquids such as sealers. The pad tool tip.

Another preferred embodiment is described as a tip to dispense and spread liquid adhesives. The notched tool tip.

Another preferred embodiment is described as an attachable tool for smoothing patch work. The smoothing tool.

Another preferred embodiment is described as a receptacle to cover tool tips. The cap.

Another preferred embodiment is described as a two piece tubular form. The container.

Another preferred embodiment is described as a pocket like receptacle to contain paste like mixtures. The reversible pocket diaphragm.

Another preferred embodiment is described as a pressure suppressor to contain liquids. The reversible pressure suppressor diaphragm.

Another preferred embodiment is described as a multi-function vent plug. The vent plug.

Another preferred embodiment is described as a tip to provide a passage to transfer paste like and liquid like substances to and from tubes and containers. The transfer tube tool tip.

Another preferred embodiment is described as a custom dispenser for applying caulk. The compact plunger style tube applicator.

The pliable materials mentioned, many are resilient and extremely tough and durable and others are extremely resilient, tough and durable.

The rigid materials mentioned are extremely tough and durable.

The scope of the claims should not be limited by the preferred embodiments set forth in the examples but should be given the broadest interpretation consistent with the specification as a whole.

1. An apparatus for applying a flowable substance from a dispensing container to a surface, wherein the dispensing container has a body forming a receptacle configured to receive the flowable substance, wherein the body is deformable for mechanically urging the flowable substance out of the receptacle, wherein the dispensing container further includes a dispensing tip supported on the body in fluidic communication with the receptacle and forming a passageway to convey the flowable substance, wherein the dispensing tip is closed and configured for locating a dispensing opening through which the flowable substance is released from the container, the apparatus comprising:
an adaptor in the form of a tube and extending from a first end to a second end, wherein the first and second ends are open, wherein the adaptor comprises a container mounting portion defining the first end and configured to be received on the dispensing tip of the container and an attachment mounting portion defining the second end, wherein each of the container mounting portion and the attachment mounting portion have interior surfaces, wherein the interior surface of the container mounting portion is arranged to face the dispensing tip of the container and the interior surface of the attachment mounting portion is configured to guide the flowable substance from the dispensing tip of the container and to the second end of the adaptor; and
a plurality of interchangeable attachment tips configured to be received on the adaptor in respective working positions, wherein each of the attachment tips forms a respective interior passageway for guiding the flowable substance from a mounting end of the attachment tip, located at or adjacent the second end of the adaptor in the respective working position and having an opening therein, and to a free end of the attachment tip arranged at or adjacent the surface and having a release opening in the free end from which the flowable substance is applied to the surface, wherein the interchangeable attachment tips have different exterior shapes for forming different beads when the flowable substance is applied to the surface.

2. The apparatus of claim 1 wherein, when the adaptor extends along an axis from the first end to the second end, the container mounting portion of the adaptor comprises a plurality of projecting members carried on the interior surface thereof and projecting inwardly therefrom towards the axis, wherein the projecting members are configured for imbedding in the dispensing tip of the container to resist relative movement between the adaptor and the dispensing tip in an axial direction of the adaptor.

3. The apparatus of claim 2 wherein the projecting members extend helically around the axis.

4. The apparatus of claim 3 wherein the projecting members are angularly spaced from each other around the axis of the adaptor.

5. The apparatus of any one of claims 2 to 4 wherein the projecting members are arranged at a common distance from the first end of the adaptor.

6. The apparatus of any one of claims 2 to 5 wherein the projecting members comprise ridges oriented transversely to the axis and a plurality of teeth supported on each of the ridges, such that each of the projecting members carries a plurality of penetrating pointed terminuses which are axially spaced apart.

7. The apparatus of any one of claims 1 to 6 wherein an interior cross-section of the container mounting portion defined by the interior surface thereof is non-uniformly tapered in size from the first end and towards the attachment mounting portion, wherein a rate of tapering is higher adjacent a junction between the container mounting portion and the attachment mounting portion than adjacent the first end.

8. The apparatus of any one of claims 1 to 7 further including a cutting gauge configured to delimit a length of an end portion of the dispensing tip to be cut for locating the dispensing opening in the dispensing tip, wherein the cutting gauge is in the form of a tube configured to receive the dispensing tip and extends along a respective axis, wherein the cutting gauge is supported on the adaptor with the axes of the adaptor and the cutting gauge in parallel relation to one another.

9. The apparatus of claim 8 wherein, when the cutting gauge extends axially from a first open end proximal to the first end of the adaptor and to a second open end of the cutting gauge distal to the first end of the adaptor, the cutting gauge comprises a leading cylindrical portion defining the first open end and a trailing frustoconical portion defining the second open end, wherein the trailing frustoconical portion is tapered in cross-sectional size from a junction between the leading cylindrical and trailing frustoconical portions towards the second open end, and wherein the leading cylindrical portion is longer in the axial direction than the trailing tapered portion.

10. The apparatus of any one of claims 1 to 9 further including a cap configured to cover the second end of the adaptor and a storage post configured to receive the cap, wherein the storage post is supported in fixed relation to the adaptor and is oriented transversely to the axis of the adaptor.

11. The apparatus of claim 10 wherein, when the apparatus further includes a second tubular passageway supported on the adaptor in fixed parallel relation thereto, the storage post is carried on the tubular passageway.

12. The apparatus of claim 10 or 11 wherein the storage post is in the form of a pair of parallel planar prongs.

13. The apparatus of any one of claims 1 to 12 wherein each of the interchangeable attachment tips and the adaptor are interconnectable by a plurality of pairs of mating members to form a fluidic seal between the second end of the adaptor and the mounting end of the attachment tip arranged in the respective working position, wherein the mating members of the adaptor include (i) a plurality of recesses in an outer surface of the attachment mounting portion, wherein the recesses are arranged in angularly and axially spaced relation about the outer surface, and (ii) an annular receptacle at the second end of the adaptor, wherein the annular receptacle extends axially of the adaptor and encompasses the interior cross-section of the attachment mounting portion; and wherein the mating members of the attachment tip include (i) a plurality of projecting bodies supported on an interior of the attachment tip and configured to mate with the recesses in the outer surface of the attachment mounting portion, and (ii) an annular lip supported at an end of the attachment tip and configured to mate with the annular receptacle.

14. The apparatus of any one of claims 1 to 13 wherein a caulking one of the interchangeable attachment tips configured to apply a bead of a caulking type of the flowable substance comprises a nose protruding in the axial direction beyond the release opening which opens transversely to the axis, wherein the exterior shape of the caulking attachment tip comprises a central bottom ridge extending from the release opening and away from the axis and in a rearward direction towards the mounting end of the caulking attachment tip, wherein the exterior shape of the caulking attachment tip includes on either side of the ridge concavely shaped surfaces forming an inverted V shaped edge from one side of the caulking attachment tip and across the nose to an opposite side of the caulking attachment tip.

15. The apparatus of claim 14 wherein the exterior shape of the caulking attachment tip has a substantially planar forwardly facing surface locating the release opening and between the nose and the bottom ridge.

16. The apparatus of any one of claims 1 to 15 wherein, when the body of the dispensing container is rollably deformable, the apparatus further includes a retention clip configured to be supported on a deformed end portion of the body of the dispensing container, wherein the retention clip is generally clam-shaped to have an upper portion and a lower portion in generally parallel and spaced-apart relation and defining therebetween a receptacle configured to receive the deformed end portion of said body, wherein sides of the retention clip at the upper and lower portions are flared away from each other to act as guide surfaces for locating the retention clip onto the deformed end portion of said body in a transverse direction to a longitudinal direction of the body of the dispensing container directed from the deformed end portion to the dispensing tip.

17. The apparatus of claim 16 wherein one of the upper portion and the lower portion of the retention clip is shorter than another one thereof and wherein an end portion of the shorter one of the upper portion and the lower portion is hooked towards a longer one of the upper and lower portion to substantially close the clam-shaped receptacle for securably pinching the body of the dispensing container.

18. The apparatus of claim 16 or 17 wherein the retention clip comprises a plurality of parallel ribs exterior to the receptacle and spanning between free ends of the upper and lower portions.

19. The apparatus of any one of claims 1 to 18 further including a smoothing tool attachment configured to cuttingly remove hardened excess of the applied flowable substance and configured to be supported on the adaptor distinctly of the interchangeable attachment tips, wherein the smoothing tool attachment comprises a mounting portion in the form of a planar body locating an opening configured to be received on the adaptor and a plurality of parallel blades arranged in a transversely extending row relative to the axis of the adaptor.

20. The apparatus of claim 19 wherein, when bottom surfaces of the blades define a common plane, the common plane is inclined to be transverse to the axis of the adaptor.

21. The apparatus of claim 19 or 20 wherein, when the smoothing tool comprises opposite ends which are axially spaced apart relative to the axis of the adaptor and opposite sides of the smoothing tool which are spaced apart in a transverse direction to the axis of the adaptor, a first one of the opposite ends is formed by substantially pointed ends of the blades and a second one of the opposite ends is formed by rounded ends of the blades, wherein the second end of the smoothing tool is convexly shaped in the transverse direction between the opposite sides.

22. The apparatus of claim 21 wherein the second end of the smoothing tool is additionally convexly shaped in a depth direction which is transverse to the axis of the adaptor and the transverse direction.

23. The apparatus of any one of claims 1 to 22 wherein a filling one of the interchangeable attachment tips configured to apply a filling type of the flowable substance comprises a triangular peripheral edge protruding axially beyond the release opening which is coaxial with the axis of the adaptor, wherein an intermediate surface of the exterior shape between the release opening and the triangular peripheral edge is planar and inclined.

24. The apparatus of claim 23 wherein the release opening is triangular shaped.

25. The apparatus of claim 23 or 24 wherein the filling attachment tip includes along one side of the triangular peripheral edge a plurality of axially-extending grooves configured for spreading the applied filling type of the flowable substance.

26. The apparatus of any one of claims 1 to 25 wherein a painting one of the interchangeable attachment tips configured to apply a painting type of the flowable substance comprises a plurality of axially-extending parallel pins supported on a planar face oriented orthogonally to the axis of the adaptor and in which the release opening is located.

27. The apparatus of claim 26 wherein free ends of the pins are pointed.

28. The apparatus of claim 26 or 27 wherein the passageway of the painting attachment tip includes a valve intermediate the mounting and free ends and upstream from the release opening relative to the flow of the flowable substance, wherein the valve is configured to resist flow in an upstream direction from the cavity of the receptacle.

29. The apparatus of any one of claims 1 to 28 wherein an absorbent applicator one of the interchangeable attachment tips configured to apply an absorbent type of the flowable substance comprises a generally cylindrical receptacle configured to receive an absorbent pad, wherein a base of the receptacle locates the release opening in a planar surface, wherein the receptacle includes a plurality of spacers supported at spaced positions on the planar surface and defining support surfaces spaced from the planar surface to carry the absorbent pad in spaced relation to the release opening.

30. The apparatus of claim 29 wherein the passageway of the absorbent applicator attachment tip includes a valve intermediate the mounting and free ends and upstream from the release opening relative to the flow of the flowable substance, wherein the valve is configured to resist flow in an upstream direction from the cavity of the receptacle.

31. The apparatus of any one of claims 1 to 30 wherein an adhesive applicator one of the interchangeable attachment tips configured to apply an adhesive type of the flowable substance comprises the release opening in the form of a transversely elongated slit and a plurality of notches in a transversely extending row and arranged to at least one side of the slot for spreading the adhesive type of the flowable substance.

32. The apparatus of claim 31 wherein the adhesive applicator attachment tip further includes a pair of planar guide tabs at opposite ends of the slit and oriented normally to the slot and configured to receive therebetween a workpiece defining the surface to which the flowable substance is to be applied.

33. The apparatus of any one of claims 1 to 32, in combination with the dispensing container, wherein the body of the dispensing container comprises an internal tubular diaphragm adjacent the dispensing tip and having a plurality of sections along a longitudinally-oriented axis of the diaphragm, wherein the diaphragm is generally frustoconical in shape and the sections are collapsible independently of the other for urging the flowable substance to the dispensing tip.

34. The apparatus of any one of claims 1 to 33, in combination with the dispensing container, wherein an end of the body opposite to the dispensing tip includes an opening selectively closed by a vent plug, wherein the vent plug forms a passageway extending between an open end exterior to the receptacle formed by the body of the dispensing container and a flap at an opposite end interior to the receptacle and forming a selectively closable opening, wherein the flap is closable responsive to lowering of pressure in the receptacle relative to an ambient environment of the body of the dispensing container so as to conduce movement of the flowable substance out through the dispensing tip.

35. The apparatus of claim 34 wherein the end of the body opposite to the dispensing tip includes at least one substantially cylindrical annular body encompassing the vent plug and configured to respectively receive a cap for closing one of the release opening in a respective one of the interchangeable attachment tips and the dispensing opening in the dispensing tip of the dispensing container.

36. The apparatus of claim 34 or 35 wherein said at least one substantially cylindrical annular body comprises a pair of concentric substantially-cylindrical annular bodies respectively configured to receive different caps respectively configured for closing the release opening and the dispensing opening.

37. The apparatus of any one of claims 1 to 36 wherein a transfer one of the interchangeable attachment tips configured to transfer the flowable substance to a different dispensing container for applying the flowable substance therefrom and to the surface comprises an adaptor mounting portion defining the mounting end of the transfer attachment tip and an insertion portion defining the free end and locating the release opening, wherein the insertion portion is substantially cylindrical and has reduced outer diameter relative to the adaptor mounting portion so as to be configured to be passed through a release opening of the different dispensing container and into an interior volume thereof for receiving the flowable substance, and wherein the respective interior passageway of the transfer attachment tip extends coaxially of the adaptor axis from the mounting end to the free end.

38. The apparatus of claim 37, in combination with the different dispensing container, wherein the different dispensing container comprises a rigid body defining the interior volume thereof and an actuator configured to mechanically urge the flowable substance out from the different dispensing container, wherein the different dispensing container further includes a tip defining the release opening of the different dispensing container and configured to respectively receive the interchangeable attachment tips.
